(19) United States
(12) Patent Application Publication
(10) Pub. No.: US 2026/0352355 A1
(43) Pub. Date: Nov. 5, 2026

(54) DETERMINATION OF CHANNEL SENSING QUALITY USING CHANNEL SENSING METRIC

(71) Applicant: COGNITIVE SYSTEMS CORP., Waterloo (CA)

(72) Inventors: Chris BEG, Waterloo (CA); Mohammad OMER, Waterloo (CA)

(21) Appl. No.: 19/482,153

(22) PCT Filed: May 17, 2024
(86) PCT No.: PCT/IB2024/054818

§ 371 Date: Nov. 6, 2025

Related U.S. Application Data
(60) Provisional application No. 63/503,070, filed on May 18, 2023.

(51) Int. Cl. H04B 17/382; H04B 17/309; H04L 25/02; H04W 24/10

(52) U.S. Cl. CPC H04B 17/382; H04B 17/309; H04L 25/0202; H04W 24/10

(57) ABSTRACT

The present invention provides a method and a system comprising establishing a basic service set that includes an access point and stations, and further provides that, in the process of establishing a basic service set, an access point establishes a sensing measurement setup, obtains a channel sensing metric, selects a transmission configuration, and communicates the transmission configuration to a station. The present invention also provides a method and a system comprising establishing a basic service set that includes an access point and stations, and further provides that, in the process of establishing a basic service set, an access point establishes a sensing measurement setup, obtains channel sensing metrics, determines that a channel sensing metric is below a quality threshold, and in response adjusts basic service set parameters.

### TECHNICAL FIELD

The present disclosure generally relates to systems and methods for Wi-Fi sensing. In particular, the systems and methods relate to determination of channel sensing quality using channel sensing metric (CSM).

### BACKGROUND OF THE DISCLOSURE

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems. A WLAN sensing system (which may be referred to as a Wi-Fi sensing system) is one recent addition to motion detection systems. A Wi-Fi sensing system may be a network of Wi-Fi-enabled devices that may be a part of an IEEE 802.11 network. In an example, a Wi-Fi sensing system may be configured to detect features of interest in a sensing space. A sensing space may refer to any physical space in which the Wi-Fi sensing system may operate, such as a place of residence, a place of work, a shopping mall, a sports hall or sports stadium, a garden, or any other physical space. Features of interest may include motion of objects and motion tracking, presence detection, intrusion detection, gesture recognition, fall detection, breathing rate detection, and other applications.

### BRIEF SUMMARY OF THE DISCLOSURE

Systems and methods are provided for determination of channel sensing quality using channel sensing metric. In an example embodiment, a method for establishing a basic service set (BSS) including an access point and a plurality of stations having a plurality of sensing links therebetween is disclosed. The method is performed by a networking device operating as the access point. The method includes establishing a sensing measurement setup with a station of the plurality of stations in the BSS. In examples, the sensing measurement setup corresponds to a transmission configuration comprising a channel and bandwidth (CHB), and transmission parameters. In some embodiments, the method includes obtaining a channel sensing metric (CSM). The CSM corresponds to a sensing link of the plurality of sensing links between the networking device and the station and to the transmission configuration. In some embodiments, the method includes selecting the transmission configuration as an operating transmission configuration according to the CSM and communicating the operating transmission configuration to the station.

In some embodiments, obtaining the CSM includes determining the CSM based on a comparison between a channel state information (CSI) for the sensing link and a reconstructed CSI for the sensing link.

In some embodiments, the CSI includes a plurality of time domain pulses and the reconstructed CSI includes a selected number of time domain pulses from the plurality of time domain pulses.

In some embodiments, the selected number of time domain pulses is determined according to at least one of a noise threshold method, a filter mask method, and a knee point method.

In some embodiments, obtaining the CSM includes transmitting, by the networking device, a sensing trigger frame to the station, receiving, by the networking device, one or more sensing NDP transmissions transmitted by the station according to the sensing trigger frame, performing one or more sensing measurements on the one or more sensing NDP transmissions, and determining the CSM according to the one or more sensing measurements.

In some embodiments, the sensing trigger frame is configured to identify a sensing measurement setup according to the transmission configuration.

In some embodiments, obtaining the CSM includes transmitting, by the networking device, one or more sensing NDPA frames to the station, transmitting, by the networking device, one or more sensing NDP transmissions configured according to the transmission configuration to the station and corresponding to the one or more sensing NDPA frames, receiving, by the networking device, one or more sensing measurement reports from the station, and determining the CSM according to the one or more sensing measurement reports.

In some embodiments, the sensing measurement report includes a CSI for the sensing link.

In some embodiments, establishing the sensing measurement setup includes establishing a plurality of sensing measurement setups according to a plurality of transmission configurations, and obtaining the CSM includes obtaining a CSM matrix. The CSM matrix comprises a plurality of CSMs, each corresponding to the sensing link and to one transmission configuration of the plurality of transmission configurations. In some embodiments, establishing the sensing measurement setup includes selecting the CHB as an operating CHB. In examples, the selection may be performed according to the CSM matrix.

In some embodiments, the method further includes determining a plurality of CSM matrices. In examples, each CSM matrix corresponds to one sensing link of the plurality of sensing links and comprises a plurality of CSM scores according to a plurality of different transmission configurations for the one sensing link.

In some embodiments, selecting the transmission configuration as an operating transmission configuration includes identifying transmission configurations as candidate transmission configurations based on having corresponding CSMs that surpass a quality threshold for each station of the plurality of stations, and selecting, as the operating transmission configuration, the transmission configuration qualifying as a candidate transmission configuration for each station of the plurality of stations.

In some embodiments, selection of the transmission configuration is performed according to at least one of availability of channel resources, received signal strength indication information, and data channel metrics.

In some embodiments, selecting the transmission configuration as an operating transmission configuration includes identifying transmission configurations as candidate transmission configurations based on having corresponding CSMs that surpass a quality threshold for each station of the plurality of stations, identifying, as potential operating transmission configurations, transmission configurations having a shared CHB and qualifying as candidate transmissions configuration for each station of the plurality of stations, and establishing the shared CHB as an operating CHB.

In another example embodiment, a method for establishing a BSS including an access point and a plurality of stations having a plurality of sensing links therebetween is described. The method is performed by a networking device operating as the access point. The method includes establishing the BSS according to an operating CHB based on data transmission metrics. The method further includes establishing a sensing measurement setup with the plurality of stations in the BSS. The sensing measurement setup corresponds to a transmission configuration comprising the CHB, and transmission parameters. In some embodiments, the method includes obtaining one or more CSMs. Each CSM corresponds to a sensing link of the plurality of sensing links between the networking device and the station and to the transmission configuration. In some embodiments, the method includes determining that at least one of the CSM of the one or more CSMs is below a quality threshold and adjusting BSS parameters responsive to determining that the at least one of the CSM of the one or more CSMs is below the quality threshold.

In some embodiments, adjusting the BSS parameters includes adjusting a configuration of the BSS. In examples, the configuration includes at least the CHB.

In some embodiments, adjusting the BSS parameters includes removing one or more sensing links corresponding to the at least one of the CSM below the quality threshold from a set of links used for sensing.

In further embodiments, a system for establishing a basic service set (BSS) including an access point and a plurality of stations having a plurality of sensing links therebetween is provided. The system may include a networking device operating as the access point and including at least a transmitting antenna, a receiving antenna, and at least one processor configured to execute instructions for: establishing a sensing measurement setup with a station of the plurality of stations in the BSS, the sensing measurement setup corresponding to a transmission configuration comprising a channel and bandwidth (CHB), and transmission parameters; obtaining a channel sensing metric (CSM), the CSM corresponding to a sensing link of the plurality of sensing links between the networking device and the station and to the transmission configuration; selecting the transmission configuration as an operating transmission configuration according to the CSM; and communicating the operating transmission configuration to the station.

In a further embodiment, a system for establishing a basic service set (BSS) including an access point and a plurality of stations having a plurality of sensing links therebetween is provided. The system may include a networking device operating as the access point and including at least a transmitting antenna, a receiving antenna, and at least one processor configured to execute instructions for: establishing the BSS according to an operating channel and bandwidth (CHB) based on data transmission metrics; establishing a sensing measurement setup with the plurality of stations in the BSS, the sensing measurement setup corresponding to a transmission configuration comprising the CHB, and transmission parameters; obtaining one or more channel sensing metrics (CSMs), each CSM corresponding to a sensing link of the plurality of sensing links between the networking device and the station and to the transmission configuration; determining that at least one of the CSM of the one or more CSMs is below a quality threshold; and adjusting BSS parameters responsive to determining that the at least one of the CSM of the one or more CSMs is below the quality threshold.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system.

FIG. 2A and FIG. 2B are diagrams showing example wireless signals communicated between wireless communication devices.

FIG. 3A and FIG. 3B are plots showing examples of channel responses computed from the wireless signals communicated between wireless communication devices in FIG. 2A and FIG. 2B.

FIG. 4A and FIG. 4B are diagrams showing example channel responses associated with motion of an object in distinct regions of a space.

FIG. 4C and FIG. 4D are plots showing the example channel responses of FIG. 4A and FIG. 4B overlaid on an example channel response associated with no motion occurring in the space.

FIG. 5 depicts an implementation of some of an architecture of a system for Wi-Fi sensing, according to some embodiments.

FIG. 6 depicts an example of a WLAN sensing procedure, according to some embodiments.

FIG. 7A depicts an example of a Sensing Measurement Setup Request frame Action field format, according to some embodiments.

FIG. 7B illustrates an example of a Sensing Measurement Parameters element, according to some embodiments.

FIG. 7C illustrates an example of a format of a Sensing Measurement Parameters field, according to some embodiments.

FIG. 7D depicts an example of a Sensing Measurement Setup Response frame Action field format, according to some embodiments.

FIG. 8A depicts one-to-many and many-to-one aspects of an example of a WLAN sensing procedure, according to some embodiments.

FIG. 8B depicts pairwise aspects of an example of a WLAN sensing procedure, according to some embodiments.

FIG. 9 depicts a message flow of a trigger-based (TB) sensing measurement instance of a WLAN sensing procedure that consists of either NDPA sounding or TF sounding, according to some embodiments.

FIG. 10 depicts examples of trigger-based (TB) sensing measurement instances, according to some embodiments.

FIG. 11 depicts an example of a TB sensing measurement instance including a polling phase, an NDPA sounding phase, a trigger frame sounding phase and a reporting phase, according to some embodiments.

FIG. 12 depicts a message flow of a non-TB sensing measurement instance of a WLAN sensing procedure with both uplink and downlink sounding, according to some embodiments.

FIG. 13 depicts an example of a single non-TB sensing measurement instance consisting of a measurement sounding phase and a reporting phase, according to some embodiments.

FIG. 14 depicts an example of an Action field format of a Sensing Measurement Report frame Action field and a Sensing Measurement Report Container field format, according to some embodiments.

FIG. 15A to FIG. 15I depict a hierarchy of fields within a Sensing Trigger frame, according to some embodiments.

FIG. 16 depicts an example representation of two discrete multipaths, according to some embodiments.

FIG. 17 depicts an example of a frequency domain channel representation of a reconstructed channel state information (CSI) including a single time domain pulse, according to some embodiments.

FIG. 18A and FIG. 18B depict an example of a frequency domain channel representation of a reconstructed channel state information (CSI) including multiple time domain pulses, according to some embodiments.

FIG. 19 depicts an example of a sensing channel transfer function of a sensing transmission both in frequency domain and time domain, according to some embodiments.

FIG. 20 depicts an example of a filter mask, according to some embodiments.

FIG. 21 depicts an example of a channel sensing matrix (CSM) curve for a transmission configuration created based on a number of selected time domain pulses, according to some embodiments.

FIG. 22 depicts a flowchart for selecting a transmission configuration as an operating transmission configuration according to a CSM, according to some embodiments.

FIG. 23A and FIG. 23B depict another flowchart for selecting a transmission configuration as an operating transmission configuration according to a CSM, according to some embodiments.

FIG. 24A and FIG. 24B depict yet another flowchart for selecting a transmission configuration as an operating transmission configuration according to a CSM, according to some embodiments.

FIG. 25 depicts a flowchart for establishing a shared channel and bandwidth (CHB) as an operating CHB, according to some embodiments.

FIG. 26 depicts a flowchart for adjusting basic service set (BSS) parameters responsive to determining that the at least one of CSM of one or more CSMs is below a quality threshold, according to some embodiments.

### DETAILED DESCRIPTION

Wireless sensing enables a device to obtain sensing measurements of transmission channel(s) between two or more devices. With the execution of a wireless sensing procedure, it is possible for a device to obtain sensing measurements useful for detecting and tracking changes in the environment. In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmissions rate or sensing measurement rate to produce a time-series of measurements with finer time resolution. Controlling a variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the description are provided below.

A wireless access point (WAP) or simply an access point (AP) is a networking device in a WLAN network that allows other networking devices in a WLAN network to connect to a wired network. In examples, an AP creates a wireless local area network.

A station (STA) is any device that is connected to a WLAN network and which contains 802.11 compliant MAC and PHY interfaces to the wireless medium. A STA may be a laptop, desktop, smartphone, or a smart appliance. A STA may be fixed, mobile or portable. A STA that does not take on the role of an AP may be referred to as a non-AP STA.

A term “sensing space” may refer to any physical space in which a Wi-Fi sensing system may operate.

A term “sensing area” may refer to a part or subset of a sensing space. For example, if a sensing space represents a house, then an individual room may be a sensing area within that sensing space.

A term “sensing procedure” may refer to a procedure that allows a high-efficiency (HE) station (STA) or extremely high throughput (EHT) STA to perform sensing. A sensing procedure may be initiated with the establishment of a sensing measurement session, which may be followed by zero or more sensing measurement exchanges, and may be terminated either implicitly or explicitly with a sensing measurement session termination.

A term “sensing capabilities exchange” may refer to the beginning part of a sensing procedure, during which the sensing capabilities may be exchanged between the sensing STAs. A term “sensing capabilities exchange” may also be referred to as “sensing session setup” or “session setup”.

A term “sensing measurement session” may refer to a set of sensing measurement exchanges that use operational parameters agreed to between a sensing initiator and sensing responder and is identified by a Measurement Session ID. The term “sensing measurement session” may also be referred to as “sensing session” or “sensing measurement setup” or “measurement setup”. The term “Measurement Session ID” may also be referred to as “Measurement Setup ID”.

A term “sensing measurement exchange” may refer to part of a sensing procedure, during which sensing measurements are performed. The term “sensing measurement exchange” may also be referred to as “sensing measurement instance”.

A term “sensing initiator” may refer to a high-efficiency (HE) station (STA) or extremely high throughput (EHT) STA that initiates a sensing procedure by transmitting a Sensing Measurement Request frame, or a DMG STA that initiates a DMG sensing procedure by transmitting a DMG Sensing Measurement Request frame.

A term “sensing responder” may refer to a high-efficiency (HE) station (STA) or extremely high throughput (EHT) STA that participates in a sensing procedure by responding to a sensing initiator, or a DMG STA that participates in a DMG sensing procedure by responding to a sensing initiator.

A term “sensing transmitter” may refer to a station (STA) that transmits PPDUs used for measurements in a sensing procedure or a directional multi-gigabit (DMG) sensing procedure.

A term “sensing receiver” may refer to a station (STA) that is the intended recipient of PPDUs sent by a sensing transmitter to obtain sensing measurements in either a sensing procedure or a directional multi-gigabit (DMG) sensing procedure.

A term “transmission opportunity (TXOP)” may refer to a negotiated interval of time during which a particular quality of service (QoS) station (e.g., a STA, an AP, or either a STA or an AP, for example in the role of a sensing initiator, a sensing responder, a sensing transmitter or a sensing receiver) may have the right to initiate a frame exchange onto a wireless medium. A QoS access category (AC) of the transmission opportunity may be requested as part of a service or session negotiation.

A term “Quality of Service (QoS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have different TXOP parameters defined for it.

A term “short interframe space (SIFS)” may refer to a period within which a processing element (for example, a microprocessor, dedicated hardware, or any such element) within a device of a Wi-Fi sensing system is able to process data presented to it in a frame. In an example, a short interframe space may be 10 ms.

A term “PHY-layer Protocol Data Unit (PPDU)” may refer to a data unit that includes preamble and data fields. The preamble field may include transmission vector format information and the data field may include payload and higher layer headers.

A term “null data PPDU (NDP)” may refer to a PPDU that does not include a data field. In an example, a null data PPDU may be used for a sensing transmission, where a MAC header of the NDP includes information required for a sensing receiver to make a sensing measurement on the sensing transmission.

A term “transmission parameters” may refer to a set of IEEE 802.11 PHY transmitter configuration parameters which are defined as a part of transmission vector (TXVECTOR) corresponding to a specific PHY and which may be configurable for each PHY-layer PPDU transmission or each null data PPDU (NDP) transmission.

A term “resource unit (RU)” may refer to an allocation of orthogonal frequency division multiplexing (OFDM) channels which may be used to cany a modulated signal. An RU may include a variable number of carriers depending on the mode of the modem. In examples, an RU may be a group of 26, 52, 106, 242, 484, 996, or 2×996 subcarriers as an allocation of subcarriers for transmission.

A term “tone” may refer to an individual subcarrier in an OFDM signal. A tone may be represented in time domain or frequency domain. In the time domain, a tone may also be referred to as a symbol. In frequency domain, a tone may also be referred to as a subcarrier.

A term “time domain pulse” may refer to a complex number that represents amplitude and phase of discretized energy in time domain. When frequency domain channel state information values are obtained for each tone from a baseband receiver, time domain pulses may be obtained by performing an IFFT on the channel state information values.

A term “sensing goal” may refer to a goal of a sensing activity at a time. A sensing goal is not static and may change at any time. In an example, a sensing goal may require sensing measurements of a specific type, a specific format, or a specific precision, resolution, or accuracy to be available to a sensing algorithm.

A term “sensing space” may refer to any physical space in which a Wi-Fi sensing system may operate.

A term “wireless local area network (WLAN) sensing session” or “Wi-Fi sensing session” may refer to a period during which objects in a physical space may be probed, detected and/or characterized. In an example, during a WLAN sensing session, several devices participate in, and thereby contribute to the generation of sensing measurements. A WLAN sensing session may be referred to as a “measurement campaign.”

A term “non-sensing message” may refer to a message which is not primarily related to sensing. In an example, non-sensing messages may include data, management, and control messages.

A term “sensing measurement” may refer to a measurement of a state of a wireless channel between a transmitter device (for example, a sensing transmitter) and a receiver device (for example, a sensing receiver) derived from a sensing transmission. In an example, sensing measurement may also be referred to as channel response measurement.

A term “sensing algorithm” may refer to a computational algorithm that achieves a sensing goal. A sensing algorithm may be executed on any device in a Wi-Fi sensing system.

Wireless network management (WNM) may provide information on network conditions and may also provide a means to obtain and exchange WLAN sensing information.

A sensing receiver is a station (STA) that receives sensing transmissions (for example, PPDUs or any other transmission including a data transmission which may be opportunistically used as a sensing transmission) sent by a sensing transmitter and performs sensing measurements as part of a WLAN sensing procedure. An AP is an example of a sensing receiver. In some examples, a STA may also be a sensing receiver.

A sensing transmitter is a station (STA) that transmits a sensing transmission (for example, PPDUs or any other transmission) used for sensing measurements (for example, channel state information) in a WLAN sensing procedure. In an example, a STA is an example of a sensing transmitter. In some examples, an AP may be a sensing transmitter for Wi-Fi sensing purposes, for example where a STA acts as a sensing receiver.

A sensing initiator is a station (STA) that initiates a WLAN sensing procedure. The role of sensing initiator may be taken on by a sensing receiver, a sensing transmitter, or a separate device which includes a sensing algorithm (for example, a remote processing device).

A sensing responder is a station (STA) that participates in a WLAN sensing procedure initiated by a sensing initiator. The role of sensing responder may be taken on by a sensing receiver or a sensing transmitter. In examples, multiple sensing responders may take part in a Wi-Fi sensing session.

A sensing by proxy (SBP) initiator is defined as a non-AP STA acting as a sensing initiator that transmits a SBP Request frame. In examples, sensing by proxy (SBP) enables a non-AP STA to obtain sensing measurements of the channel between an AP and one or more non-AP STAs or between a receive antenna and a transmit antenna of an AP. With the execution of the SBP procedure, it is possible for a non-AP STA to obtain sensing measurements necessary for detecting and tracking changes in the environment. A sensing by proxy (SBP) responder is an AP that receives or is the intended recipient of an SBP Request frame.

A term “sensing transmission” may refer to a transmission made from a sensing transmitter to a sensing receiver which may be used to make a sensing measurement. In an example, a sensing transmission may also be referred to as wireless sensing signal or wireless signal.

A term “sensing trigger message” may refer to a message sent from a sensing initiator to a sensing transmitter to initiate or trigger one or more sensing transmissions.

A term “sensing response message” may refer to a message which is included within a sensing transmission from a sensing transmitter to a sensing receiver. A sensing transmission that includes a sensing response message may be used by a sensing receiver to perform a sensing measurement.

A term “sensing response announcement” may refer to a message that is included within a sensing transmission from a sensing transmitter to a sensing receiver that announces that a sensing response NDP will follow within a short interframe space (SIFS). An example of a sensing response announcement is an NDP announcement, or NDPA. In examples, a sensing response NDP may be transmitted using a requested transmission configuration.

A term “sensing response NDP” may refer to a response transmitted by a sensing transmitter and used for a sensing measurement at a sensing receiver. In examples, a sensing response NDP may be used when a requested transmission configuration is incompatible with transmission parameters required for successful non-sensing message reception. A sensing response NDP may be announced by a sensing response announcement. In an example, a sensing response NDP may be implemented with a null data PPDU. In some examples, a sensing response NDP may be implemented with a frame that does not contain any data.

A term “channel representation information (CRI)” or “channel impulse response (CIR)” may refer to properties of a communications channel, such as how wireless signals propagate from a sensing transmitter to a sensing receiver along multiple paths, which are known or measured by a technique of channel estimation. For example, CRI may refer to one or more sensing measurements made on one or more sensing transmissions during a sampling instance which together represent the state of the channel at the sampling instance between two devices.

A term “channel state information (CSI)” may refer to an example of CRI which is represented in a frequency domain. CSI indicates the properties of a communications channel which is measured by channel estimation in subcarrier-level granularity. CSI is typically a matrix of complex values representing the amplitude attenuation and phase shift of signals, which provides an estimation of a communications channel. A CSI of a subcarrier may be represented as an in-phase (real) component (I) and a quadrature (imaginary) component (Q).

A term “time-domain channel representation information (TD-CRI)” or “channel impulse response (CIR)” in time-domain may refer to an example of CRI which is represented in a time domain. TD-CRI may be generated by applying an inverse transform, such as an IDFT or an IFFT, to CSI. TD-CRI or CIR of a time domain pulse may be represented as an in-phase (real) component (I) and a quadrature (imaginary) component (Q).

A term “full time-domain channel representation information (full TD-CRI)” may refer to a series of complex pairs of time domain pulses which are created by performing an inverse fast Fourier transform (IFFT) on CSI values, for example CSI calculated by a baseband receiver.

A term “filtered time-domain channel representation information (filtered TD-CRI)” may refer to a reduced series of complex pairs of time domain pulses created by applying an algorithm to a full TD-CRI. The algorithm may select some time domain pulses and reject others. The filtered TD-CRI may contain information that relates a selected time domain pulse to the corresponding time domain pulse in the full TD-CRI.

A term “reconstructed filtered time-domain channel representation information (reconstructed filtered TD-CRI)” may refer to a version of a full TD-CRI created from a filtered TD-CRI.

A term “channel representation information transmission message” may refer to a message sent by a sensing receiver that has performed a sensing measurement on a sensing transmission, in which the sensing receiver sends CRI to a sensing initiator which may be a sensing transmitter which contains a sensing algorithm or a remote processing device which contains a sensing algorithm.

A term “reconstructed CSI (R-CSI)” may refer to a representation of original CSI values as measured by the baseband receiver that is reconstructed from a time domain channel representation information (TD-CRI). In an example, R-CSI may be calculated by taking original CSI values (frequency domain), performing an IFFT to translate those values into the time domain, selecting a number of time domain pulses, zeroing or nulling time domain tones that do not include a selected time domain pulse, and performing an FFT. The resulting frequency domain complex values are the R-CSI.

A term “feature of interest” may refer to an item or state of an item in a sensing space which is positively detected and/or identified by a sensing algorithm.

A term “sensing imprint” may refer to a steady state or semi-static representation of the propagation channel between a sensing transmitter and a sensing receiver in the sensing space calculated by the sensing receiver in the form of a time domain channel impulse response.

A term “requested transmission configuration” may refer to transmission parameters a sensing transmitter is requested to use when sending a sensing transmission.

A term “delivered transmission configuration” may refer to transmission parameters applied by a sensing transmitter to a sensing transmission.

A term “imprint delta” may refer to a single dimension matrix of complex values which represent the difference between a time domain channel impulse response generated by converting a CSI measurement to the time domain using an IFFT, and a stored sensing imprint.

A term “measurement imprint delta threshold” may refer to minimum difference between a TD-CRI value and the corresponding sensing imprint value for which a sensing receiver or a sensing algorithm considers that there is a change in the propagation channel propagation characteristics.

A term “measurement imprint delta count” may refer to a number of times which a measurement imprint delta threshold is exceeded before a sensing receiver or a sensing algorithm considers that there is a change in propagation channel propagation characteristics.

A term “imprint delta derivative period” may refer to a period during which imprint delta derivatives must remain below an imprint delta derivative threshold before a sensing receiver or a sensing algorithm may determine that a new sensing imprint needs to be calculated.

A term “imprint delta derivative” may refer to a rate of change of the imprint delta over one or more tones and over one or more frames.

A term “imprint delta derivative threshold” may refer to a maximum value of the rate imprint delta derivative for which a sensing receiver or a sensing algorithm considers that there is ongoing movement or motion in the sensing space. If the imprint delta derivative drops below the imprint delta derivative threshold, a sensing receiver or a sensing algorithm may determine that a new sensing imprint needs to be calculated.

A term “steady-state imprint delta threshold” may refer to a maximum difference between a TD-CRI value and a corresponding sensing imprint value for which a sensing receiver or a sensing algorithm considers that the TD-CRI has not returned to its steady-state (i.e., a stored sensing imprint).

A term “sensing imprint average count” may refer to a number of sensing measurements which may be averaged to generate a sensing imprint.

A term “steering matrix configuration” may refer to a matrix of complex values representing real and complex phases required to pre-condition one or more antenna of a radio frequency (RF) transmission signal chain for each transmit signal. Application of a steering matrix configuration (for example, by a spatial mapper) enables beamforming and beam-steering.

A term “spatial mapper” may refer to a signal processing element that adjusts the amplitude and phase of a signal input to an RF transmission chain in a sensing transmitter. A spatial mapper may include elements to process the signal to each RF chain implemented. The operation carried out may be called spatial mapping. The output of a spatial mapper is one or more spatial streams.

A term “sensing PPDU” may refer to a customized data packet with one or more training fields on which sensing measurements can be made and a header and data field portion which contain Motion Information elements to be shared with other networked devices in the Wi-Fi network.

A term “channel sensing metric (CSM)” may refer to a metric to determine if a certain channel (represented in either time domain or frequency domain) is suitable for Wi-Fi sensing or not.

A term “channel and bandwidth (CHB)” is a combination of a channel/bandwidth selection for assessment of CSM or for operation.

A term “transmission configuration” may refer to a combination of a CHB and a selection of transmission parameter configuration (as represented by a sensing measurement setup).

A term “channel” may refer to a collection of frequency domain subcarriers used for a sensing NDP transmission. In an example, a channel may be a 20 MHz channel or may be one or more RUs.

In a TD-CRI of a channel, “a noise tail of the channel” in the time domain may be defined as time domain pulses with amplitudes lower than a threshold (for example, noise threshold) and with larger time delays than the time delay of a last time domain pulse (along the time axis) that has amplitude higher than the threshold.

A “knee point of a CSM curve” may be defined as a number of time domain pulses, which is optimal for sensing channel to operate where adding more time domain pulses, can only add a minimal gain to the value of the CSM for the channel bandwidth.

A 2-norm of a 1×n matrix (i.e., a column vector of length n) is represented by the following expression:

$${‖ x ‖}_{2} = \sqrt{( {\sum }_{i = 1}^{n} {\vert {x}_{i} \vert}^{2} )}$$

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a wireless sensing system configurated to send sensing transmissions and make sensing measurements.

Section C describes embodiments of systems and methods that are useful for determination of channel sensing quality using channel sensing metric (CSM).

### A. Wireless Communications System, Wireless Transmissions and Sensing Measurements

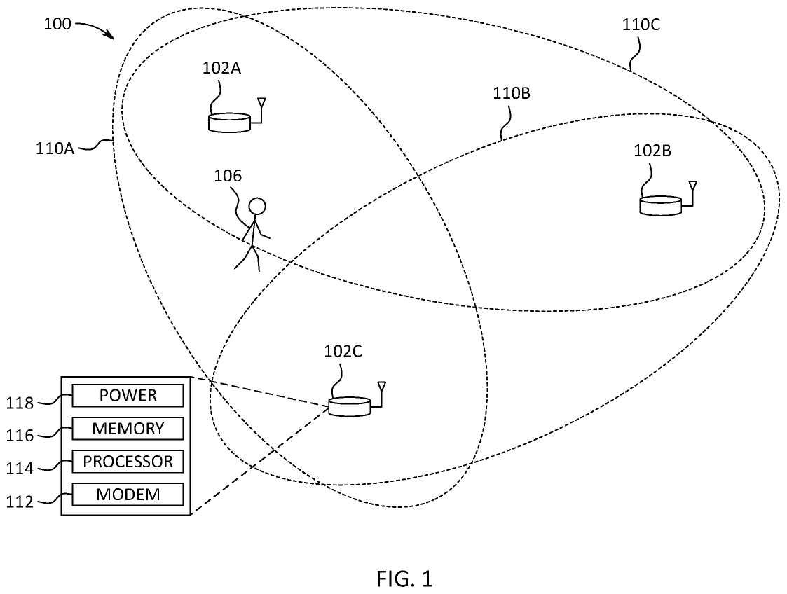

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes herein disclosed.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

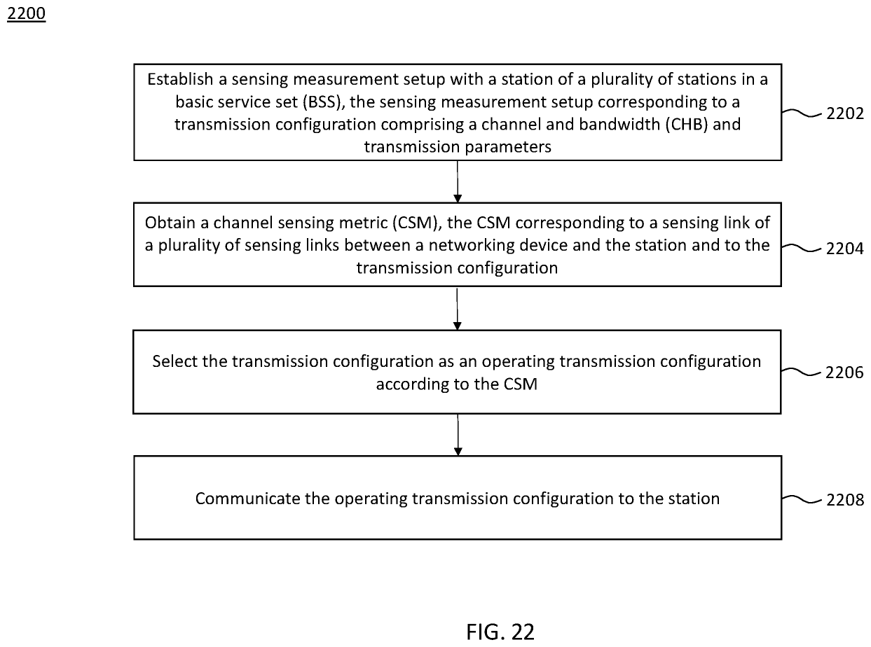

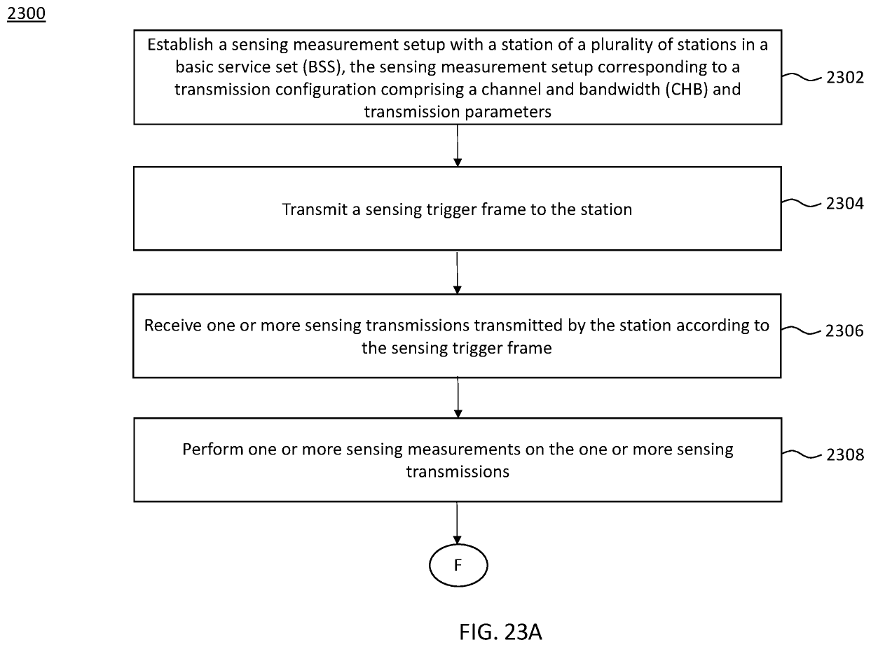

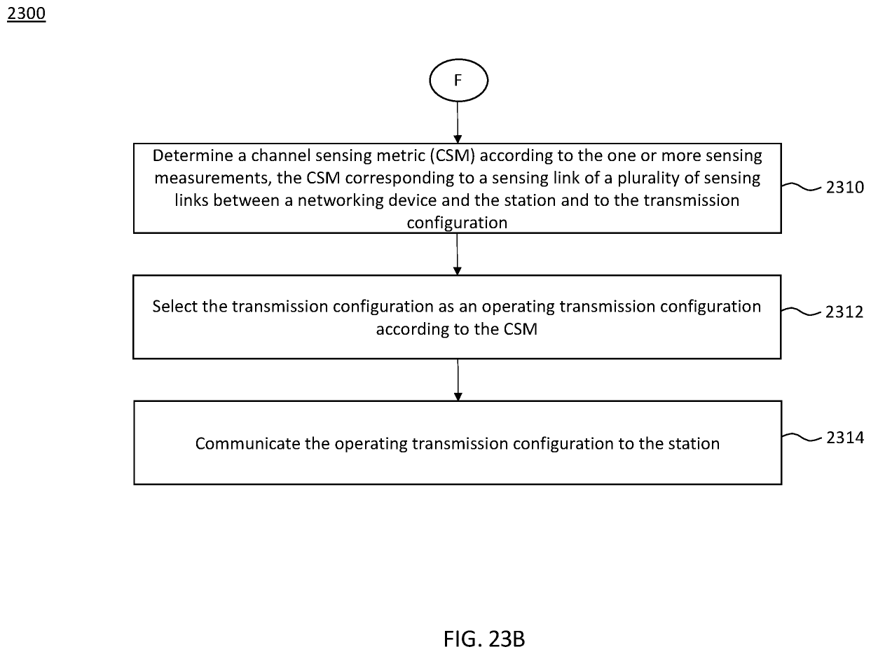

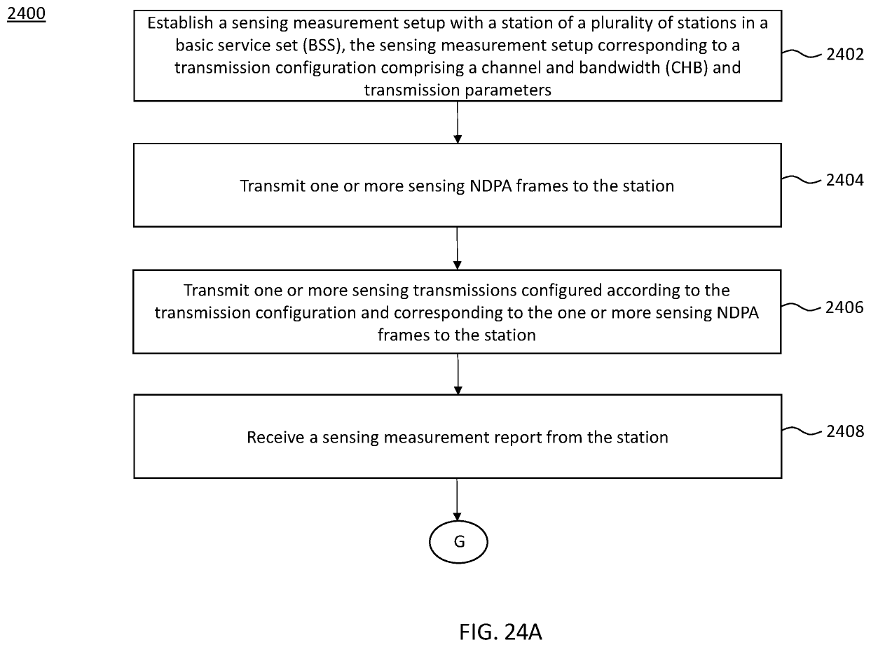

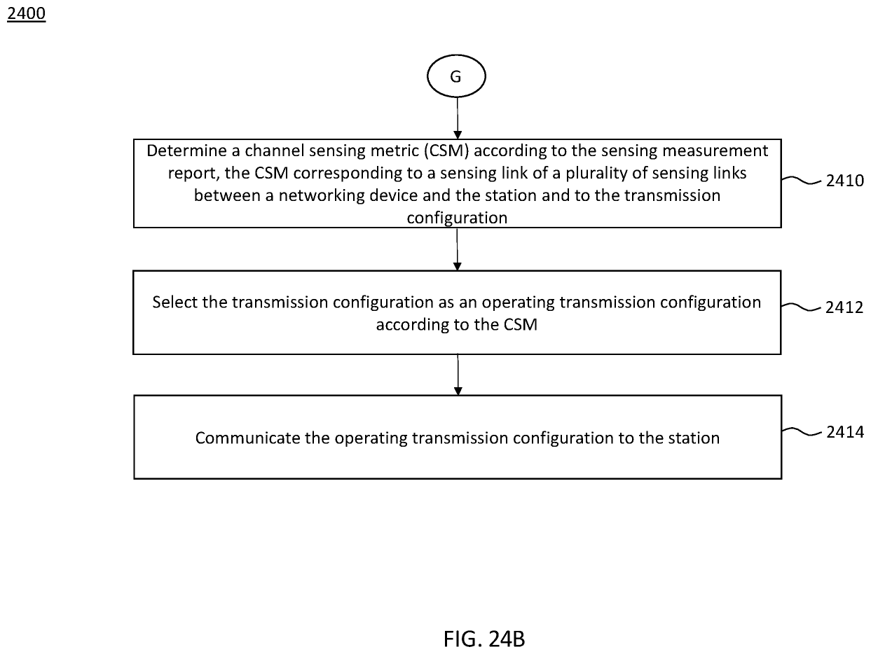

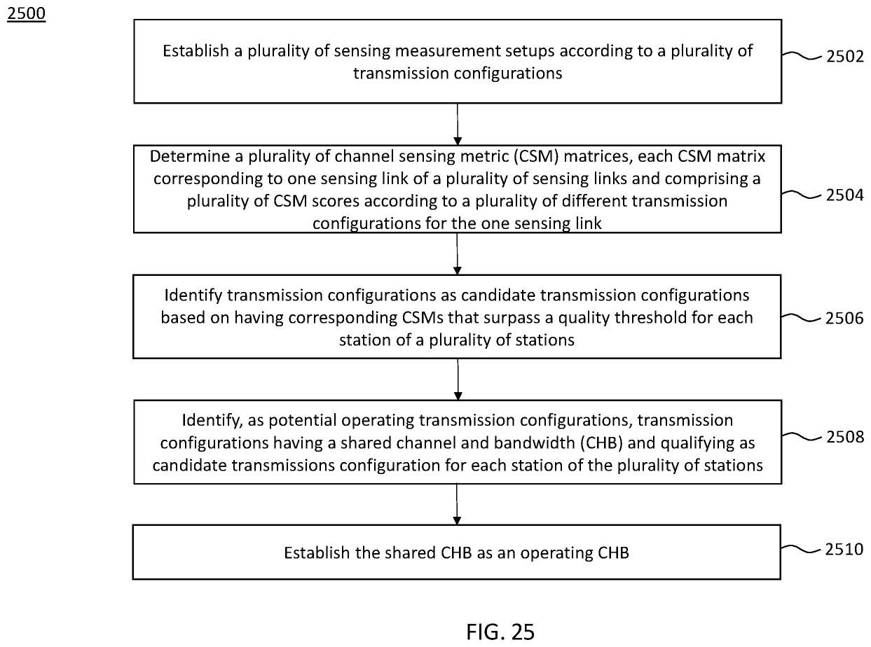

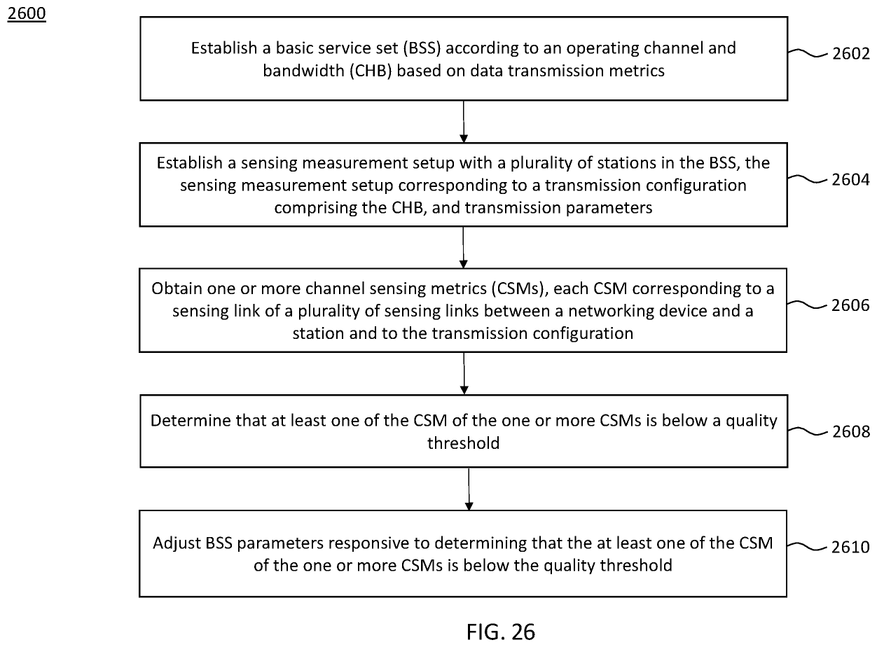

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 22, FIG. 23A, FIG. 23B, FIG. 24A, FIG. 24B, FIG. 25, and FIG. 26, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

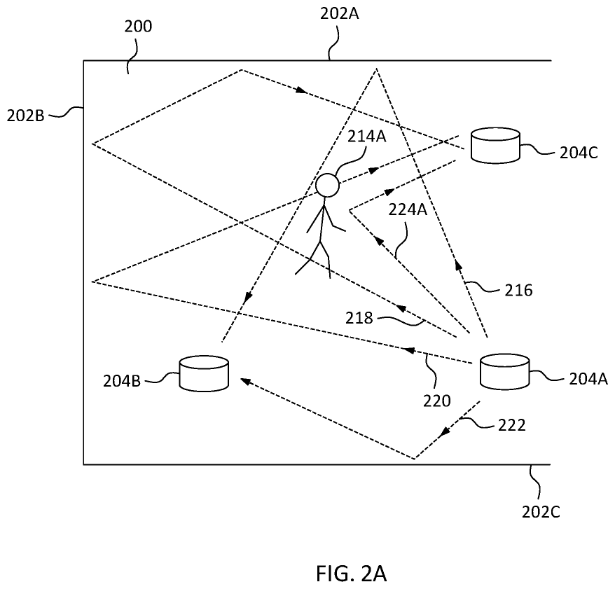

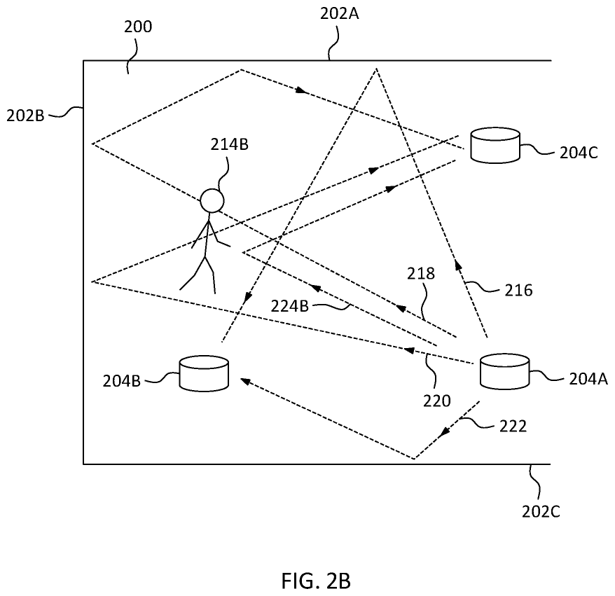

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B and 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and φ_{n,k} represents the phase of the signal for nth frequency component along k. Then, the received signal, R, at a wireless communication device can be described as the summation of all output signals rₖ(t) from all paths to the wireless communication device, which is shown in Equation (3):

R=Σₖrₖ(t) (3)

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

Hₙ=Σₖcₙα_{n,k}e^{jφ}^{_{n,k}} (5)

Ha for a given ωₙ indicates a relative magnitude and phase offset of the received signal at on. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion as in Equation (8):

$${min}_{{h}_{ch}} \{ \sum {( {\hat{R}}_{cvd} - {R}_{cvd} )}^{2} \} \qquad ( 8 )$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

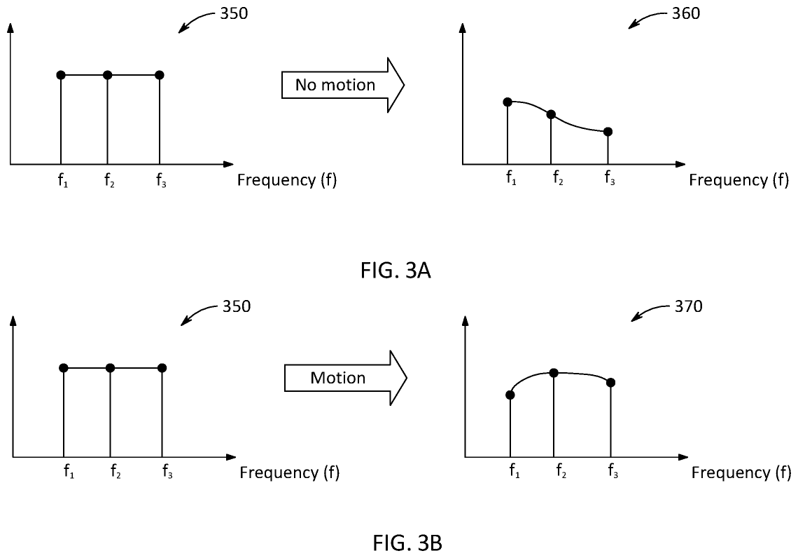

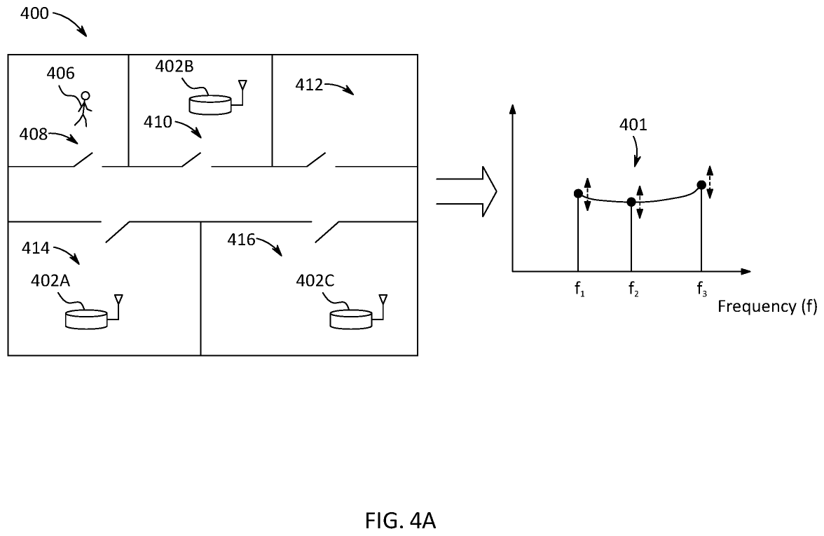

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

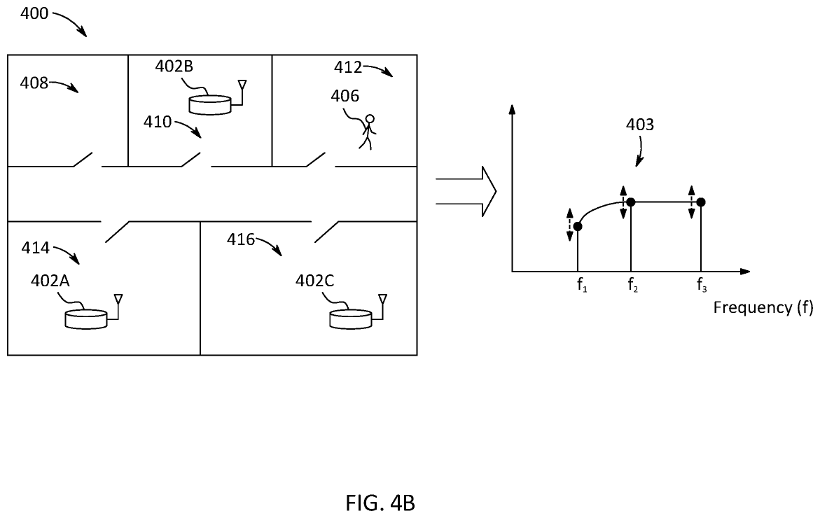

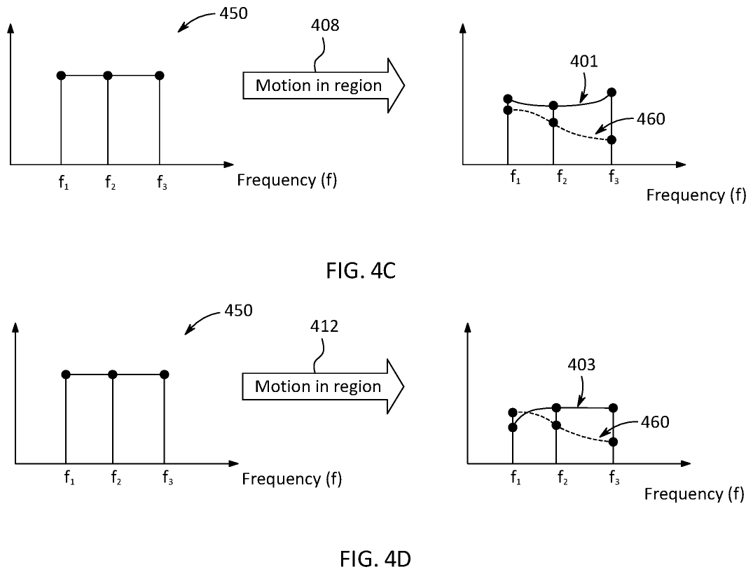

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions—first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configurated to send sensing transmissions and make sensing measurements.

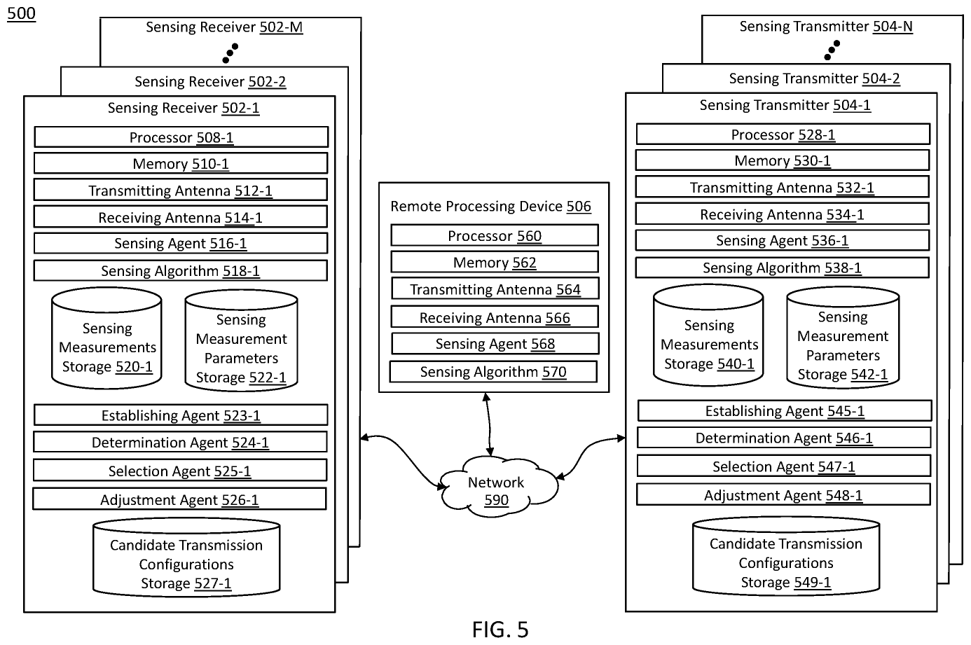

FIG. 5 depicts an implementation of some of an architecture of an implementation of system 500 for Wi-Fi sensing, according to some embodiments.

System 500 may include a plurality of networking devices. In an example, system 500 may include plurality of sensing receivers 502-(1-M), plurality of sensing transmitters 504-(1-N), remote processing device 506, and network 560 enabling communication between the system components for information exchange. In an example implementation, plurality of sensing transmitters 504-(1-N) may include at least first sensing transmitter 504-1 and second sensing transmitter 504-2. In an example implementation, plurality of sensing receivers 502-(1-M) may include at least first sensing receiver 502-1 and second sensing receiver 502-2. System 500 may be an example or instance of wireless communication system 100 and network 560 may be an example or instance of wireless network or cellular network, details of which are provided with reference to FIG. 1 and its accompanying description.

According to an embodiment, plurality of sensing receivers 502-(1-M) may be configured to receive one or more sensing transmissions (for example, from one or more of plurality of sensing transmitters 504-(1-N)) and perform one or more measurements (for example, channel representation information (CRI) measurements such as channel state information (CSI) or time domain channel representation information (TD-CRI)) useful for Wi-Fi sensing. In examples, these measurements may be known as sensing measurements. Sensing measurements may be processed to achieve a sensing goal of system 500. In an embodiment, one or more of plurality of sensing receivers 502-(1-M) may be an AP. In some embodiments, one or more of plurality of sensing receivers 502-(1-M) may take a role of sensing initiator and/or sensing responder.

According to an implementation, one or more of plurality of sensing receivers 502-(1-M) may be implemented by a device, such as wireless communication device 102 shown in FIG. 1. In some implementations, one or more of plurality of sensing receivers 502-(1-M) may be implemented by a device, such as wireless communication device 204 shown in FIG. 2A and FIG. 2B. Further, one or more of plurality of sensing receivers 502-(1-M) may be implemented by a device, such as wireless communication device 402 shown in FIG. 4A and FIG. 4B. In an implementation, one or more of plurality of sensing receivers 502-(1-M) may coordinate and control communication among plurality of sensing transmitters 504-(1-N). According to an implementation, one or more of plurality of sensing receivers 502-(1-M) may be enabled to control a sensing measurement session comprising one or more sensing measurement instances to ensure that required sensing transmissions are made at a required times and to ensure an accurate determination of one or more sensing measurements. In some embodiments, one or more of plurality of sensing receivers 502-(1-M) may process sensing measurements to achieve the sensing goal of system 500. In some embodiments, one or more of plurality of sensing receivers 502-(1-M) may be configured to transmit sensing measurements to one or more of plurality of sensing transmitters 504-(1-N), and one or more of plurality of sensing transmitters 504-(1-N) may be configured to process the sensing measurements to achieve a sensing result of system 500.

In an embodiment, one or more of plurality of sensing receivers 502-(1-M) may be a STA. In an embodiment, one or more of plurality of sensing receivers 502-(1-M) may be an AP. In some embodiments, one or more of plurality of sensing receivers 502-(1-M) may be configured to transmit sensing measurements to remote processing device 506, and remote processing device 506 may be configured to process sensing measurements to achieve the sensing goal of system 500. In some embodiments, first sensing receiver 502-1 may be any computing device, such as a desktop computer, a laptop, a tablet computer, a mobile device, a personal digital assistant (PDA), or any other computing device.

Referring again to FIG. 5, in some embodiments, one or more of plurality of sensing transmitters 504-(1-N) may be configured to send one or more sensing transmissions to one or more of plurality of sensing receivers 502-(1-M) based on which one or more sensing measurements may be performed for Wi-Fi sensing. In an embodiment, one or more of plurality of sensing transmitters 504-(1-N) may be a STA. In an embodiment, one or more of plurality of sensing transmitters 504-(1-N) may be an AP. In some embodiments, one or more of plurality of sensing transmitters 504-(1-N) may take a role of sensing initiator and/or sensing responder.

According to an implementation, one or more of plurality of sensing transmitters 504-(1-N) may be implemented by a device, such as wireless communication device 102 shown in FIG. 1. In some implementations, one or more of plurality of sensing transmitters 504-(1-N) may be implemented by a device, such as wireless communication device 204 shown in FIG. 2A and FIG. 2B. Further, one or more of plurality of sensing transmitters 504-(1-N) may be implemented by a device, such as wireless communication device 402 shown in FIG. 4A and FIG. 4B. In some embodiments, first sensing transmitter 504-1 may be any computing device, such as a desktop computer, a laptop, a tablet computer, a mobile device, a PDA, or any other computing device. In some implementations, communication between one or more of plurality of sensing receivers 502-(1-M) and one or more of plurality of sensing transmitters 504-(1-N) may happen via station management entity (SME) and MAC layer management entity (MLME) protocols.

In some embodiments, remote processing device 506 may be configured to receive sensing measurements from one or more of plurality of sensing receivers 502-(1-M) and process the sensing measurements. In an example, remote processing device 506 may process and analyze sensing measurements to identify one or more features of interest. According to some implementations, remote processing device 506 may include/execute a sensing algorithm. In an embodiment, remote processing device 506 may be a STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a personal digital assistant (PDA) or any other computing device. In embodiments, remote processing device 506 may take a role of sensing initiator where a sensing algorithm determines a Wi-Fi sensing session and the sensing measurements required to fulfill the measurement campaign. In an example, remote processing device 506 may communicate sensing measurement parameters and/or transmission parameters required to initiate a Wi-Fi sensing session to one or more of plurality of sensing receivers 502-(1-M) and/or to one or more of plurality of sensing transmitters 504-(1-N) to coordinate and control sensing transmissions for performing sensing measurements.

Referring to FIG. 5 in more detail, sensing receiver 502-1 (which is an example of one or more of plurality of sensing receivers 502-(1-M)) may include processor 508-1 and memory 510-1. For example, processor 508-1 and memory 510-1 of sensing receiver 502-1 may be processor 114 and memory 116, respectively, as shown in FIG. 1. In an embodiment, sensing receiver 502-1 may further include transmitting antenna(s) 512-1, receiving antenna(s) 514-1, and sensing agent 516-1. In some embodiments, an antenna may be used to both transmit and receive signals in a half-duplex format. When the antenna is transmitting, it may be referred to as transmitting antenna 512-1, and when the antenna is receiving, it may be referred to as receiving antenna 514-1. It is understood by a person of normal skill in the art that the same antenna may be transmitting antenna 512-1 in some instances and receiving antenna 514-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1, and a group of antenna elements used to receive a composite signal may be referred to as receiving antenna 514-1. In some examples, each antenna is equipped with its own transmission and receive paths, which may be alternately switched to connect to the antenna depending on whether the antenna is operating as transmitting antenna 512-1 or receiving antenna 514-1.

In an implementation, sensing agent 516-1 may be responsible for causing sensing receiver 502-1 to receive sensing transmissions and associated sensing measurement parameters and/or transmission parameters, to calculate sensing measurements. In examples, sensing agent 516-1 may be responsible for processing sensing measurements to fulfill a sensing goal. In some implementations, receiving sensing transmissions and optionally associated sensing measurement parameters and/or transmission parameters, and calculating sensing measurements may be carried out by sensing agent 516-1 running in the medium access control (MAC) layer of sensing receiver 502-1 and processing sensing measurements to fulfill a sensing goal may be carried out by an algorithm running in the application layer of sensing receiver 502-1, for example sensing algorithm 518-1. In examples, a sensing algorithm 518-1 running in the application layer of sensing receiver 502-1 may be known as a Wi-Fi sensing agent, a sensing application, or sensing algorithm. In examples, sensing algorithm 518-1 may include and/or execute sensing agent 516-1. According to some implementations, sensing agent 516-1 may include and/or execute sensing algorithm 518-1. In some implementations, sensing agent 516-1 running in the MAC layer of sensing receiver 502-1 and sensing algorithm 518-1 running in the application layer of sensing receiver 502-1 may run separately on processor 508-1. In an implementation, sensing agent 516-1 may pass one or more of sensing measurement parameters, transmission parameters, or physical layer parameters (e.g., such as channel representation information, examples of which are CSI, CIR and TD-CRI) between the MAC layer of sensing receiver 502-1 and the application layer of sensing receiver 502-1. In an example, sensing agent 516-1 in the MAC layer or sensing algorithm 518-1 in the application layer may operate on physical layer parameters, for example to detect one or more features of interest. In examples, sensing algorithm 518-1 may form services or features, which may be presented to an end-user. According to an implementation, communication between the MAC layer of sensing receiver 502-1 and other layers or components of sensing receiver 502-1 (including the application layer) may take place based on communication interfaces, such as an MLME interface and a data interface. In examples, sensing agent 516-1 may be configured to determine a number and timing of sensing transmissions and sensing measurements for the purpose of Wi-Fi sensing. In some implementations, sensing agent 516-1 may be configured to transmit sensing measurements to plurality of sensing transmitters 504-(1-N) and/or remote processing device 506 for further processing. In an implementation, sensing agent 516-1 may be configured to cause at least one transmitting antenna of transmitting antenna(s) 512-1 to transmit messages to one or more of plurality of sensing transmitters 504-(1-N) or to remote processing device 506. Further, sensing agent 516-1 may be configured to receive, via at least one receiving antenna of receiving antennas(s) 514-1, messages from one or more of plurality of sensing transmitters 504-(1-N) or from remote processing device 506. In an example, sensing agent 516-1 may be configured to make sensing measurements based on sensing transmissions received from one or more of plurality of sensing transmitters 504-(1-N).

In some embodiments, sensing receiver 502-1 may include sensing measurements storage 520-1. In an implementation, sensing measurements storage 520-1 may store sensing measurements computed by sensing receiver 502-1 based on received sensing transmissions. In an example, sensing measurements stored in sensing measurements storage 520-1 may be periodically or dynamically updated as required. In some embodiments, sensing receiver 502-1 may include sensing measurement parameters storage 522-1. In an implementation, sensing measurement parameters storage 522-1 may store sensing measurement parameters and/or transmission parameters applicable to one or more sensing measurement setups. In an implementation, sensing measurement parameters storage 522-1 may store sensing measurement parameters and/or transmission parameters applicable to one or more sensing measurement sessions. In an implementation, sensing measurement parameters storage 522-1 may store sensing measurement parameters and/or transmission parameters applicable to one or more sensing measurement instances. In an example, sensing measurement parameters and/or transmission parameters stored in sensing measurement parameters storage 522-1 may be periodically or dynamically updated as required. In an implementation, sensing measurements storage 520-1 and sensing measurement parameters storage 522-1 may include any type or form of storage, such as a database or a file system or coupled to memory 510-1.

In an implementation, sensing receiver 502-1 may include establishing agent 523-1, determination agent 524-1, selection agent 525-1, and adjustment agent 526-1. In an implementation, establishing agent 523-1, determination agent 524-1, selection agent 525-1, and adjustment agent 526-1 may be coupled to processor 508-1 and memory 510-1. In some embodiments, establishing agent 523-1, determination agent 524-1, selection agent 525-1, and adjustment agent 526-1 amongst other units, may include routines, programs, objects, components, data structures, etc., which may perform particular tasks or implement particular abstract data types. Establishing agent 523-1, determination agent 524-1, selection agent 525-1, and adjustment agent 526-1 may also be implemented as, signal processor(s), state machine(s), logic circuitries, and/or any other device or component that manipulates signals based on operational instructions.

In some embodiments, establishing agent 523-1, determination agent 524-1, selection agent 525-1, and adjustment agent 526-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or the processing unit may be dedicated to performing the required functions. In some embodiments, establishing agent 523-1, determination agent 524-1, selection agent 525-1, and adjustment agent 526-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 510-1.

In some embodiments, sensing receiver 502-1 may include candidate transmission configurations storage 527-1. In an implementation, candidate transmission configurations storage 527-1 may store candidate transmission configurations. In an example, candidate transmission configurations stored in candidate transmission configurations storage 527-1 may be periodically or dynamically updated as required. In an implementation, candidate transmission configurations may include any type or form of storage, such as a database or a file system or coupled to memory 510-1.

Referring again to FIG. 5, sensing transmitter 504-1 (which is an example of one or more of plurality of sensing transmitters 504-(1-N)) may include processor 528-1 and memory 530-1. For example, processor 528-1 and memory 530-1 of sensing transmitter 504-1 may be processor 114 and memory 116, respectively, as shown in FIG. 1. In an embodiment, sensing transmitter 504-1 may further include transmitting antenna(s) 532-1, receiving antenna(s) 534-1, and sensing agent 536-1.

Sensing agent 536-1 may be configured to cause at least one transmitting antenna of transmitting antenna(s) 532-1 and at least one receiving antenna of receiving antennas(s) 534-1 to exchange messages with one or more of plurality of sensing receivers 502-(1-M)) or with remote processing device 506. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In an implementation, sensing agent 536-1 may be responsible for causing sensing transmitter 504-1 to send sensing transmissions and, in examples, receive associated sensing measurements from one or more of plurality of sensing receivers 502-(1-M). In examples, sensing agent 536-1 may be responsible for processing sensing measurements to fulfill a sensing goal. In some implementations, sensing agent 536-1 may run in the medium access control (MAC) layer of sensing transmitter 504-1 and processing sensing measurements to fulfill a sensing goal may be carried out by sensing algorithm 538-1, which in examples may run in the application layer of sensing transmitter 504-1. In examples, sensing algorithm 538-1 running in the application layer of sensing transmitter 504-1 may be known as a Wi-Fi sensing agent, a sensing application, or a sensing algorithm. In examples, sensing algorithm 538-1 may include and/or execute sensing agent 536-1. According to some implementations, sensing agent 536-1 may include and/or execute sensing algorithm 538-1. In some implementations, sensing agent 536-1 may run in the MAC layer of sensing transmitter 504-1 and sensing algorithm 538-1 may run in the application layer of sensing transmitter 504-1. In some implementations, sensing agent 536-1 of sensing transmitter 504-1 and sensing algorithm 538-1 may run separately on processor 528-1. In an implementation, sensing agent 536-1 may pass sensing measurement parameters, transmission parameters, or physical layer parameters between the MAC layer of sensing transmitter 504-1 and the application layer of sensing transmitter 504-1. In an example, sensing agent 536-1 in the MAC layer or sensing algorithm 538-1 in the application layer may control physical layer parameters, for example physical layer parameters used to generate one or more sensing transmissions. In examples, sensing algorithm 538-1 may form services or features, which may be presented to an end-user. According to an implementation, communication between the MAC layer of sensing transmitter 504-1 and other layers or components of sensing transmitter 504-1 (including the application layer) may take place based on communication interfaces, such as an MLME interface and a data interface. In examples, sensing agent 536-1 may be configured to determine a number and timing of sensing transmissions for the purpose of Wi-Fi sensing. In some implementations, sensing agent 536-1 may be configured to cause sensing transmitter 504-1 to transmit sensing transmissions to one or more of plurality of sensing receivers 502-(1-M). In an implementation, sensing agent 536-1 may be configured to cause at least one transmitting antenna of transmitting antenna(s) 532-1 to transmit messages to one or more of plurality of sensing receivers 502-(1-M) or to remote processing device 506. Further, sensing agent 536-1 may be configured to receive, via at least one receiving antenna of receiving antennas(s) 534-1, messages from one or more of plurality of sensing receivers 502-(1-M) or from remote processing device 506.

In some embodiments, sensing transmitter 504-1 may include sensing measurements storage 540-1. In an implementation, sensing measurements storage 540-1 may store sensing measurements computed by one or more of plurality of sensing receivers 502-(1-M) based on sensing transmissions sent by sensing transmitter 504-1 and sent by one or more of plurality of sensing receivers 502-(1-M) to sensing transmitter 504-1. In an example, sensing measurements stored in sensing measurements storage 540-1 may be periodically or dynamically updated as required. In an implementation, sensing measurements storage 540-1 may include any type or form of storage, such as a database or a file system or coupled to memory 530-1.

In some embodiments, sensing transmitter 504-1 may include sensing measurement parameters storage 542-1. In an implementation, sensing measurement parameters storage 542-1 may store sensing measurement parameters and/or transmission parameters applicable to one or more sensing measurement sessions. In an implementation, sensing measurement parameters storage 542-1 may store sensing measurement parameters and/or transmission parameters applicable to one or more sensing measurement setups. In an implementation, sensing measurement parameters storage 542-1 may store sensing measurement parameters and/or transmission parameters applicable to one or more sensing measurement instances. In an example, sensing measurement parameters and/or transmission parameters stored in sensing measurement parameters storage 542-1 may be periodically or dynamically updated as required. In an implementation, sensing measurements storage 540-1 and sensing measurement parameters storage 542-1 may include any type or form of storage, such as a database or a file system or coupled to memory 530-1.

In an implementation, sensing transmitter 504-1 may include establishing agent 545-1, determination agent 546-1, selection agent 547-1, and adjustment agent 548-1. In an implementation, establishing agent 545-1, determination agent 546-1, selection agent 547-1, and adjustment agent 548-1 may be coupled to processor 528-1 and memory 530-1. In some embodiments, establishing agent 545-1, determination agent 546-1, selection agent 547-1, and adjustment agent 548-1 amongst other units, may include routines, programs, objects, components, data structures, etc., which may perform particular tasks or implement particular abstract data types. Establishing agent 545-1, determination agent 546-1, selection agent 547-1, and adjustment agent 548-1 may also be implemented as signal processor(s), state machine(s), logic circuitries, and/or any other device or component that manipulates signals based on operational instructions.

In some embodiments, establishing agent 545-1, determination agent 546-1, selection agent 547-1, and adjustment agent 548-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or the processing unit may be dedicated to performing the required functions. In some embodiments, establishing agent 545-1, determination agent 546-1, selection agent 547-1, and adjustment agent 548-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 530-1.

In some embodiments, sensing transmitter 504-1 may include candidate transmission configurations storage 549-1. In an implementation, candidate transmission configurations storage 549-1 may store candidate transmission configurations. In an example, candidate transmission configurations stored in candidate transmission configurations storage 549-1 may be periodically or dynamically updated as required. In an implementation, candidate transmission configurations may include any type or form of storage, such as a database or a file system or coupled to memory 530-1.

Referring to FIG. 5 in more detail, remote processing device 506 may include processor 560 and memory 562. For example, processor 560 and memory 562 of remote processing device 506 may be processor 114 and memory 116, respectively, as shown in FIG. 1. In an embodiment, remote processing device 506 may further include transmitting antenna(s) 564, receiving antenna(s) 566, sensing agent 568, and sensing algorithm, 570. In some embodiments, an antenna may be used to both transmit and receive signals in a half-duplex format. When the antenna is transmitting, it may be referred to as transmitting antenna 564, and when the antenna is receiving, it may be referred to as receiving antenna 566. It is understood by a person of normal skill in the art that the same antenna may be transmitting antenna 564 in some instances and receiving antenna 566 in other instances. In the case of an antenna array, one or more antenna elements may be used to transmit or receive a signal, for example, in a beamforming environment. In some examples, a group of antenna elements used to transmit a composite signal may be referred to as transmitting antenna 564, and a group of antenna elements used to receive a composite signal may be referred to as receiving antenna 566. In some examples, each antenna is equipped with its own transmission and receive paths, which may be alternately switched to connect to the antenna depending on whether the antenna is operating as transmitting antenna 564 or receiving antenna 566.

In an implementation, sensing agent 568 may be responsible for determining sensing measurement parameters and/or transmission parameters for one or more sensing measurement setups. In examples, sensing agent 568 may receive sensing measurement parameters and/or transmission parameters for one or more sensing measurement setups from sensing algorithm 570. In an example, sensing agent 568 may receive sensing measurements from one or more of plurality of sensing receivers 502-(1-M) and may process the sensing measurements to fulfill a sensing goal. In an example, sensing agent 568 may receive channel representation information (such as CSI or TD-CRI) from one or more of plurality of sensing receivers 502-(1-M) and may process the channel representation information to fulfill a sensing goal. In implementations, sensing agent 568 may receive sensing measurements or channel representation information and may provide the received sensing measurements or channel representation information to sensing algorithm 570, and sensing algorithm 570 may receive the sensing measurements or channel representation information from sensing agent 568 and may process the information to fulfill a sensing goal.

In some implementations, receiving sensing measurements may be carried out by an algorithm running in the medium access control (MAC) layer of remote processing device 506 and processing sensing measurements to fulfill a sensing goal may be carried out by an algorithm running in the application layer of remote processing device 506. In examples, the algorithm running in the application layer of remote processing device 506 may be known as a Wi-Fi sensing agent, a sensing application, or sensing algorithm. In some implementations, the algorithm running in the MAC layer of remote processing device 506 and the algorithm running in the application layer of remote processing device 506 may run separately on processor 548. In an implementation, sensing agent 568 may pass physical layer parameters (e.g., such as channel representation information, examples of which are CSI and TD-CRI) from the MAC layer of remote processing device 506 to the application layer of remote processing device 506 and may use the physical layer parameters to detect one or more features of interest. In an example, the application layer may operate on the physical layer parameters and form services or features, which may be presented to an end-user. According to an implementation, communication between the MAC layer of remote processing device 506 and other layers or components of remote processing device 506 may take place based on communication interfaces, such as an MLME interface and a data interface. According to some implementations, sensing agent 568 may include/execute a sensing algorithm 570. In an implementation, sensing agent 568 may process and analyze sensing measurements using sensing algorithm 570 and identify one or more features of interest. Further, sensing agent 568 may be configured to determine a number and timing of sensing transmissions and sensing measurements for the purpose of Wi-Fi sensing. In some implementations, sensing agent 568 may be configured to cause one or more of plurality of sensing transmitters 504-(1-N) to transmit sensing measurements to one or more of plurality of sensing receivers 502-(1-M).

For ease of explanation and understanding, descriptions provided above may be with reference to sensing receiver 502-1 or sensing transmitter 504-1, however, the description is equally applicable to one or more of plurality of sensing receivers 501-(1-M) and/or one or more of plurality of sensing transmitters 504-(1-N).

According to one or more implementations, communications in network 560 may be governed by one or more of the 802.11 family of standards developed by IEEE. Some example IEEE standards may include IEEE 802.11, IEEE 802.11ax, IEEE 802.11me, IEEE 802.11az and IEEE 802.11be. IEEE 802.11 and IEEE 802.11ax are fully-ratified standards whilst IEEE 802.11me reflects an ongoing maintenance update to the IEEE 802.11 standard and IEEE 802.11be defines the next generation of standard. IEEE 802.11az is an extension of the IEEE 802.11 and IEEE 802.11ax standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax included OFDMA, which allows sensing receiver 502 to simultaneously transmit data to all participating devices, such as plurality of sensing transmitters 504-(1-N), and vice versa using a single transmission opportunity (TXOP). The efficiency of OFDMA depends on how sensing receiver 502 schedules channel resources (interchangeably referred to as RUs) among plurality of sensing transmitters 504-(1-N) and configures transmission parameters. According to an implementation, system 500 may be an OFDMA enabled system.

Referring back to FIG. 5, according to one or more implementations, Wi-Fi sensing system 500 may participate in a sensing session. In examples, a sensing session is an agreement between a sensing initiator and a sensing responder to participate in a WLAN sensing procedure (also known as a Wi-Fi sensing procedure.) In examples, sensing measurement parameters associated with a sensing session may be determined by a sensing initiator and may be exchanged between the sensing initiator and a sensing responder. In examples, sensing initiator may be sensing transmitter 504-1 and sensing responder may be sensing receiver 502-1. In examples, sensing initiator may be sensing receiver 502-1 and sensing responder may be sensing transmitter 504-1. In examples, sensing initiator may be remote processing device 506, and both sensing transmitter 504-1 and sensing receiver 502-1 are sensing responders. In examples, sensing transmitter 504-1 may participate in multiple sensing sessions either as a sensing initiator or as a sensing responder. In examples, sensing receiver 502-1 may participate in multiple sensing sessions either as a sensing initiator or as a sensing responder. In examples, remote processing device may participate in multiple sensing sessions as a sensing initiator.

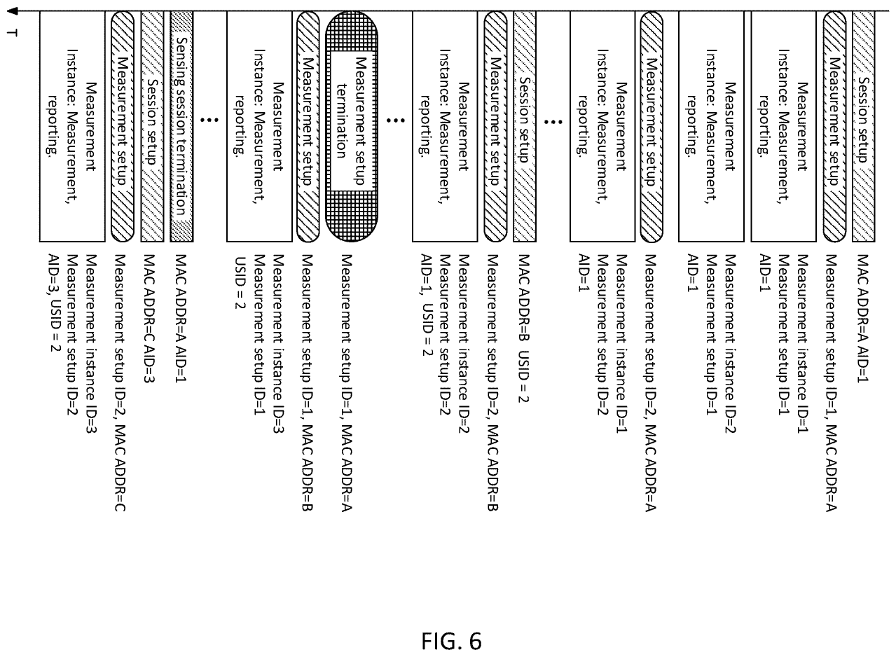

FIG. 6 is reproduced from IEEE P802.11bf and illustrates an example of a WLAN sensing procedure (also known as a Wi-Fi sensing procedure) according to some embodiments. In examples, a WLAN sensing procedure allows a STA to perform WLAN sensing. In an example, a WLAN sensing procedure enables a STA to obtain one or more sensing measurements of the wireless transmission channel between two or more STAs and or the wireless transmission channel between a receive antenna and a transmit antenna of a STA. In examples, a WLAN sensing procedure is composed of one or more of a sensing session setup, a sensing measurement setup, one or more sensing measurement instances, sensing measurement setup termination, and sensing session termination.

FIG. 6 illustrates a sensing session setup with a STA with MAC ADDR=A and AID=1, In examples, a sensing session setup establishes a sensing session. In examples, the sensing session may be identified by the AID of the STA involved in the sensing session. FIG. 6 illustrates a sensing measurement setup procedure for the STA with MAC ADDR=A, where the sensing measurement setup ID=1.

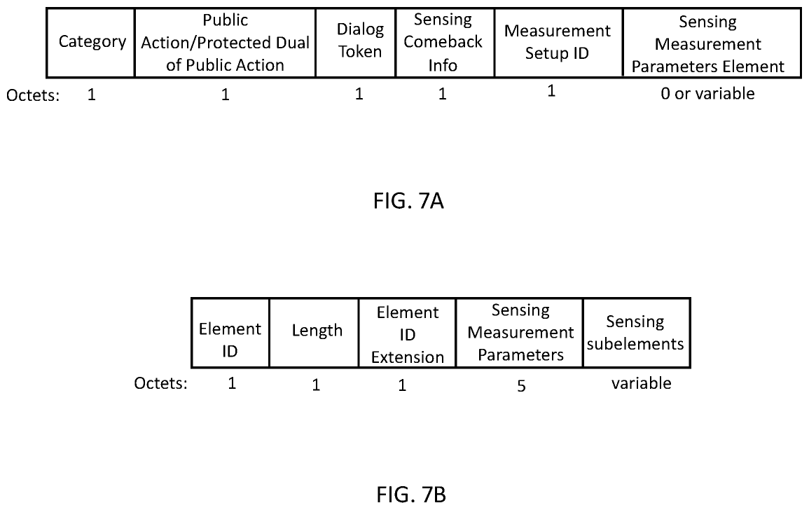

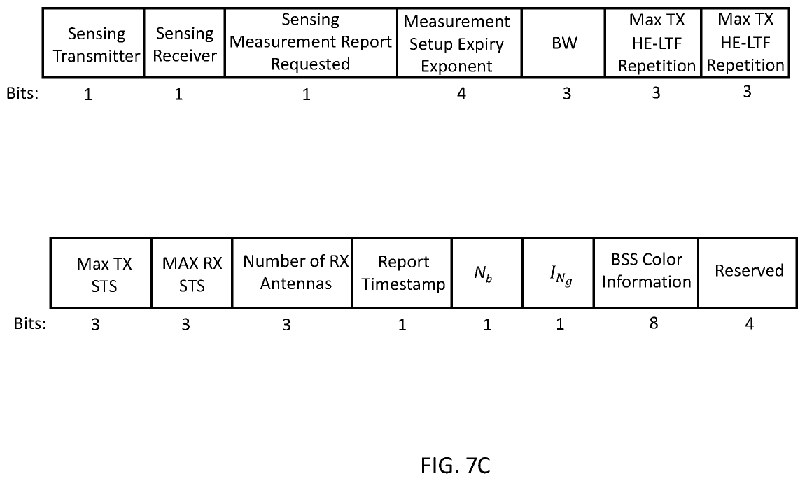

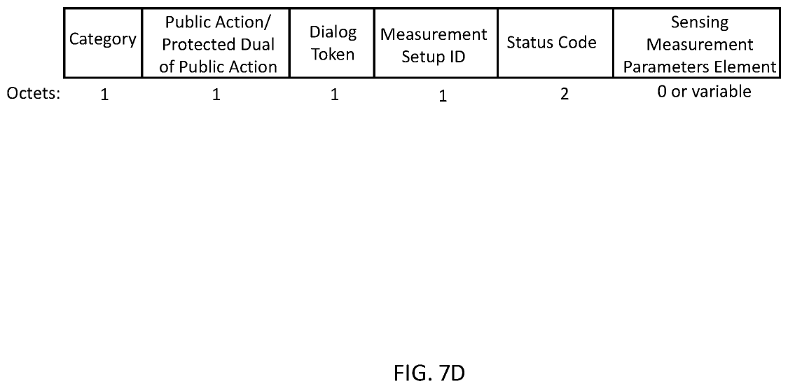

In examples, a sensing measurement setup allows for a sensing initiator and a sensing responder to exchange and agree on operational attributes associated with a sensing measurement instance. A sensing initiator may transmit a Sensing Measurement Setup Request frame to a sensing responder with which it intends to perform a sensing measurement setup. An example of a Sensing Measurement Setup Request frame Action field is provided in FIG. 7A. As shown in the example illustrated in FIG. 7A, in embodiments, a Sensing Measurement Setup Request frame Action field format may include one or more of a Category field, a Public Action field, a Dialog Token field, a Sensing Comeback Info field, a Measurement Setup ID field, and a Sensing Measurement Parameters element. In examples, a Category value code is defined for a “Protected Sensing Frame.” In an embodiment, a Protected Sensing Action field is defined in the octet immediately after the Category field in order to differentiate Protected Sensing Frame formats from Public Sensing Frame formats.

FIG. 7B is reproduced from IEEE P802.11bf and illustrates an example, according to some embodiments, of a Sensing Measurement Parameters element. In examples, a Sensing Measurement Parameters element indicates operational attributes of a corresponding sensing measurement instance. In examples, the Sensing Measurement Parameters element comprises a Sensing Measurement Parameters field and a Sensing subelements field. FIG. 7C illustrates an example of a format of a Sensing Measurement Parameters field, according to some embodiments. In an example, a Sensing Measurement Parameters field comprises a Sensing Transmitter subfield. The Sensing Transmitter subfield may be set to 1 to indicate a sensing responder assumes a sensing transmitter role, such as sensing transmitter 504-1. In an example the sensing responder assumes a sensing transmitter role according to the Sensing Transmitter subfield for the Sensing Measurement Setup ID associated with the Sensing Measurement Parameters field. In an example, the Sensing Measurement Parameters field comprises a Sensing Receiver subfield. The Sensing Receiver subfield may be set to 1 to indicate a sensing responder assumes a sensing receiver role, such as sensing receiver 502-1. In an example the sensing responder assumes a sensing receiver role according to the Sensing Receiver subfield for the Sensing Measurement Setup ID associated with the Sensing Measurement Parameters field.

Referring again to FIG. 7C, in examples, a Sensing Measurement Parameters field format includes a Sensing Measurement Report Requested subfield if the Sensing Receiver subfield indicates that the sensing responder should assume a sensing receiver role. In an example, the Sensing Measurement Report Requested subfield may indicate that whether or not a sensing responder sends Sensing Measurement Report frames in sensing measurement instances that result from the sensing measurement setup.

In examples, after the sensing responder receiver the Sensing Measurement Setup Request frame, the sensing responder may transmit a Sensing Measurement Setup Response frame. An example of a Sensing Measurement Setup Response frame Action field is provided in FIG. 7D. In examples, the sensing responder may use a Status Code field in the Sensing Measurement Setup Response frame to indicate whether the sensing responder accepts the requested sensing measurement setup parameters in the received Sensing Measurement Setup Request frame. In an embodiment, the Status Code field may be set to 0 indicating a successful sensing measurement setup, where the sensing responder accepts the operational attributes included in the Sensing Measurement Setup Request frame. In examples, the sensing responder may indicate in the Sensing Measurement Setup Response frame that the operational attributes included in the Sensing Measurement Setup Request frame sent by the sensing initiator are not accepted, for example by setting a Status Code field to a non-zero value. In examples, the sensing responder may indicate in the Sensing Measurement Setup Response frame suggested sensing measurement parameters, for example to indicate to the sensing initiator one or more operational attributes preferred by the sensing responder. In examples, the sensing responder may indicate to the sensing initiator that suggested sensing measurement parameters are included in the Sensing Measurement Setup Response frame by setting a Status Code field to a non-zero value.

In examples, the sensing initiator may assign a role to the sensing responder as part of the sensing measurement setup sent in the Sensing Measurement Setup Request frame. For example, the sensing initiator may indicate to a sensing responder that the sensing responder is to assume the role of a sensing receiver, such as sensing receiver 502-1, or the role of a sensing transmitter, such as sensing transmitter 504-1, or the role of sensing receiver 502-1 and sensing transmitter 504-1. In examples, sensing initiator may indicate to sensing responder whether the sensing responder sends sensing measurement report frames in sensing measurement instances. In an embodiment, the role assigned to the sensing responder and/or whether the sensing responder sends sensing measurement report frames persists until the sensing measurement setup is terminated.

Referring again to FIG. 6 and the sensing session with the STA with MAC ADDR=A identified by the STA AID, AID=1, the sensing measurement setup is followed by one or more sensing measurement instances and measurement reporting instances which may be performed based on the defined operational attribute set. In the example shown in FIG. 6, the one or more sensing measurement instances for the STA with MAC ADDR=A may be assigned sensing measurement instance IDs, for example a first sensing measurement instance may be assigned sensing measurement instance ID=1, and a second measurement instance may be assigned sensing measurement instance ID=2. In examples, a sensing measurement instance may be uniquely associated with a sensing measurement setup.

Referring again to FIG. 6, a second sensing measurement setup may be initiated for the STA with MAC ADDR=A, which may be identified as sensing measurement setup ID=2. As with sensing measurement setup ID=1, sensing measurement setup ID=2 may be associated with a second operational attribute set. In examples, after the second sensing measurement setup, any subsequent one or more sensing measurement instances may be performed based on either the first operational attribute set (sensing measurement setup ID=1) or the second operational attribute set (sensing setup measurement ID=2.)

Referring again to FIG. 6, FIG. 6 illustrates a sensing session setup with a STA with MAC ADDR=B and USID=2. In examples, the sensing session may be identified by the USID of the STA with MAC ADDR=B. FIG. 6 further illustrates a sensing measurement setup for the STA with MAC ADDR=B. In the example, the operational attribute set for the sensing measurement setup for the STA with MAC ADDR=B is the same as the second operational attribute set established with the STA with MAC ADDR=A, and the sensing measurement setup ID is used for both the STA with MAC ADDR=A and the STA with MAC ADDR=B. That is, a sensing measurement setup ID (which may also be referred to as a sensing measurement setup label) may apply to one or more STA. In examples according to FIG. 6, subsequent sensing measurement instances associated with sensing measurement setup ID=2 may be associated with the STA with MAC ADDR=A, the STA with MAC ADDR=B, or with both the STA with MAC ADDR=A and the STA with MAC ADDR=B. An example of one-to-many triggering is shown in FIG. 6 where AID=1 and USID=2 are both associated with a single measurement instance and measurement reporting (measurement instance ID=2 and measurement setup ID=2.)

In examples, an operational attribute set of a sensing session may be terminated by performing a sensing measurement setup termination procedure, for example as is shown in FIG. 6 for sensing measurement setup ID=1 and the STA with MAC ADDR=A. In examples, the sensing measurement setup ID of a terminated sensing measurement setup may be used for a subsequent sensing measurement setup. This is shown in FIG. 6 where a sensing measurement setup with ID=1 is established for the STA with MAC ADDR=B, after the termination of the sensing measurement setup ID=1 with the STA with MAC ADDR=A. In some embodiments, a sensing session may be terminated using a sensing session termination procedure, as shown in FIG. 6.

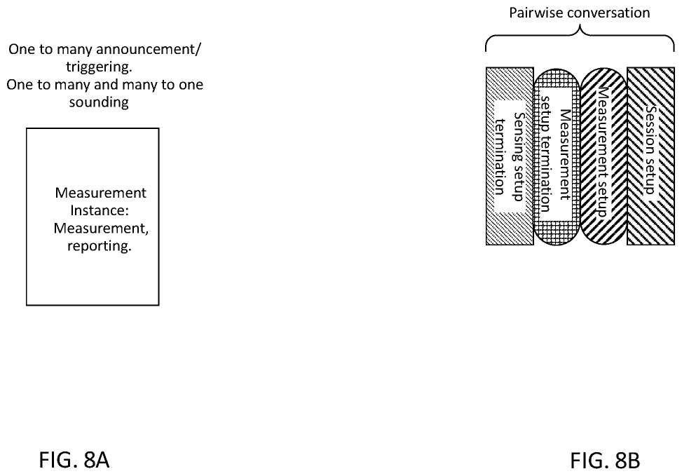

FIG. 8A illustrates exchanges between a sensing initiator and a sensing responder that may be one-to-many or many-to-one. In examples, a measurement instance and/or measurement reporting may have a one-to-one (single device to single device) announcement or triggering or may have a one-to-many (single device to multiple device) announcement or triggering. In examples, a measurement instance may have a one-to-one, one-to-many, or many-to-one (many devices to a single device) sounding.

As previously described, a sensing session is an agreement between a sensing initiator and a sensing responder to participate in a WLAN sensing procedure, that is a sensing session is pairwise and in examples, may be identified by MAC addresses of the sensing initiator and the sensing responder or by the associated AID/USID. FIG. 8B shows an example of pairwise exchanges or procedures that may take place between a sensing initiator and a sensing responder related to a sensing session, which include a sensing session setup, a sensing measurement setup, a sensing measurement setup termination, and a sensing session termination.

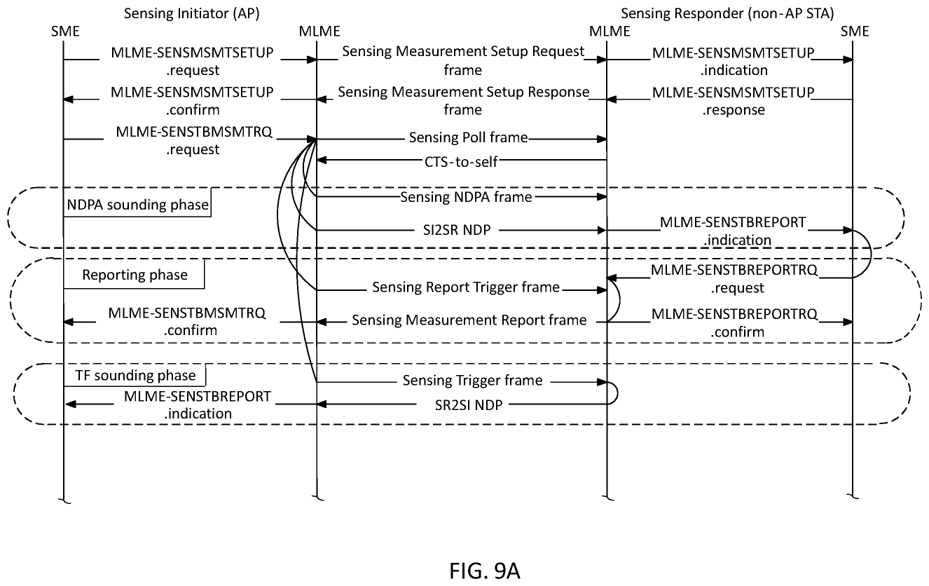

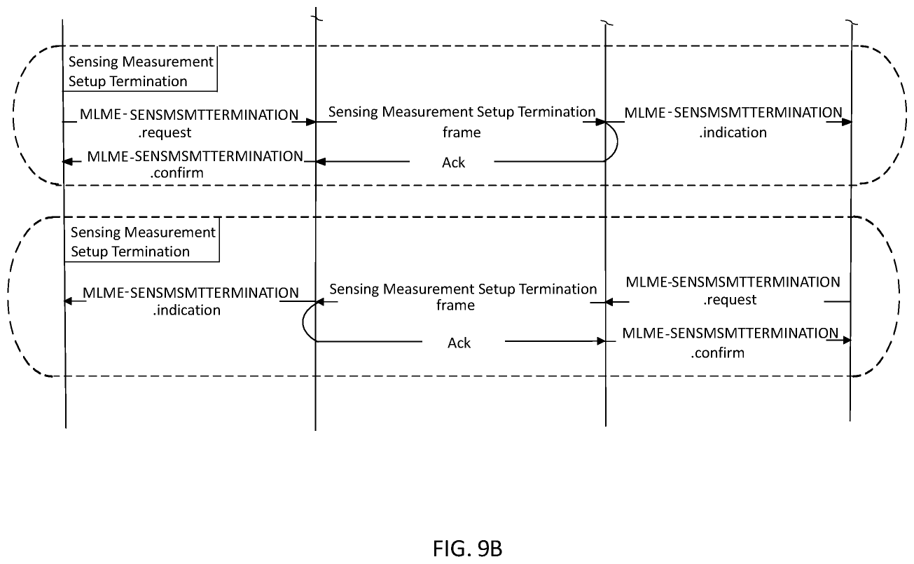

In examples, a sensing measurement instance of a WLAN sensing procedure may be a trigger-based (TB) sensing measurement instance. FIG. 9 depicts a message flow of a sensing session of a WLAN sensing procedure comprising a sensing measurement setup procedure followed by one or more trigger-based (TB) sensing measurement instances that consists of either NDPA sounding or trigger frame (TF) sounding, following by a sensing measurement setup termination procedure, according to some examples. In examples, a TB sensing measurement instance may be used where the sensing initiator is an AP and one or more non-AP STAs are sensing responders. In examples, a TB sensing measurement instance may include a polling phase, an NDPA sounding phase, a trigger frame (TF) sounding phase, and a reporting phase.

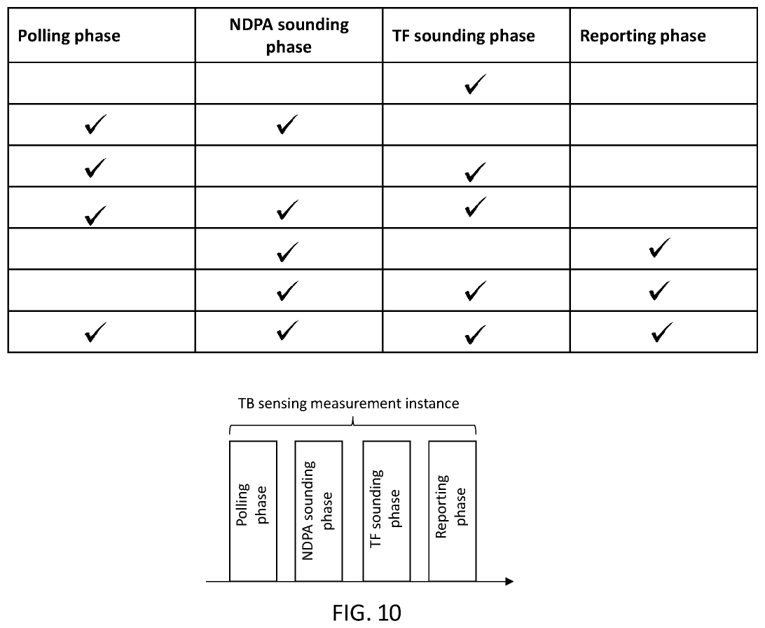

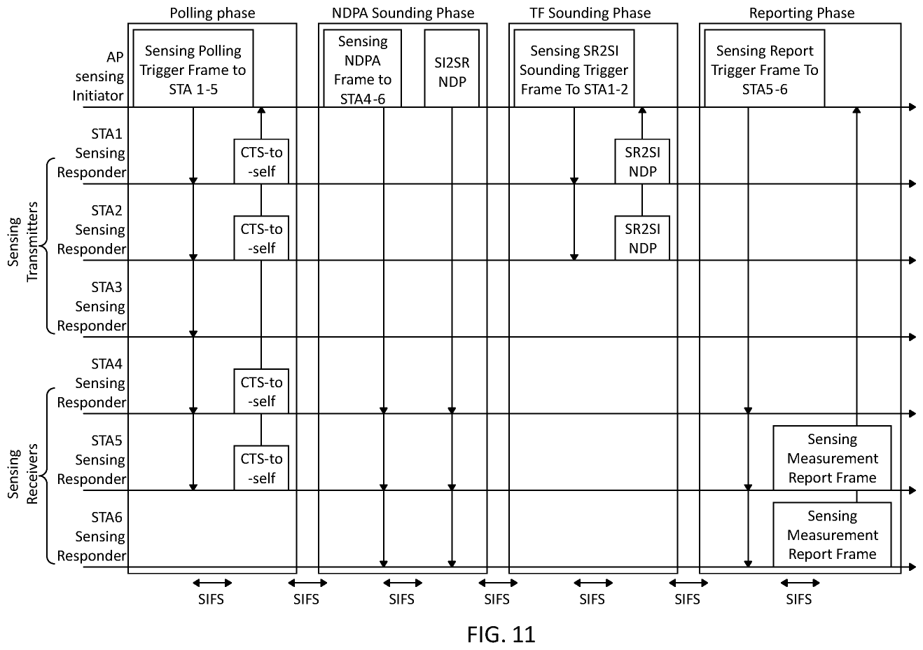

FIG. 10 illustrates a TB sensing measurement instance includes polling phase, NDPA sounding phase, Trigger frame (TF) sounding phase, and reporting phase with relevant combinations of different phases present in a TB sensing measurement instance. The table in FIG. 10 indicates valid combinations of phases of a TB sensing measurement instance. FIG. 10 also shows an example of a TB sensing measurement instance, which consists of a polling phase, an NDPA sounding phase, a TF sounding phase, and a reporting phase. FIG. 11 is one example of a TB sensing measurement instance with a single AP in the role of a sensing initiator and six STAs, referred to as STA 1, STA 2, STA 3, STA 4, STA 5 and STA 6, all of which in the example are sensing responders. In the example, the TB sensing measurement instance comprises a polling phase, an NDPA sounding phase, a TF sounding phase, and a reporting phase. In the example, STA 1, STA 2 and STA 3 are sensing transmitters, such as sensing transmitter 504-1, sensing transmitter 504-2 and sensing transmitter 504-3. In the example of FIG. 11, STA 4, STA 5, and STA 6 are sensing receivers, such as sensing receiver 502-1, sensing receiver 502-2, and sensing receiver 502-3. In examples, in the polling phase, the AP as the sensing initiator transmits a Sensing Polling Trigger frame to STA 1, STA 2, STA 3, STA 4, and STA 5. In an embodiment, sensing transmitter STA 1 (504-1) and sensing transmitter STA 2 (504-2) respond to the Sensing Polling Trigger frame with an indication that the STA is available to participate in a sensing measurement instance. In examples, the indication is a CTS-to-self frame. In the example, sensing transmitter STA 3 (504-3) does not respond to the Sensing Polling Trigger frame sent by the AP as the sensing initiator, indicating that STA 3 (504-3) will not participate in the sensing measurement instance. In an embodiment, sensing receiver STA 4 (502-1) and sensing receiver STA 5 (502-2) respond to the Sensing Polling Trigger frame with an indication that the STA is available to participate in a sensing measurement instance. In examples, the indication is a CTS-to-self frame. In the example, sensing receiver STA 6 (502-3) does not respond to the Sensing Polling Trigger frame sent by the AP as the sensing initiator, indicating that STA 6 (502-3) will not participate in the sensing measurement instance.

Referring again to FIG. 11, in a NDPA sounding phase, the AP acting as sensing initiator assumes the role of sensing transmitter (504-4). In examples, the AP as sensing transmitter 504-3 transmits a sensing transmission. In examples, the sensing transmission may be a broadcast transmission. In examples, the sensing transmission may be a unicast transmission to one or more STAs, for example to sensing receiver STA 4 (502-1), sensing receiver STA 5 (502-2) and/or to sensing receiver STA 6 (502-3). In examples, a period of one or more SIFS elapses between the AP as sensing transmitter 504-3 sending the sensing NDPA frame and when the AP as sensing transmitter 504-3 sends the one or more sensing transmissions. In examples, one or more of the sensing transmissions may be a full bandwidth NDP frame. In examples, one or more of the sensing transmissions may be a partial bandwidth NDP frame. In examples, one or more of the NDP frames may be an SI2SR NDP frame.

The sensing measurement instance of FIG. 11 includes a TF Sounding phase. In examples, in the TF Sounding phase, the AP as the sensing initiator sends a Sensing Sounding Trigger frame to sensing transmitter STA 1 (504-1) and to sensing transmitter STA 2 (504-2). In examples, responsive to receiving the Sensing Sounding Trigger frame, sensing transmitter STA 1 (504-1) and sensing transmitter STA 2 (504-2) send sensing transmissions to the AP. In examples, the sensing transmissions may comprise NDP transmissions. In an example, one or more of the NDP transmissions to the AP may be SR2SI NDP transmissions (as shown in the example of FIG. 11). In examples, a period of one or more SIFS elapses between sensing transmitter STA 1 (504-1) receiving the Sensing Sounding Trigger frame and transmitting a sensing transmission, and in examples a period of one or more SIFS elapses between sensing transmitter STA 2 (504-2) receiving the Sensing Sounding Trigger frame and transmitting a sensing transmission. In examples, the AP may assume the role of sensing receiver 502-4, and the AP may make sensing measurements on the sensing transmissions from sensing transmitter STA 1 (504-1) and sensing transmitter STA 2 (504-2).

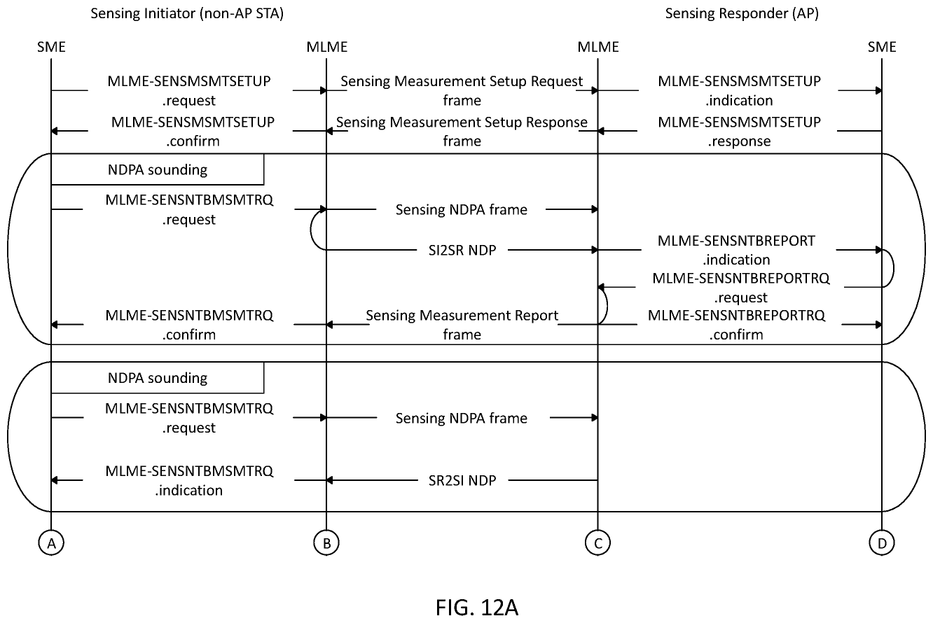

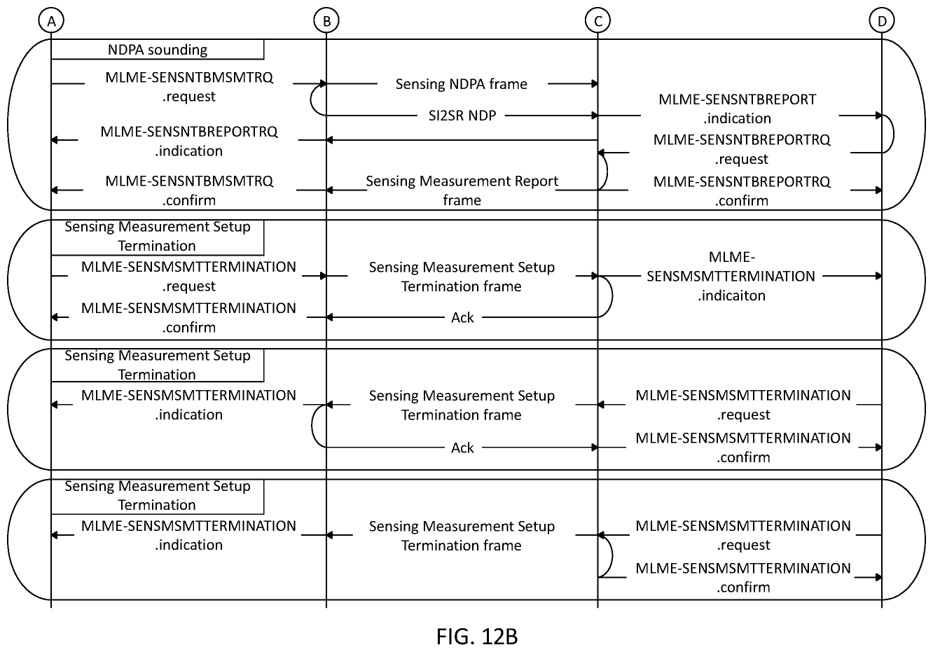

In examples, a sensing measurement instance of a WLAN sensing procedure may be a non-trigger-based (non-TB) sensing measurement instance. FIG. 12 depicts a message flow of a sensing measurement setup procedure followed by one or more non-TB sensing measurement instances of a WLAN sensing procedure that consist of one or more of downlink sounding or uplink sounding, according to some embodiments, followed by a sensing measurement setup termination procedure, according to some examples. In examples, a non-TB sensing measurement instance may be used where the sensing initiator is a non-AP STA and an AP is the sensing responder. In examples of uplink sounding as shown in FIG. 12, the sensing initiator (non-AP STA) acting as a sensing transmitter (for example, sensing transmitter 504-1) transmits a sensing announcement frame followed by a sensing transmission. In examples, the sensing announcement frame may be an NDPA frame. In examples, the sensing transmission may be an NDP frame. In examples, responsive to receiving the sensing transmission, the AP acting as a sensing receiver (for example, sensing receiver 502-1), may transmit to the sensing initiator (non-AP STA in the role of sensing transmitter 504-1) a sensing measurement report, for example one or more Sensing Measurement Report frames. In examples of downlink sounding as shown in FIG. 12, the sensing initiator (non-AP STA) acting as a sensing receiver (for example, sensing receiver 502-1) transmits a sensing announcement frame. In examples, the sensing announcement frame may be an NDPA frame. In examples, responsive to receiving the sensing announcement frame, the AP acting as sensing transmitter (for example, sensing transmitter 504-1) may transmit one or more sensing transmissions. In examples, one or more of the sensing transmissions may be an NDP frame. In examples, the non-AP STA acting as a sensing receiver (502-1), responsive to receiving a sensing transmission, may make a sensing measurement on the sensing transmission. In examples, the sensing measurement setup may be terminated by the sensing initiator or the sensing responder transmitting a SENS Measurement Setup Termination frame. In examples, the sensing responder or sensing initiator (respectively) may respond with an acknowledgment.

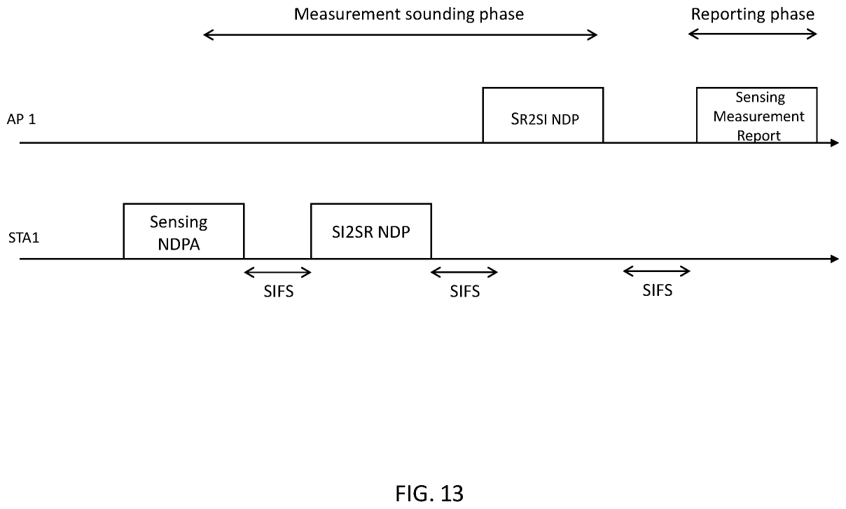

FIG. 13 is reproduced from IEEE P802.11bf and illustrates a detailed example of a non-TB sensing measurement instance, according to some embodiments. In examples, STA 1 acting as sensing initiator and sensing transmitter, such as sensing transmitter 504-1, transmits a sensing announcement frame. In examples, the sensing announcement frame may be a sensing NDPA frame. In examples, one or more SIFS may elapse followed by STA 1 acting as sensing initiator and sensing transmitter (such as sensing transmitter 504-1) transmitting one or more sensing transmissions. In examples, one or more of the sensing transmissions may be an NDP frame. In an example. STA 1 acting as sensing initiator and sensing receiver, such as sensing receiver 502-1, transmits a sensing announcement frame. In examples, the sensing announcement frame may be a sensing NDPA frame. In examples, one or more SIFS may elapse followed by AP 1 acting as sensing responder and sensing transmitter (such as sensing transmitter 504-1) transmitting one or more sensing transmissions. In examples, one or more of the sensing transmissions may be an NDP frame.

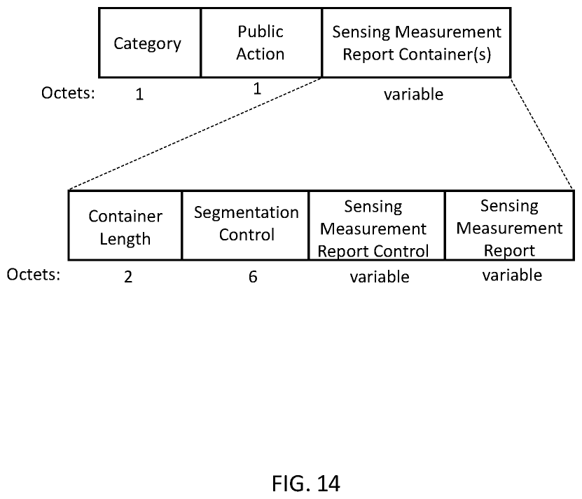

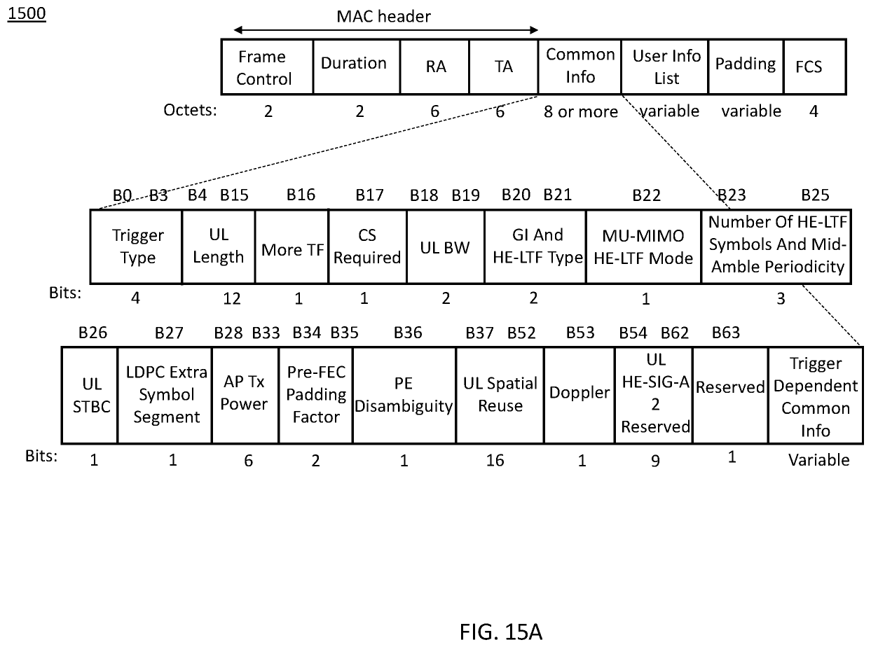

FIG. 14 is reproduced from IEEE P802.11bf and illustrates an example of a Sensing Measurement Report frame Action field. In some examples, a Sensing Measurement Report frame may be transmitted to provide WLAN sensing measurements, for example to a sensing agent or a sensing algorithm of a sensing initiator. In examples, a Sensing Measurement Report frame may comprise one or more Sensing Measurement Report Containers. A Sensing Measurement Report Container may comprise a single sensing measurement report, in some embodiments.

Referring again to FIG. 14, in embodiments a Sensing Measurement Report Container may include a Sensing Measurement Report Control field. In examples, the Sensing Measurement Report Control field may contain information necessary to interpret the Sensing Measurement Report field. For example, the Sensing Measurement Report Control field format may comprise one or more subfields. In an embodiment, one or more subfields of the Sensing Measurement Report Control field may include PHY layer parameters used by the sensing receiver when performing the sensing measurement, for example receiver antenna beamforming or spatial layer information.

In a sensing session, exchanges of transmissions between one or more of plurality of sensing receivers 502-(1-M) and one or more of plurality of sensing transmitters 504-(1-N) may occur. In an example, control of these transmissions may be with the MAC layer of the IEEE 802.11 stack. According to an implementation, one or more of plurality of sensing receivers 502-(1-M) may secure a TXOP which may be allocated to one or more sensing transmissions by one or more of plurality of sensing transmitters 504-(1-N). According to an implementation, one or more of plurality of sensing receivers 502-(1-M) may allocate channel resources (or RUs) within a TXOP to the one or more of plurality of sensing transmitters 504-(1-N). In an example, one or more of plurality of sensing receivers 502-(1-M) may allocate the channel resources to the one or more of plurality of sensing transmitters 504-(1-N) by allocating time and bandwidth within the TXOP to the one or more of plurality of sensing transmitters 504-(1-N).

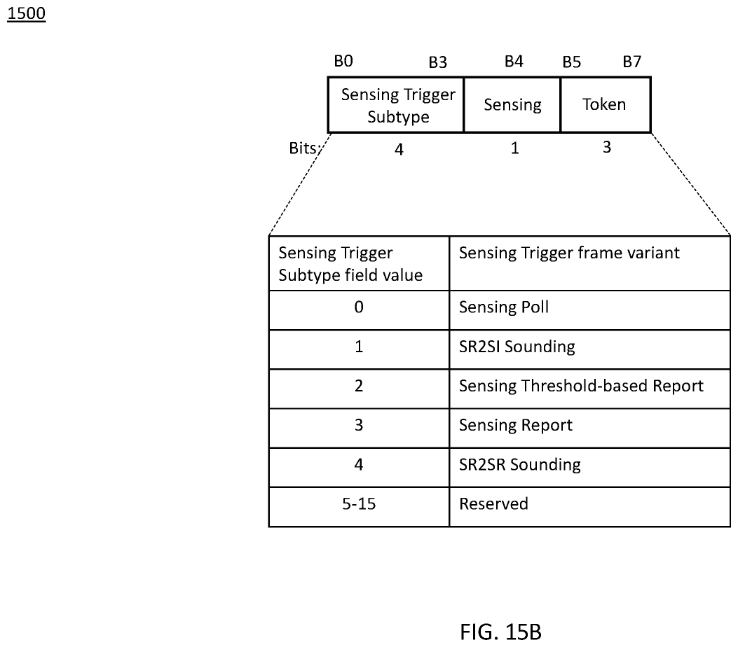

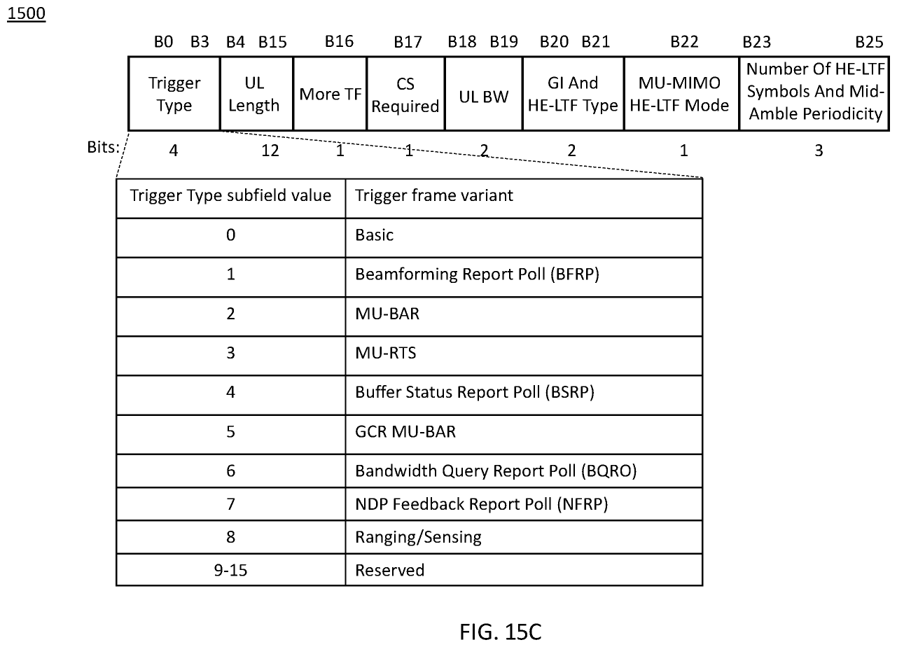

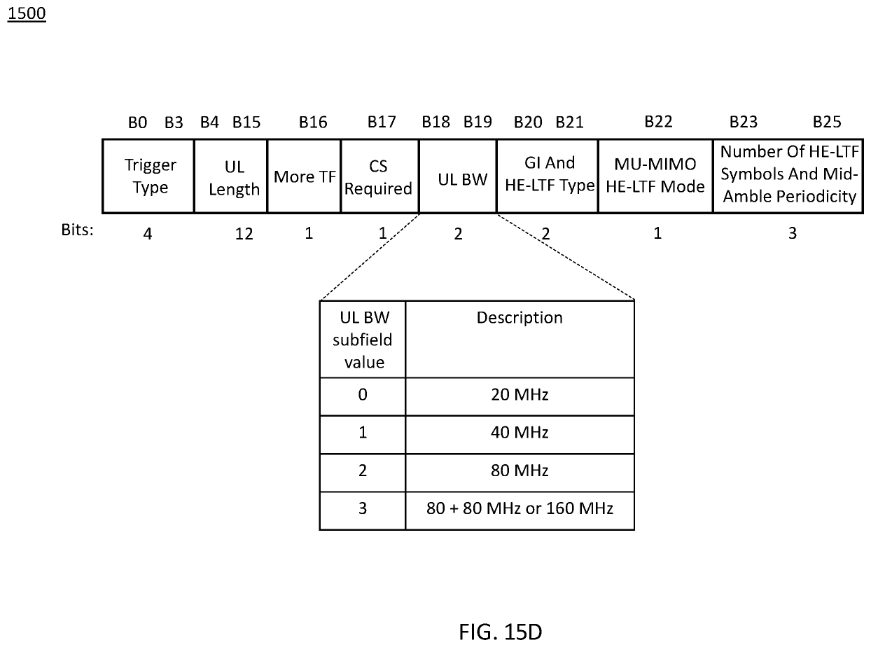

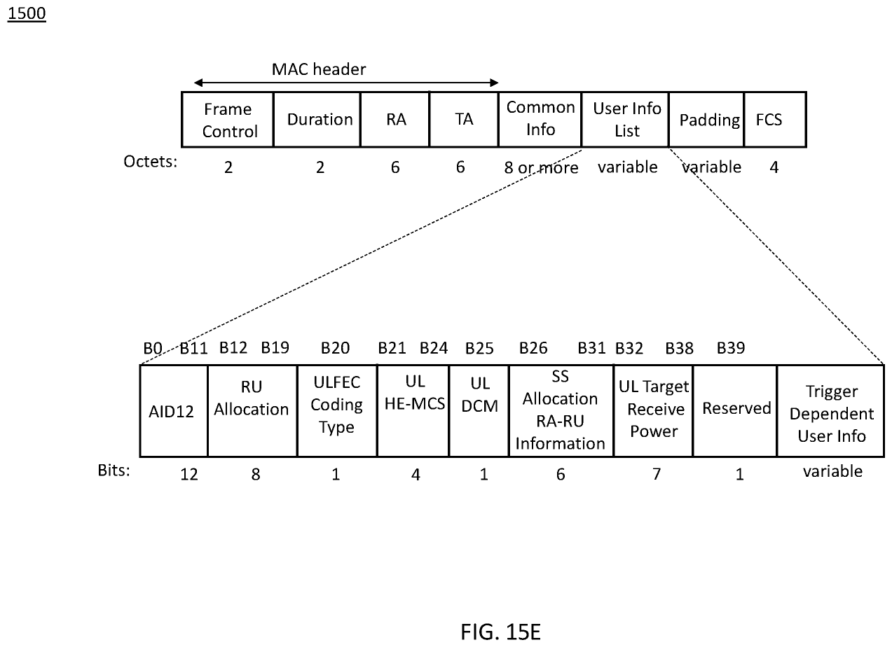

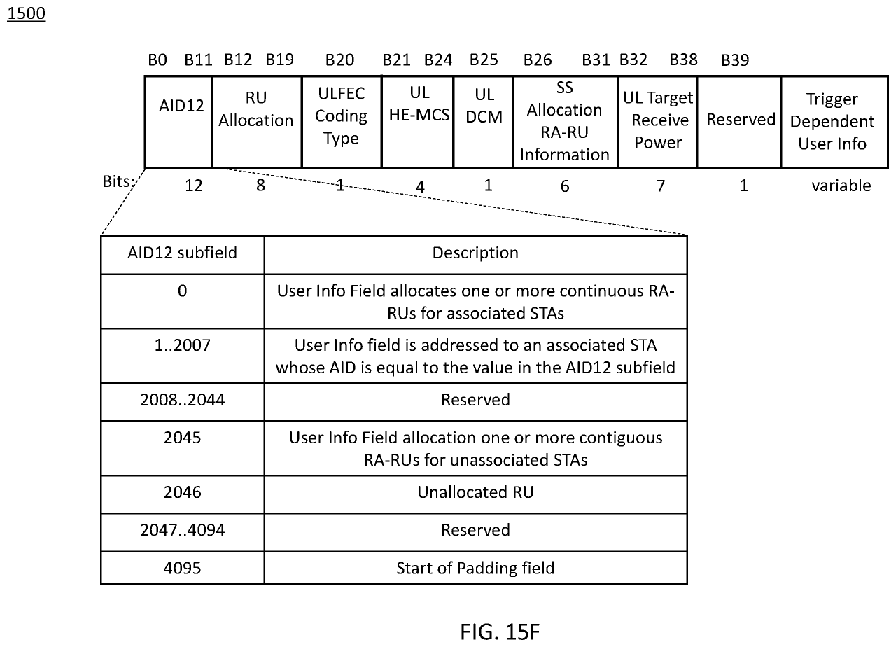

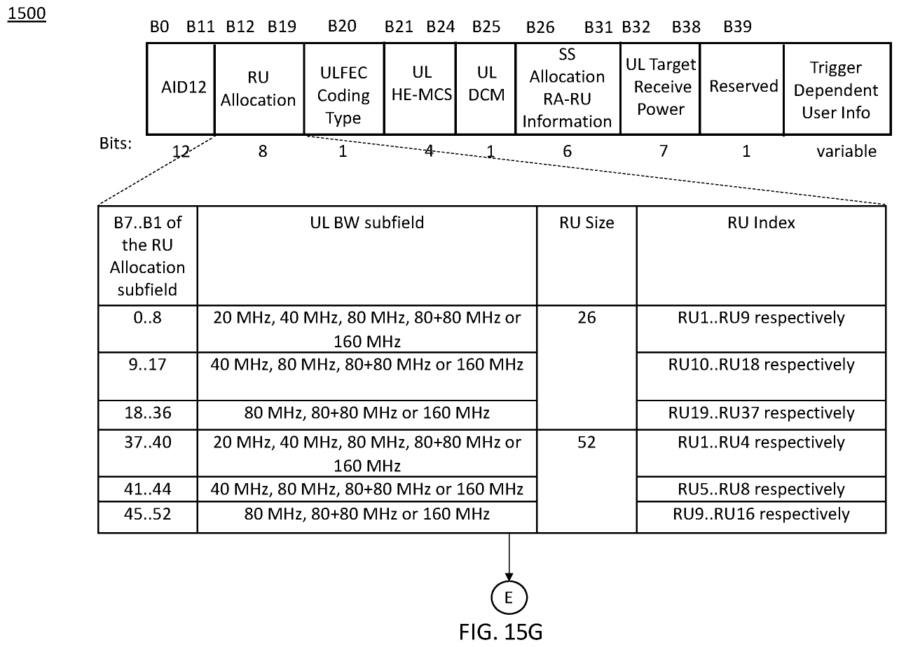

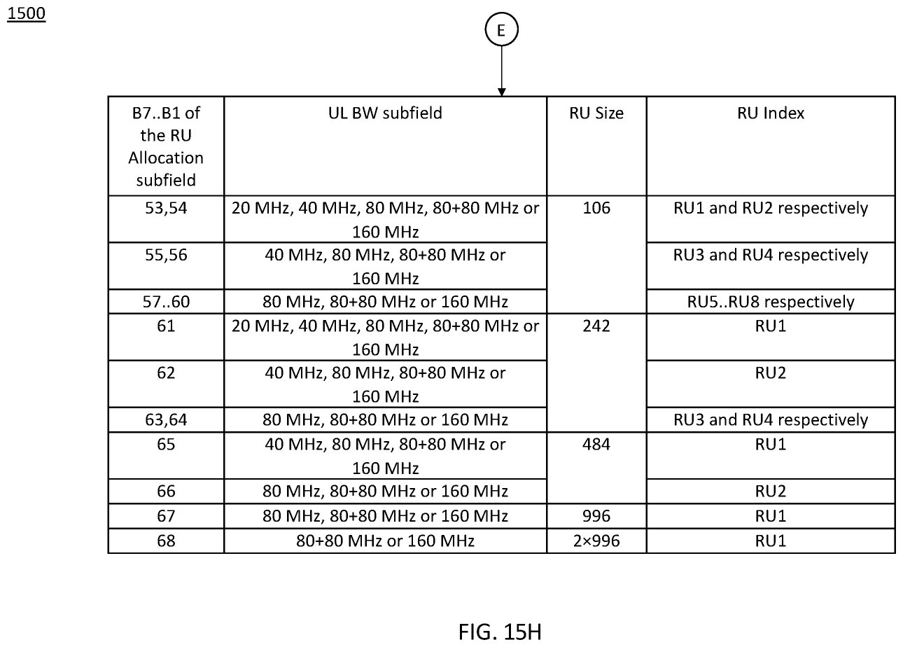

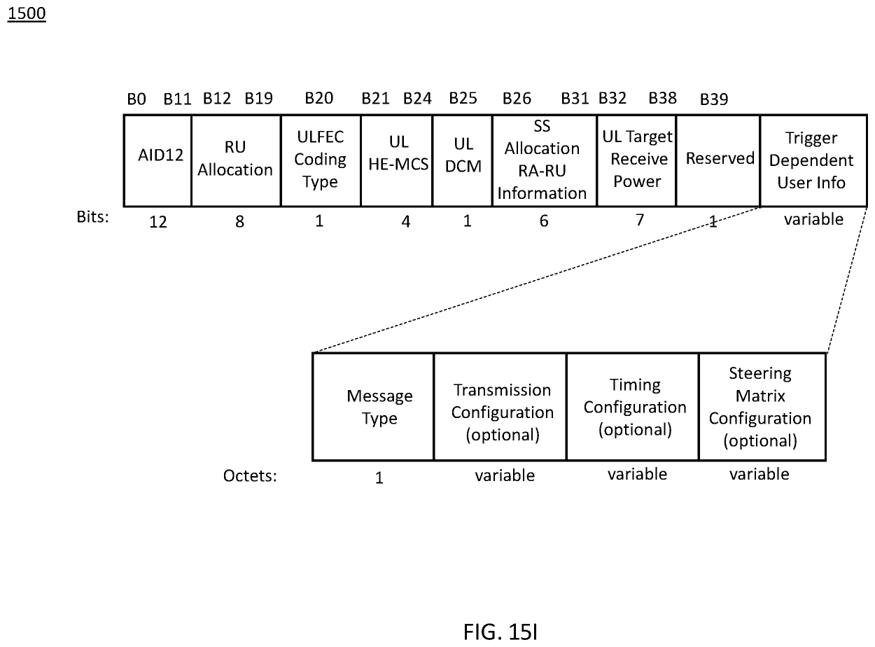

According to an implementation, example 1500 of a hierarchy of fields within sensing trigger message is shown in FIG. 15A to FIG. 15I.

As described in FIG. 15A and based upon a Trigger frame as described by IEEE P802.11, the Common Info field may contain information which is common to one or more of plurality of sensing transmitters 504-(1-N). According to some implementations, the requirement of an NDPA preceding an NDP may be optional. This may be indicated to one or more of plurality of sensing transmitters 504-(1-N) and may for example be encoded into a “Trigger Dependent Common Info” field if the requirement is common to plurality of sensing transmitters 504-(1-N), or into a “Trigger Dependent User Info” field if the requirement is specific to one or more of plurality of sensing transmitters 504-(1-N). According to an example, the requirement for a sensing announcement (for example, and NDPA) preceding a sensing response NDP may be encoded by a single bit where 0 (bit clear) indicates that a sensing announcement is optional and 1 (bit set) indicates that a sensing announcement is required.

As described in FIG. 15B which is a reproduction of IEEE P802.11bf, a Trigger Dependent Common Info subfield may include the Sensing Trigger Subtype field with different values to indicate different Sensing Trigger frame variants. The Sensing Trigger frame variants may be used for Sensing Poll, SR2SI Sounding, Sensing Threshold-based Report, Sensing Report, or SR2SR Sounding.

As adapted from IEEE P802.11 and IEEE P802.11bf and described in FIG. 15C, a Trigger Type (within B0 . . . 3 of “Common Info” field) may be defined which represents a sensing trigger message. In examples, a sensing Trigger message may have a Trigger Type subfield value of any Reserved value from 9-15, for example a Sensing Trigger message may have a Trigger Type subfield value of 9. In an example of triggering a sensing transmission from a sensing transmitter 504-1, a Trigger Dependent User Info field may include sensing trigger message data. In an implementation, a time-synchronized sensing transmission may be required from plurality of sensing transmitters 504-(1-N) responding to a sensing trigger message. In an example, the requirement for one or more time-synchronized sensing transmissions may be encoded into a Trigger Dependent Common Info field. According to an example, the requirement for one or more time-synchronized sensing transmissions may be encoded by a single bit where 0 (bit clear) represents a request for a normal or non-time-synchronized response and 1 (bit set) represents a request for a time-synchronized response. In some examples, a method of time-synchronization may be requested in the sensing trigger. In examples, the method of time-synchronization to be requested may be encoded into a Trigger Dependent Common Info field. In examples the encoding may use two bits as shown in the following table.

| Encoding | Method | Description |
|---|---|---|
| 00 | A | Sensing announcement followed by sensing NDP. |
| 01 | B | Padding followed by a sensing response message. |
| 10 | C | Sensing NDP without an initial sensing |
| | | announcement. |
| 11 | N/A | For future use or extensions. |

As described by IEEE P802.11 and reproduced in FIG. 15D the sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 15E and based upon a Trigger frame as described by IEEE P802.11, the User Info List contains information which is specific to each of the plurality of sensing transmitters 504-(1-N). In examples, the User Info List may include the AID of a sensing transmitter, an RU allocation for a sensing transmitter, and other Trigger Dependent User Info.

As described in FIG. 15F and leveraging the definition of IEEE P802.11, the AID12 subfield of the User Info List illustrated in FIG. 15D may be used to address a specific sensing transmitter of the plurality of sensing transmitters 504-(1-N).

As described in FIG. 15G and FIG. 15H and leveraging the definition of IEEE P802.11, the RU Allocation subfield is used to allocate resource units (RU) to each of the plurality of sensing transmitters 504-(1-N).

As described in FIG. 15I, the Trigger Dependent User Info subfield may be used to request the transmission configuration and/or steering matrix configuration for one or more of the plurality of sensing transmitters 504-(1-N) that the sensing trigger message is triggering.

### C. Determination of Channel Sensing Quality Using Channel Sensing Metric

The following describes systems and methods for determination of channel sensing quality using channel sensing matrix (CSM).

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

A typical bistatic Wi-Fi sensing system includes a sensing transmitter (which may be an access point (AP) or a non-AP station (STA)) and a sensing receiver (which is an AP if the sensing transmitter is a STA, and a STA if the sensing transmitter is an AP). A sensing NDP transmission is sent from the sensing transmitter to the sensing receiver. A sensing measurement is made using the sensing NDP transmission at the sensing receiver. In directional multi-gigabit (DMG) sensing at GHz frequency, in addition to bistatic DMG sensing, monostatic DMG sensing may be utilized, where the sensing transmitter and the sensing receiver are the same STA. In monostatic DMG sensing, a sensing responder transmits a sensing transmission which reflects of a target and is received at the same sensing responder. Also, in monostatic DMG sensing, any IEEE 802.11 compatible PPDU suitable for sensing may be transmitted by a monostatic DMG STA. Since the sensing transmitter and the sensing receiver are the same STA, any other STA that receives the signal transmitted by the monostatic DMG STA will discard the signal at the MAC layer because the frame is not addressed to it.

An IEEE 802.11 physical channel constitutes a number of orthogonal frequency division multiplexing (OFDM) tones or subcarriers depending on the overall bandwidth of the channel and the revision of the specification. A baseband Wi-Fi receiver calculates a channel state measurement (CSI) consisting of a real and imaginary part for High Efficiency Long Training Field (HE-LTF) for a received HE Ranging NDP/HE TB Ranging NDP or each Extremely High-Throughput Long Training Field (EHT-LTF) for each EHT sounding NDP. In examples, the CSI is passed via a Wi-Fi sensing agent to a sensing algorithm to determine if there is motion or movement in the sensing space. In examples, the number of CSI calculated (equivalent to the number of FFT points) for a 20 MHz 2× HE-LTF sensing configuration is 122 points, and for an 80 MHz 2× HE-LTF sensing configuration is 498 points. Where the sensing algorithm is in the sensing receiver, all the CSI points may be passed from the PHY to the SME for use in the detection of motion. In examples, the size of a sensing measurement report increases with the number of transmitting antennas, the number of receiving antennas, the bandwidth, the subcarrier grouping size Ng (increasing with smaller sizes), and with the number of quantization bits for each real and imaginary component of CSI. In examples, greater number of quantization bits increases the size of the sensing measurement report. The number of subcarriers in a given channel bandwidth depends on the subcarrier grouping (which may take values of 4, 8, or optionally 16). For example, in a 20 MHz bandwidth and with Ng=4, CSI for 64 subcarriers is included in the sensing measurement report. In another example, for a 20 MHz bandwidth with Ng=16, CSI for 20 subcarriers is included in the sensing measurement report. In examples, a motion in the sensing space may be determined by the sensing algorithm by looking for perturbation in the local environment, e.g., on the transmission path between one or more transmitter devices and one or more receiver devices.

A sensing measurement may be a measurement of amplitude and phase (which may be derived from in-phase (I) and quadrature (Q) components of a signal) at each of a number of subcarriers within a transmission channel, which may be the whole channel bandwidth or within a partial bandwidth (also referred to as a resource allocation (RU)). This sensing measurement is a CSI, and the CSI is a form of channel representation information (CRI). The CSI may be further processed by a sensing algorithm or by pre-processing before the sensing algorithm, for example to reduce the content of the sensing measurement, usually to reduce the size of the sensing measurement and to reduce the overhead of transferring and processing the sensing measurement. A CSI may be transformed into the time domain to provide options for methods of processing to reduce the content of the sensing measurement. This sensing measurement may be referred to as a time domain channel representation information (TD-CRI). A sensing measurement may be made by processing a sensing NDP transmission which may be transmitted from a sensing transmitter to a sensing receiver through a sensing space. The sensing space is a free space containing objects in motion which are to be sensed, and the sensing transmitter and the sensing receiver may be Wi-Fi devices which implement both analog and digital processing of the sensing NDP transmission. A time domain representation may also be formulated by measuring a transmitted pulse with a given pulse shape, where the same pulse shape is used for the entire sensing packet, such that all the pulses within one sensing packet are modulated with a constant amplitude. An example of such a PHY is described in 802.15.4ab UWB Sensing Technical Framework Proposal. According to UWB Sensing Technical Framework Proposal, the same pulse shape may be used for the entire sensing packet and all the pulses within one sensing packet may be modulated with a constant amplitude.

In examples, the transmitted pulse shape p(t) may be constrained by its cross-correlation function with a standard reference pulse shape r(t). The normalized cross-correlation function between two waveforms may be defined using Equation (9) provided below.

$$ϕ ( τ ) = \frac{1}{\sqrt{{E}_{r} {E}_{p}}} Re {\int }_{- ∞}^{∞} r ( t ) {p}^{*} ( t + τ ) dt \qquad ( 9 )$$

where Eᵣ and Eₚ represent the energies of r(t) and p(t), respectively, p* represents the complex conjugate of p, and Re{.} represents that the real part is used.

The reference pulse r(t) is a time-bounded Kaiser pulse with a parameter of β which may be mathematically expressed using Equation (10) provided below.

$$r ( t ) = \{ \begin{matrix}\frac{1}{L} \frac{{I}_{0} [ β \sqrt{1 - {( \frac{2 t}{L} )}^{2}} ]}{{I}_{0} [ β ]} , & \vert t \vert \leq L / 2 \\ 0 , & \vert t \vert > L / 2\end{matrix} \qquad ( 10 )$$

where I₀ represents the zeroth-order modified Bessel function of the first kind and L represents the duration of the pulse which is set to 3 chips.

In examples, the transmitted pulse p(t) may have a magnitude of the cross-correlation function |φ(τ)| whose main lobe is greater than or equal to a first specified value for a duration of at least T_{w}, as defined in IEEE 802.15.4-2020 table 15-12, and any sidelobe may be no greater than a second specified value. For the purposes of testing a pulse for compliance, the following are defined:

Let φ(τ) be the magnitude of the cross-correlation of p(t) and r(t), and Ti, for i=1, 2, . . . , be a set of critical points as defined in Equation (10) provided below:

$$\frac{d}{d τ} {\vert ϕ ( τ ) \vert}_{τ = {τ}_{i}} = 0 \qquad ( 11 )$$

The maximum of the function occurs at one of these critical points τₘₐₓ, where |φ(τₘₐₓ)|≥|φ(τ)| for all values of τ. The requirements thus states that for some continuous set of values that contain the point τₘₐₓ, the function |φ(τ)| is no greater than the first specified value. In addition, the second constraint on the value of sidelobes may be stated mathematically as |φ(τᵢ)|≤the second specified value for all τᵢ.

In examples, the transmitted pulse should exhibit both minimum precursor energy and minimum postcursor energy to support interoperability in sensing scenarios. The transmitted pulse shape p(t) may be constrained by a symmetric time domain mask.

In examples, a sensing transmission may be more sensitive to channel noise than data transmissions because sensing transmissions do not use channel coding to improve the signal reception accuracy in the presence of channel noise. For data communications, there are different channel coding techniques used which can overcome interference, fading and noise and which improve SNR by error detection and error correction while adding some redundant information in transmission. Although these channel coding techniques require more processing but allows operation in a lower SNR channel. In sensing transmissions, channel coding may be used. Therefore, the sensing ability of the channel may be much more impaired in the presence of the noise in comparison to the data transmission ability of the channel. In examples, if the Wi-Fi sensing system is sensing and communicating on the same channel, then it may be more beneficial for the Wi-Fi sensing system to select a channel that is more “sensing friendly” than “data communication friendly”. As a result, both sensing and data transmission are error free or have minimum error. A channel sensing metric may be required that facilitates selection of sensing channels for optimum sensing transmissions.

The present disclosure describes a system and a method for determination of channel sensing quality using channel sensing metric (CSM). For Wi-Fi sensing, a CSM may be a metric that may be used to determine if a certain channel (represented in either time domain or frequency domain) is suitable for sensing or not.

In the time domain, a transmission channel may be referred to as h(t). The transmission channel may also be described as an impulse response of the transmission channel. The impulse response of the transmission channel may include a plurality of time domain pulses. The plurality of time domain pulses may represent reflections that transmitted signals (for example, those transmitted by a transmitter) underwent before reaching a receiver. A reflected time domain pulse may be mathematically represented using Equation (12) provided below.

h(tₖ)=αₖδ(t−tₖ) (12)

where, tₖ represents the time that it took the reflected time domain pulse to reach the receiver following its unique reflective path and αₖ represents the attenuation experienced by the reflected time domain pulse between the transmitter and receiver.

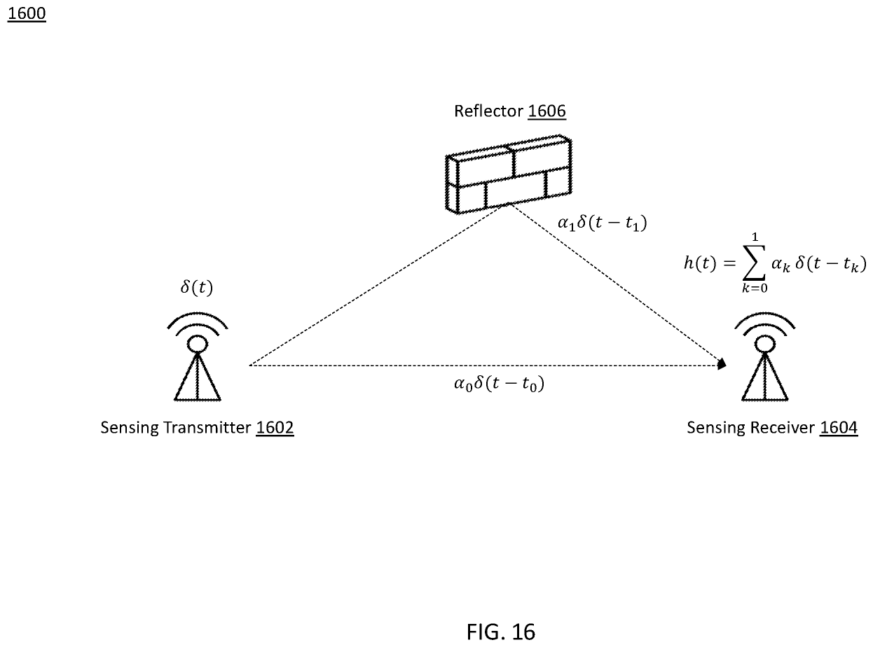

FIG. 16 depicts example representation 1600 of two discrete multipaths, according to some embodiments. In an implementation, FIG. 16 depicts discrete multipaths of a time domain pulse, δ(t), between sensing transmitter 1602 and sensing receiver 1604 according to some embodiments. Reflector 1606 is also shown in FIG. 16.

In an implementation, if a number of discrete multipaths is given by LP, then the received time domain signal may be mathematically represented using Equation (13) provided below.

$$h ( t ) = {\sum }_{k = 0}^{{L}_{p}} {α}_{k} δ ( t - {t}_{k} ) \qquad ( 13 )$$

The time domain signal can be converted to a frequency domain signal using a discrete Fourier transform (DFT), and the frequency domain representation of the signal (which is the frequency response of the channel or the CSI) is given by Equation (14).

$$H ( f ) = {\sum }_{k = 0}^{{L}_{p}} {α}_{k} {e}^{- j 2 {π ft}_{k}} \qquad ( 14 )$$

Each value of H(f) in Equation (14) is a linear combination of all values of h(t) in Equation (13).

According to an implementation, determination of channel sensing quality using the CSM may be carried out by an access point operating as a sensing initiator. The access point may be a networking device. In examples, the access point may be sensing receiver 502-1. In some examples, the access point may be sensing transmitter 504-1. Examples by which channel sensing quality is determined based on CSM are described in detail below.

In an implementation, a basic service set (BSS) including an access point and a plurality of stations having a plurality of sensing links therebetween may be established. In examples, the BSS may be established according to an operating channel and bandwidth (CHB) based on data transmission metrics. A CHB is a combination of a channel and bandwidth selection for assessment of CSM or for operation.

According to an implementation, establishing agent 523-1 (where the access point assumes the role of sensing receiver 502-1) or establishing agent 545-1 (where the access point assumes the role of sensing transmitter 504-1) may establish the BSS according to the CHB based on the data transmission metrics. In an implementation, establishing agent 523-1 or establishing agent 545-1 may establish a sensing measurement setup with a station of the plurality of stations in the BSS. In examples, the sensing measurement setup may correspond to a transmission configuration comprising CHB and transmission parameters. A transmission configuration is defined as a combination of a channel, a channel bandwidth, and a set of transmission parameters. In examples, for a set of sensing measurements to be useful in detecting motion, all the sensing measurements must be made using the same transmission configuration.

In an implementation, determination agent 524-1 (where the access point assumes the role of sensing receiver 502-1) or determination agent 546-1 (where the access point assumes the role of sensing transmitter 504-1) may obtain a CSM. In examples, the CSM may correspond to a sensing link of the plurality of sensing links between the access point (i.e., the networking device) and the station and to the transmission configuration. According to an implementation, determination agent 524-1 or determination agent 546-1 may determine the CSM based on a comparison between a channel state information (CSI) for the sensing link and a reconstructed CSI (interchangeably referred to as R-CSI) for the sensing link. In examples, the CSI may include a plurality of time domain pulses and the reconstructed CSI may include a selected number of time domain pulses from the plurality of time domain pulses. In an implementation, selection agent 525-1 (where the access point assumes the role of sensing receiver 502-1) or selection agent 547-1 (where the access point assumes the role of sensing transmitter 504-1) may select the transmission configuration as an operating transmission configuration according to the CSM. Further, selection agent 525-1 or selection agent 547-1 may communicate the operating transmission configuration to the station.

In examples, a CSM may be a metric that may be used to determine if a transmission configuration is suitable for sensing or not. The CSM may be determined using CSI and/or channel impulse response (CIR) calculated on sensing transmissions, which is available at the access point. In examples, a CSM for a transmission configuration may be determined using a number of selected time domain pulses for a channel (for example, “n”) as described in Equation (15) provided below. For ease of representation, the transmission configuration is abbreviated to TC in Equation (15).

$$Channel Sensing Metric ( CSM ) = 20 {log}_{10} ( \frac{‖ {H}_{n}^{′} ( TC ) ‖}{‖ H ( TC ) ‖ - ‖ {H}_{n}^{′} ( TC ) ‖} ) \qquad ( 15 )$$

In Equation (15), the numerator is the 2-norm of the reconstructed frequency domain channel representation across the channel (referred to as the reconstructed CSI or

$${H}_{n}^{′} ( TC ) )$$

that is obtained from the selected n time domain pulses.

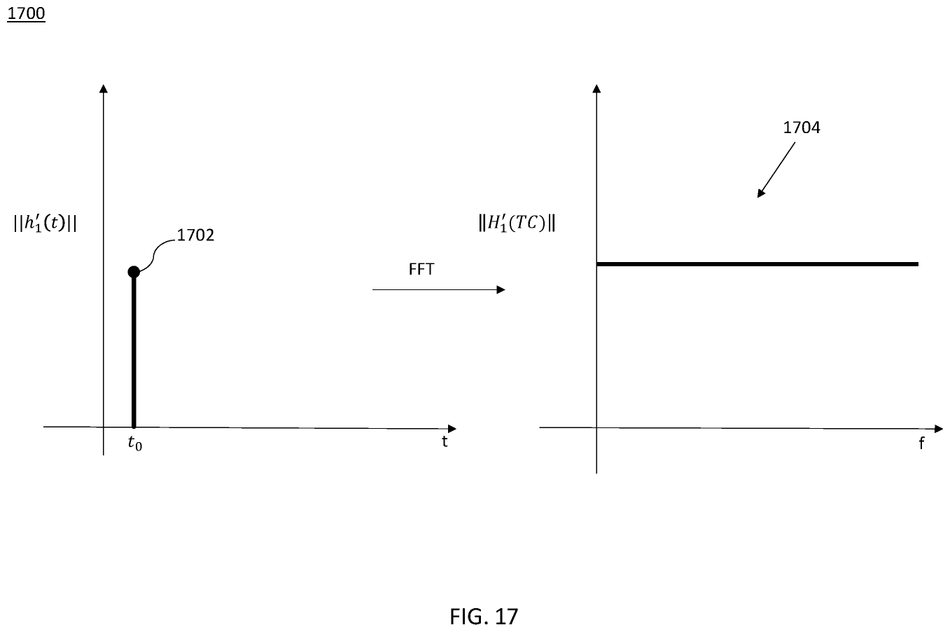

FIG. 17 depicts example 1700 of a frequency domain channel representation of a reconstructed CSI including a single time domain pulse, according to some embodiments.

In the example shown in FIG. 17, the numerator in Equation (15) is the 2-norm value of

$$‖ {H}_{1}^{′} ( TC ) ‖$$

in the frequency domain when n=1 (i.e., one time domain pulse) is selected. In the example, starting with a first time domain pulse at a reference point t₀ of the time representation of the channel transfer function (represented by reference numeral “1702”), and using a Fast Fourier Transform (FFT), a first estimate of the frequency domain channel transfer function defined as

$$‖ {H}_{1}^{′} ( TC ) ‖$$

may be obtained (represented by reference numeral “1704”).

In examples, the original CSI of the received sensing transmission may be used to determine the 2-norm of the frequency domain channel transfer function of the channel including the sensing transmission and the noise. This is represented as ∥H(TC)∥ in Equation (15). The CSM for the transmission configuration may then be determined according to Equation (15).

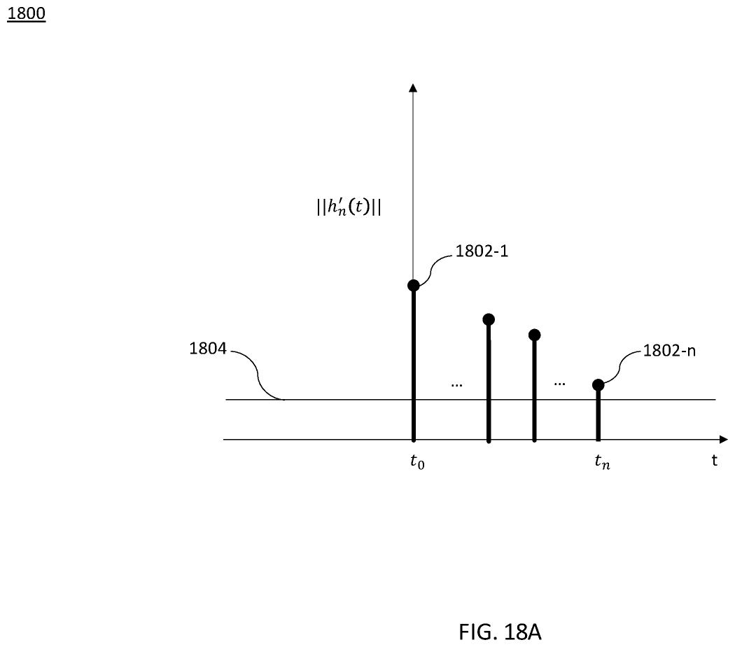

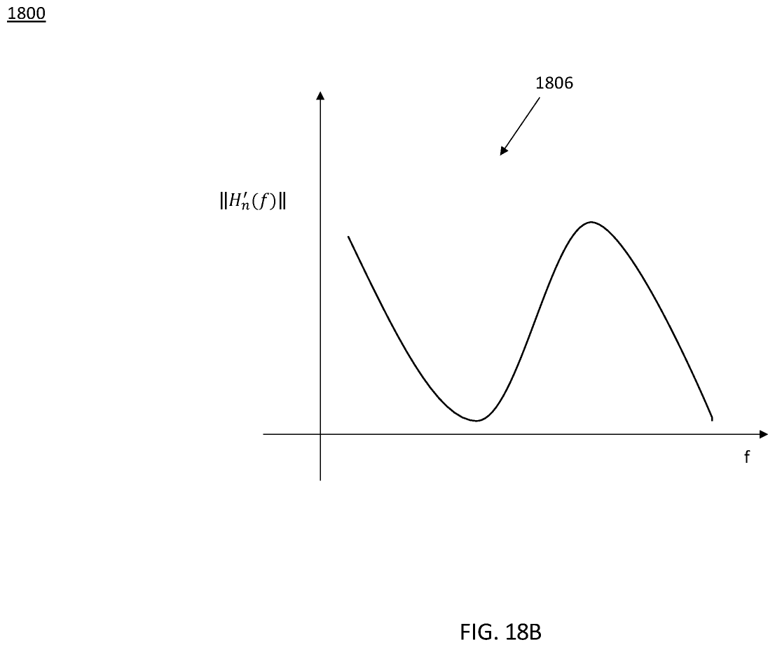

FIG. 18A and FIG. 18B depict example 1800 of reconstruction of the reconstructed CSI including a number of time domain pulses, according to some embodiments. In particular, an example of using “n” time domain pulses (represented by reference numerals “1802-1 to 1802-n”) to reconstruct the reconstructed CSI and determine

$$‖ {H}_{n}^{′} ( TC ) ‖$$

in the frequency domain (represented by reference numeral “1806”) is described in FIG. 18A and FIG. 18B. A noise threshold is also depicted in FIG. 18A, which is represented by reference numeral “1804”. A noise threshold may be defined as the minimum amplitude of a time domain pulse that represents energy from the reflected sensing transmission.

As described previously, the original CSI of the received sensing transmission may be used to determine the 2-norm of frequency domain channel transfer function of the channel including the sensing transmission and the noise. This is represented as ∥H(TC)∥ in Equation (15). The CSM for the transmission configuration may be determined according to Equation (15). In examples, a CSM for a channel may be associated with a transmission configuration for a sensing transmission in the channel. For each different transmission configuration, a different CSM may be determined.

In examples, a CSM may be determined for a wider channel bandwidth and the CSM may be applicable for any transmission configuration that may be contained within the wider channel bandwidth. For example, a CSM may be determined for a transmission configuration including 40 MHz channel bandwidth. In some examples, a CSM may be determined for two transmission configurations including 20 MHz channels contained within the 40 MHz channel bandwidth. In examples, the number of time domain pulses used in determining the CSM needs to be fixed across all transmission configurations for which the CSM for the transmission configuration may be used to assess the optimum (or suitable) transmission configuration(s). For example, where the CSM for more than one transmission configurations is compared, the number of time domain pulses used in determining the CSM for each of the transmission configuration that is compared should be the same.

Examples by which the number of time domain pulses that are used in determining a CSM for a transmission configuration is selected are described in detail below.

In examples, in time domain, the signal energy is contained in a relatively small number of time domain pulses. To reduce the complexity of the CSM determination, it is preferrable to use the smallest number of time domain pulses as possible. However, the accuracy of the CSM determination is reduced if too few time domain pulses are used. Therefore, it is required to determine (or select) an optimum number of time domain pulses for determination of a CSM for a transmission configuration. According to an implementation, the number of time domain pulses that may be used to determine the CSM may be selected according to at least one of a noise threshold method, a filter mask method, and a knee point method.

The selection of the optimum number of time domain pulses that may be used to determine the CSM for the transmission configuration using the noise threshold method is described below.

In examples, the energy of a sensing transmission reflected from different objects in the environment may have a large impact on the channel where every reflection contributes to the CSM directly. The energy of the channel impulse response is made up of the time domain pulses that represent all the reflections that the transmitted sensing transmission underwent before reaching the receiver. While the channel impulse response is represented in a subset of the time domain pulses, the energy contributed by noise affects the entire channel and may be distributed over all the subcarriers and spread uniformly in the frequency domain and in the time domain.

H(f) is the channel transfer function of the CSI in the frequency domain. In examples, the CSI in the frequency domain may be converted to the time domain using an Inverse Fast Fourier Transform (IFFT) and is referred to as time domain channel representation information (TD-CRI). TD-CRI may be represented as a channel transfer function channel h(t) in the time domain. If CSI or H(f) (including the noise energy) is transformed into the time domain, the energy of the reflected sensing transmissions may be compacted into a number of time domain pulses. The pulses in the time domain that contain energy also represent the time delay spread of the channel and the multi-path reflection structure of the channel.

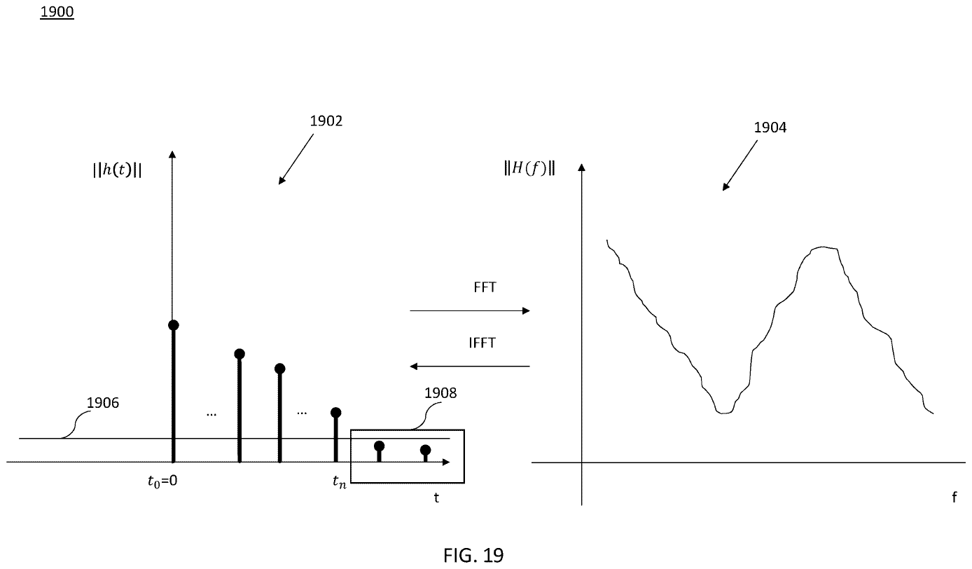

FIG. 19 depicts example 1900 of a sensing channel transfer function of a sensing transmission (with noise energy) both in frequency domain and time domain, according to some embodiments.

In FIG. 19, plot 1902 represents the sensing channel transfer function h(t) in the time domain where for simplicity, only the 2-norm of the channel transfer function is shown. Further, plot 1904 represents the sensing channel transfer function H(f) in the frequency domain where for simplicity, only the 2-norm of the channel transfer function is shown. An IFFT is used to transform the channel transfer function in the frequency domain H(f) to the time domain and an FFT is used to transform the channel transfer function in the time domain h(f) to the frequency domain. FIG. 19 also shows a noise threshold (represented by reference number “1906” in FIG. 19) and a noise tail of the channel transfer function in the time domain (represented by reference number “1908” in FIG. 19). The noise tail of the channel transfer function in the time domain may be defined as the time domain pulses with amplitudes lower than the noise threshold. As shown in FIG. 19, two time domain pulses have amplitudes lower than the noise threshold, and are thus considered as noise. Accordingly, these two time domain pulses may not be selected for use in determination of the CSM for the transmission configuration. In an example, the noise threshold may be a percentage of the maximum amplitude of the time domain pulses of the channel transfer function in the time domain. In some examples, the noise threshold may be a fixed minimum amplitude of the time domain pulses of the channel transfer function in the time domain. In examples, the noise threshold may have the same unit as the amplitude. The noise threshold may be used to select the number of time domain pulses that may be used in the determination of a CSM for a transmission configuration. According to an implementation, the time domain pulses that have amplitudes greater than the noise threshold are selected for use in determination of the CSM for the transmission configuration.

The selection of the optimum number of time domain pulses that may be used to determine the CSM for the transmission configuration using the filter mask method is described below. A filter mask may include one or more of the noise threshold, a time delay offset, and a time window.

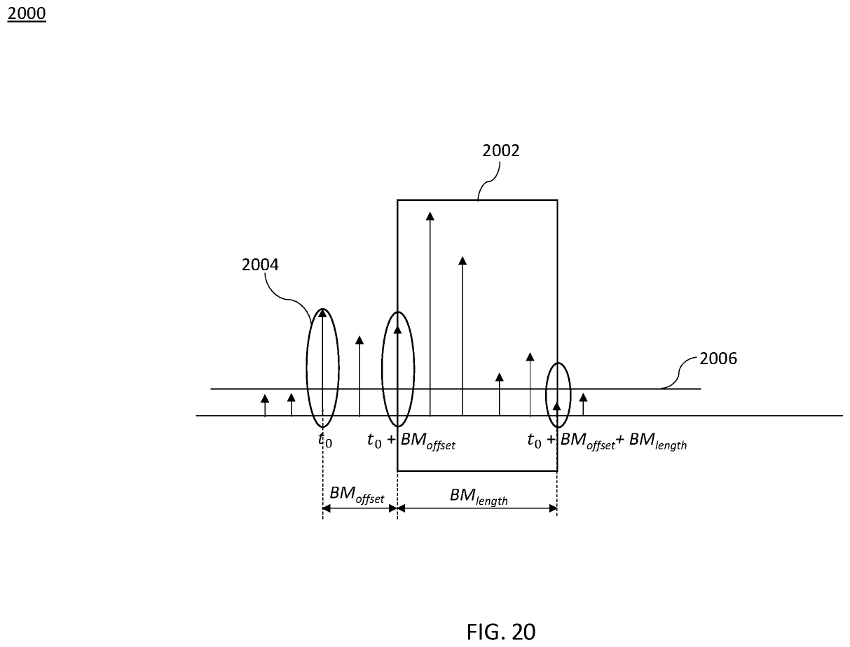

FIG. 20 depicts example 2000 of filter mask 2002, according to some embodiments. FIG. 20 is a reproduction of FIG. 2 from IEEE P802.15-22-0538-03-004ab—Sensing window parameters defined relative to the reference tap.

In the example shown in FIG. 20, a bitmap offset (BM_{offset}) specifies the offset (in count of time domain pulses) of a first time domain pulse (shown as to, and denoted by reference numeral “2004”). BM_{offset} may be defined as the time when a first time domain pulse of a sensing transmission may be detected at a sensing receiver. BM_{offset} may also be defined as the time offset from the start of the time domain frame at the sensing receiver. BM_{length} may be defined the length (in count of time domain pulses) of the time window. In examples, the time window may start at a first bitmap offset (t₀+BM_{offset}) and end at a second bitmap offset (t₀+BM_{offset}+BM_{length}). In examples, a noise tail may be the time domain pulses having amplitudes lower than a noise threshold (represented by reference numeral “2006” in FIG. 20). In some examples, the noise tail may be the time domain pulses that are outside filter mask 2002 and these represent the noise of the channel and may be called noise pulses. The time domain pulses that are within filter mask 2002 may be selected for determination of the CSM for the transmission configuration.

The selection of the optimum number of time domain pulses for use in determination of the CSM for the transmission configuration using the knee point method is described below.

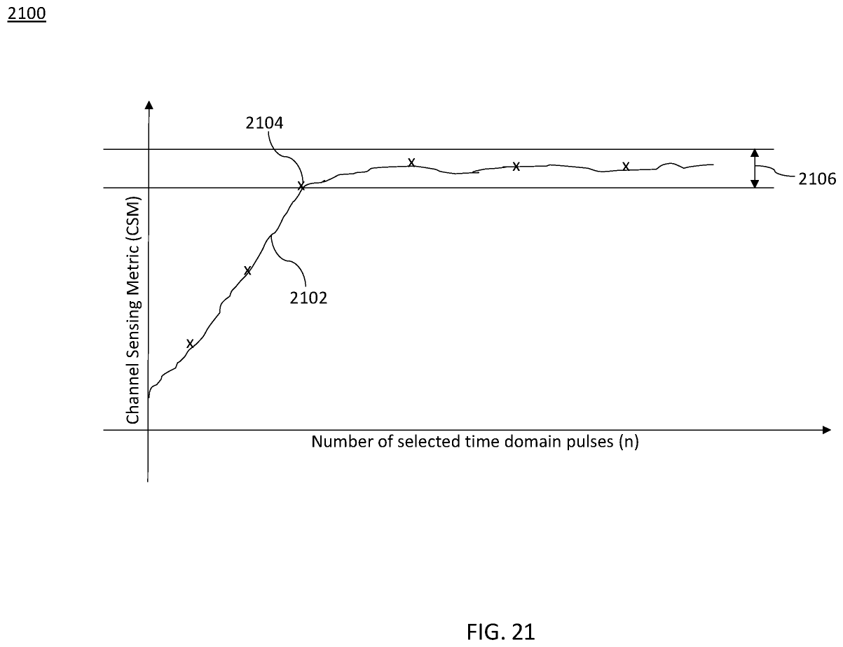

FIG. 21 depicts example 2100 of CSM curve 2102 for a transmission configuration created based on a number of selected time domain pulses, according to some embodiments.

A CSM curve for a transmission configuration may be defined as a representation of the CSM as a function of the number of time domain pulses used to determine the CSM. In FIG. 21, an example of CSM curve 2102 showing the value of CSM as a function of the selected number of time domain pulses (denoted by “n”) for a transmission configuration is shown. A knee point of the CSM curve is represented by reference numeral “2104” in FIG. 21. The knee point of the CSM curve may be defined as the number of selected time domain pulses which is optimal for the accurate determination of the CSM for the transmission configuration. In examples, adding more time domain pulses to the CSM determination may only add a minimal gain to the value of the CSM for the for the transmission configuration. In examples, the knee point is defined as a number of time domain pulses that may be used in the determination of the CSM such that the addition of one or more additional time domain pulses in the determination of the CSM changes the value of the CSM by an amount less than a delta CSM threshold (represented by reference numeral “2106” in FIG. 21).

In examples, there are different techniques which may be used to determine a knee point of a CSM curve. The selected time domain pulses may be used to determine the reconstructed CSI in the frequency domain while the non-selected time domain pulses may be removed and may not be included or used for the reconstruction of the CSI in the frequency domain. The knee point of the CSM curve may be determined by computing the CSM with an increasing number of selected time domain pulses (n) until the delta between CSM (n) and CSM (n+1) is less than the delta CSM threshold. Another technique for determining the knee point is by plotting first order derivative and second order derivative of the CSM curve with each additional selected time domain pulse. In examples, the CSM curve is the CSM as a function of the number of selected time domain pulses (n) and the knee point is determined to be where the transition from high slope to low slope happens. Based on the knee point of the CSM curve, the optimum number of time domain pulses that may be used determining the CSM for the transmission configuration may be determined.

Although it has been described that establishing agent 523-1 or establishing agent 545-1 may establish a sensing measurement setup with one station of the plurality of stations in the BSS, in some embodiments, establishing agent 523-1 or establishing agent 545-1 may establish a plurality of sensing measurement setups with the plurality of stations in the BSS. In examples, establishing agent 523-1 or establishing agent 545-1 may establish the plurality of sensing measurement setups according to a plurality of transmission configurations. Further, determination agent 524-1 or determination agent 546-1 may obtain a CSM matrix. The CSM matrix may include a plurality of CSMs, each corresponding to one sensing link of the plurality of sensing links, and to one transmission configuration of the plurality of transmission configurations. According to some embodiments, establishing agent 523-1 or establishing agent 545-1 may determine a plurality of CSM matrices. Each CSM matrix may correspond to one sensing link of the plurality of sensing links and include a plurality of CSM scores according to a plurality of different transmission configurations for the one sensing link.

According to an implementation, selection agent 525-1 or selection agent 547-1 may select the CHB as an operating CHB. In examples, selection agent 525-1 or selection agent 547-1 may select the CHB as the operating CHB according to the CSM matrix. According to some implementations, selection agent 525-1 or selection agent 547-1 may identify transmission configurations as candidate transmission configurations based on having corresponding CSMs that surpass a quality threshold for each station of the plurality of stations. In an implementation, selection agent 525-1 or selection agent 547-1 may select, as the operating transmission configuration, the transmission configuration qualifying as a candidate transmission configuration for each station of the plurality of stations. According to some implementations, selection agent 525-1 or selection agent 547-1 may perform the selection of the transmission configuration according to at least one of availability of channel resources, received signal strength indication information, and data channel metrics.

According to an implementation, selection agent 525-1 or selection agent 547-1 may identify transmission configurations as candidate transmission configurations based on having corresponding CSMs that surpass a quality threshold for each station of the plurality of stations. In some implementations, selection agent 525-1 or selection agent 547-1 may identify, as potential operating transmission configurations, transmission configurations having a shared CHB and qualifying as candidate transmissions configuration for each station of the plurality of stations. In an implementation, selection agent 525-1 or selection agent 547-1 may establish the shared CHB as an operating CHB.

Examples by which the potential operating transmission configurations are identified are described in detail below.

In a BSS, all stations associated with an access point may be on the same channel as the access point. To determine one or more potential transmission configurations for operation, the access point may first determine the CSM for each sensing link with a station for available transmission configuration options. This may take place in an initial scanning phase. In the initial scanning phase, all sensing link assessments are done between the access point and any station in an associated state. During actual operation, a station may operate as an associated station or a non-associated station for sensing. However, the CSM for the sensing link is applicable in either case, such that it is sufficient to do the scanning operation in an associated state.

Alternatively, or in addition, the CSM of a candidate transmission configuration may be assessed when the CHB is selected for operation. For example, the access point may decide to move to a new channel for reasons, for example, based on congestion metrics. Once on the new channel, the access point may associate with the stations and then the proceed with CSM determinations. Once the CSMs are determined, the access point may determine if the CSMs for all or most of the stations satisfy a threshold condition. If the CSMs satisfy the threshold condition, the access point may choose to stay on the selected channel. Otherwise, the access point may select its next best candidate channel (for example, using the usual interference criterion). In either case, the assessment of the CSM for the sensing links is performed as described below.

As described earlier, each transmission configuration includes CHB and transmission parameters. The more potential combinations of transmission parameters that are considered, the longer the initial scanning phase will take, as the CSM for each sensing link needs to be measured with each transmission configuration.

In examples, considering a situation where only 20 MHz channel bandwidths are being taken into consideration, and there are 4 possible 20 MHz CHB that may be utilized, three different transmission parameter configurations may be possible. In the example, the transmission parameters included in a transmission parameter configuration are the number of space-time-streams (NSTS) and the HE-LTF configuration. Each transmission parameter configuration may include more or fewer transmission parameters. In the example, for each associated or non-associated station for which the access point seeks to assess the CSM, 12 different transmission configurations may be required (which includes four CHB multiplied by three transmission parameter configurations), as is illustrated in Table 1 provided below. In the example, if the number of stations in close enough proximity to the access point to conduct a sensing measurement instance is 3, then sensing links with 3 stations are evaluated resulting in a total of 36 transmission configurations.

In general, the number of trials (denoted as “P”) is a function of a number of stations and a number of transmission configurations (which is the product of the number of CHBs and the number of transmission parameter configurations). The number of trials may be mathematically expressed using Equation (16) provided below.

P=f(NSTA,NCHB,NTPC)=NSTA×NCH×NTPC=NSTA×TC (16)

where P represents the number of trials, NSTA represents the number of stations, NCHB represents the number of CHBs, NTPC represents the number of transmission parameter configurations, NCH represents the number of channels, and TC represents the transmission configuration.

In examples, the steps for conducting trials in the initial scanning phase are outlined below.

| | |
|---|---|
| Step 1 | The access point may tune to the first CHB for the first |
| | set of trials. |
| Step 2 | The access point may associate with all stations within the |
| | coverage of the access point that it could potentially form |
| | a sensing link with on the selected CHB. |
| Step 3 | The access point may establish a sensing measurement setup |
| | with each station for each transmission parameter |
| | configuration. There are a number of transmission parameter |
| | configurations (NTPC) which may be assigned measurement |
| | setup ID values from 0-7. The measurement setup ID field |
| | indicates a measurement setup ID that identifies assigned |
| | transmission parameter configuration parameters in the |
| | sensing measurement parameters element to be used in the |
| | corresponding sensing measurement instances. A measurement |
| | setup ID on an NCH is a TC. |
| | In examples, if NTPC > 8, then the access point may establish |
| | sensing measurement setups for transmission parameter |
| | configurations 0-7 and perform step 4 to step 6 (described |
| | below). This is referred to as first grouping of sensing |
| | measurement setups. Thereafter, the access point may |
| | terminate all sensing measurement setups, and establish the |
| | next set of up to 8 transmission parameter configurations |
| | as sensing measurement setups. For example, transmission |
| | parameter configuration “9” may be assigned measurement |
| | setup ID “0” in the second grouping of sensing |
| | measurement setups. |
| Step 4 | For a sensing measurement setup that has been established, |
| | the access point may perform sensing measurement instances |
| | with each of the stations. In examples, the access point |
| | may use a trigger based (TB) sensing measurement instance |
| | with a trigger frame (TF) sounding phase. |
| Step 5 | The access point may perform sufficient sensing measurement |
| | instances with each station to determine the CSM for that |
| | station. Once the CSM for each station is determined, the |
| | value of the CSM may be stored along with the transmission |
| | configuration and the AID of the station so that analysis |
| | can be later performed. The transmission configuration may |
| | be used during the analysis to identify the transmission |
| | parameter configuration and CHB that the sensing |
| | measurement instances were performed on for the station |
| | associated with the AID for that transmission configuration. |
| | In examples, a different identifier may be used for the |
| | station in place of the AID (which may change on subsequent |
| | associations). For example, the MAC address of the station |
| | may be used to uniquely identify the station. |
| Step 6 | The access point may repeat step 4 and step 5 for each |
| | measurement setup ID (covering all the transmission |
| | configuration which include that CHB). If more than one |
| | grouping of sensing measurement setups are needed (for |
| | example, in the case where NTPC > 8) then after completing |
| | the first group of measurement setup IDs, the access point |
| | may return to step 3. |
| Step 7 | Once all the trials on the selected CHB are performed, the |
| | access point may move back to step 1 and transfer all the |
| | stations to the next CHB for evaluation. |

TABLE 1
Example of CSM matrix for one station (AID = 1) and
12 different transmission configurations (i.e., 12 trials)

| | | Transmission | |
|---|---|---|---|
| Transmission | Channel and | Parameter | |
| Configuration | Bandwidth | Configuration | Channel Sensing |
| (TC) | (CHB) | (TPC) | Metric (CSM) |
| 1 | CHB1 | TPC A | CSM-TC1-AID-1 |
| 2 | CHB1 | TPC B | CSM-TC2-AID-1 |
| 3 | CHB1 | TPC C | CSM-TC3-AID-1 |
| 4 | CHB2 | TPC A | CSM-TC4-AID-1 |
| . . . | . . . | . . . | . . . |
| 11 | CHB3 | TPC B | CSM-TC11-AID-1 |
| 12 | CHB3 | TPC C | CSM-TC12-AID-2 |

Examples by which a CSM determination trial is implemented in a TB sensing measurement instance are described in detail below.

According to an implementation, in a TB sensing measurement instance with TF sounding, the access point may be a sensing initiator and sensing receiver (for example, sensing receiver 502-1) and the station may be the sensing responder and the sensing transmitter (for example, sensing transmitter 504-1). In an implementation, the access point may select the sensing measurement setup, that will be used for the sensing measurement instance, as the sensing measurement setup that corresponds to the transmission configuration for which the access point needs to determine the CSM. According to an implementation, determination agent 524-1 may transmit a sensing trigger frame to the station to trigger a sensing transmission according to the sensing measurement setup. In examples, the sensing trigger frame may be configured to identify the sensing measurement setup according to the transmission configuration. Thereafter, determination agent 524-1 or determination agent 546-1 may receive one or more sensing transmissions transmitted by the station according to the sensing trigger frame. According to an implementation, determination agent 524-1 may perform one or more sensing measurements on the one or more sensing transmissions and determine the CSM according to the one or more sensing measurements. In examples, determination agent 524-1 may calculate CSI on the one or more sensing transmissions. In an example, determination agent 524-1 may transform the CSI to time domain pulses. Further, determination agent 524-1 may select the optimum number of time domain pulses and determine the CSM. Alternatively, the CIR may be passed to determination agent 524-1 for selection of the optimum number of time domain pulses and determination of the CSM. In examples, multiple sensing transmissions may be triggered through multiple sensing measurement instances for the sensing measurement setup in order to obtain sufficient data to determine the CSM.

According to an implementation, in a TB sensing measurement instance with NDPA sounding, the access point may be a sensing initiator and sensing transmitter (for example, sensing transmitter 504-1) and the station may be the sensing responder and the sensing receiver (for example, sensing receiver 504-1). In an implementation, the access point may determine the transmission configuration that may be used. Further, the access point may establish the sensing measurement setup for the CHB of the transmission configuration with the station. According to some implementations, determination agent 546-1 may transmit one or more sensing NDPA frames to the station to indicate that one or more sensing transmissions will follow. In an implementation, determination agent 546-1 may transmit one or more sensing transmissions configured according to the transmission configuration to the station and corresponding to the one or more sensing NDPA frames. Determination agent 546-1 may then receive a sensing measurement report from the station. In examples, the sensing measurement report may include a CSI for the sensing link and a reconstructed CSI for the sensing link. In some examples, the sensing measurement report may include a CIR. In an implementation, determination agent 546-1 may determine the CSM according to the sensing measurement report.

In examples, a sensing NDPA frame may include a value for “n” which is the number of time domain pulses to retain in the filtered TD-CRI or CIR. The sensing NDPA frame may optionally include an indication of how to select the n time domain pulses (for example, indicate filter mask (or filter window) parameters or a noise threshold). In an example, the station may calculate the CSI or CIR of the sensing transmission. In an example, the CSI or CIR may be transferred via the sensing measurement report which may be passed via MLME primitives to the station. The station may transform the CSI to the time domain (for example, TD-CRI) and select “n” time domain pulses (filtered TD-CRI) or select “n” time domain pulses from the CIR, according to the value of “n” in the sensing NDPA frame and optionally according to the selection indication. In an example, the station may pass the filtered TD-CRI or CIR to the MLME to be included in the sensing measurement report. The access point may then determine the CSM. According to an implementation, determination agent 546-1 may determine the CSM. In some examples, the station may determine the CSM. Upon determining the CSM, the station may send the CSM to the access point in a sensing measurement report, for example together with an indication of the transmission configuration and its AID.

Examples by which the CSM matrix may be utilized for selecting operating transmission configuration(s) are described in detail below.

In examples, a minimum CSM may be established and any channel with a CSM that is below the minimum CSM may yield undesirable Wi-Fi sensing results if used for sensing. In a Wi-Fi sensing system, the sensing goal of the Wi-Fi system may determine a minimum threshold for the value of CSM (as the lowest requirement of the sensing channel quality). In an implementation, once the CSM matrix has been determined, selection agent 525-1 or selection agent 547-1 may use the CSM matrix and other available information to select a transmission configuration for operation in both data and Wi-Fi sensing modes. In an example, the sensing goal may be used to determine a minimum CSM threshold (interchangeably referred to as quality threshold) for selecting a transmission configuration. In examples, a different CSM threshold may exist for different sensing goals. In an implementation, selection agent 525-1 or selection agent 547-1 may determine which transmission configurations have CSMs that exceed the minimum CSM threshold, and these transmission configurations may be recorded or stored as candidate transmission configurations. In an implementation, selection agent 525-1 or selection agent 547-1 may store the candidate transmission configurations in candidate transmission configurations storage 527-1 or candidate transmission configurations storage 549-1. In an example, a candidate transmission configurations (CTC) matrix may be created (example of which is shown in Table 2 provided below). For ease of representation, the candidate transmission configuration is abbreviated to CTC in Table 2.

TABLE 2
CTC Matrix for different transmission configuration for a station

| | | Transmission | | Candidate |
|---|---|---|---|---|
| Transmission | Channel and | Parameter | | Transmission |
| Configuration | Bandwidth | Configuration | Channel Sensing | Configuration |
| (TC) | (CHB) | (TPC) | Metric (CSM) | (CTC) |
| 1 | CHB1 | TPC A | CSM-TC1-AID-1 | YES |
| 2 | CHB1 | TPC B | CSM-TC2-AID-1 | YES |
| 3 | CHB1 | TPC C | CSM-TC3-AID-1 | NO |
| 4 | CHB2 | TPC A | CSM-TC4-AID-1 | YES |
| . . . | . . . | . . . | . . . | . . . |
| 11 | CHB3 | TPC B | CSM-TC11-AID-1 | NO |
| 12 | CHB3 | TPC C | CSM-TC12-AID-2 | NO |

In examples, the access point may select a transmission configuration for which all stations in the BSS have CTC=YES as options for operating transmission configuration(s). In examples, where all stations in the BSS have CTC=YES for more than one transmission configuration with the same CHB, the access point may establish an equivalent number of sensing measurement setups (which represent different transmission parameter configurations on the same channel/bandwidth). In such scenarios, the access point may instruct the stations to participate in sensing measurement instances on any of the valid sensing measurement setups during operations.

The access point may also use the information in the CTC matrix to determine one or more transmission configurations that can be selected from, to use when performing sensing measurement instances with associated stations during Wi-Fi sensing operation. In an example, the access point may determine the one or more transmission configurations that may be used to select sensing measurement setups that may be used for Wi-Fi sensing. The selection of the one or more transmission configurations determines which subset of CSM value (or CSM scores) in the CSM matrix are applicable to the sensing measurement instances according to the sensing measurement setup associated with that transmission configuration. In examples, the selection of an operating transmission configuration from amongst the candidate transmission configurations may depend on factors including availability of channel resources, received signal strength indication information, and/or data channel metrics for the channel (for example, SNR, error-vector magnitude (EVM), bit error rate (BER), and block error rate (BLER)). In an example, if there are multiple candidate transmission configurations, then the candidate transmission configuration with the highest CSM may be selected for operation.

Examples by which the CHB selection is made are described in detail below.

In examples, in a sensing link between an access point and a station, there are typically a number of different frequency channels that could be used. The number of options for frequency channels may depend on the capabilities of the devices and the total bandwidth available. For example, if the total bandwidth is 80 MHz and the smallest supported channel is 20 MHz, then there may be four tunable CHB. In examples, this may be related to the “UL BW subfield” as shown in FIG. 15G. In the example shown in FIG. 15G, there are a number of different UL BW allocations that are possible. To be able to determine which of the UL BW allocations or CHB are acceptable for sensing, the access point may determine the CSM for a possible CHB and transmission parameter configuration combination. The CSM then becomes one input of information into the choice of the channel between the AP and the STA.

In an example, the CSM values may need to be refreshed from time to time, for example, if additional channels are allocated to the Wi-Fi sensing system. In examples, the CSM values may also need to be refreshed or determined again if any changes in the sensing space are detected. Examples of changes include, but are not limited to, movement of a device, addition of a device, and movement of an object in the sensing space. In examples, the access point may consider the CSM information in making its channel selection/channel switching decisions. For example, whatever channel association decision is made by access point, the CSM information may be considered in that decision. In examples, a central sensing controller may be responsible for assigning channels to the access point and the station. In an example, if an access point is on a certain channel, and needs to switch to another channel, then the access point may take into account the CSM information of the channel it needs to switch to (and optionally other metrics including those previously mentioned and received signal strength indication information, or RSSI) and make sure that the CSM is acceptable, or that the CSM ranks better than the existing channel. In an example, a linear combination of RSSI, CSM with some weight assigned to each can be used to make the decision.

According to an implementation, establishing agent 523-1 or establishing agent 545-1 may be configured to establish a BSS according to a CHB based on data transmission metrics. The BSS may include an access point and a plurality of stations having a plurality of sensing links therebetween. In an implementation, establishing agent 523-1 or establishing agent 545-1 may establish a sensing measurement setup with the plurality of stations in the BSS. In examples, the sensing measurement setup may correspond to a transmission configuration including the CHB and transmission parameters. In an implementation, determination agent 524-1 or determination agent 546-1 may obtain one or more CSMs. Each CSM may correspond to a sensing link of the plurality of sensing links between the access point and the station and to the transmission configuration.

In an implementation, adjustment agent 526-1 (where the access point assumes the role of sensing receiver 502-1) or adjustment agent 548-1 (where the access point assumes the role of sensing transmitter 504-1) may determine that at least one of the CSM of the one or more CSMs is below a quality threshold. Responsive to determining that the at least one of the CSM of the one or more CSMs is below the quality threshold, adjustment agent 526-1 or adjustment agent 548-1 may adjust BSS parameters. In examples, adjustment agent 526-1 or adjustment agent 548-1 may adjust a configuration of the BSS, where the configuration including at least the CHB. In examples, adjustment agent 526-1 or adjustment agent 548-1 may adjust the BSS parameters based on removing one or more sensing links corresponding to the at least one of the CSM below the quality threshold from a set of links used for sensing.

FIG. 22 depicts flowchart 2200 for selecting a transmission configuration as an operating transmission configuration according to a channel sensing metric (CSM), according to some embodiments. In an implementation, flowchart 2200 may be carried out by an access point (for example, sensing receiver 502-1 or sensing transmitter 504-1) operating as a sensing initiator.

In a brief overview of an implementation of flowchart 2200, at step 2202, a sensing measurement setup may be established with a station of a plurality of stations in a basic service set (BSS). In examples, the sensing measurement setup may correspond to a transmission configuration comprising a channel and bandwidth (CHB) and transmission parameters. At step 2204, a CSM may be obtained. The CSM may correspond to a sensing link of a plurality of sensing links between an access point (which is a networking device) and the station and to the transmission configuration. At step 2206, the transmission configuration may be selected as an operating transmission configuration according to the CSM. At step 2208, the operating transmission configuration may be communicated to the station.

Step 2202 includes establishing a sensing measurement setup with a station of a plurality of stations in a BSS. In examples, the sensing measurement setup may correspond to a transmission configuration comprising a CHB and transmission parameters. According to an implementation, access point acting as sensing receiver 502-1 may be configured to establish the sensing measurement setup with the station of the plurality of stations in the BSS. In an example, the BSS including an access point and a plurality of stations having a plurality of sensing links therebetween may be established.

Step 2204 includes obtaining a CSM. In examples, the CSM may correspond to a sensing link of a plurality of sensing links between a networking device (operating as the access point) and the station and to the transmission configuration. According to an implementation, access point acting as sensing receiver 502-1 may be configured to obtain the CSM. In examples, obtaining the CSM includes determining the CSM based on a comparison between a channel state information (CSI) for the sensing link and a reconstructed CSI for the sensing link. In an example, the CSI includes a plurality of time domain pulses and the reconstructed CSI includes a selected number of time domain pulses from the plurality of time domain pulses. In examples, the selected number of time domain pulses may be determined according to at least one of a noise threshold method, a filter mask method, and a knee point method.

Step 2206 includes selecting the transmission configuration as an operating transmission configuration according to the CSM. According to an implementation, the access point acting as sensing receiver 502-1 may be configured to select the transmission configuration as the operating transmission configuration according to the CSM.

Step 2208 includes communicating the operating transmission configuration to the station. According to an implementation, access point acting as sensing receiver 502-1 may be configured to communicate the operating transmission configuration to the station.

FIG. 23A and FIG. 23B depict another flowchart 2300 for selecting a transmission configuration as an operating transmission configuration according to a CSM, according to some embodiments. In an implementation, flowchart 2300 may be carried out by an access point (for example, sensing receiver 502-1) operating as a sensing initiator.

In a brief overview of an implementation of flowchart 2300, at step 2302, a sensing measurement setup may be established with a station of a plurality of stations in a basic service set (BSS). In examples, the sensing measurement setup may correspond to a transmission configuration comprising a channel and bandwidth (CHB) and transmission parameters. At step 2304, a sensing trigger frame may be transmitted to the station. At step 2306, one or more sensing transmissions may be transmitted by the station according to the sensing trigger frame may be received. At step 2308, one or more sensing measurements may be performed on the one or more sensing transmissions. At step 2310, a CSM may be determined according to the one or more sensing measurements. In examples, the CSM may correspond to a sensing link of a plurality of sensing links between an access point (which is a networking device) and the station and to the transmission configuration. At step 2312, the transmission configuration may be selected as an operating transmission configuration according to the CSM. At step 2314, the operating transmission configuration may be communicated to the station.

Step 2302 includes establishing a sensing measurement setup with a station of a plurality of stations in a BSS. In examples, the sensing measurement setup may correspond to a transmission configuration comprising a CHB and transmission parameters. According to an implementation, access point acting as sensing receiver 502-1 may be configured to establish the sensing measurement setup with the station of the plurality of stations in the BSS. In an example, the BSS including an access point and a plurality of stations having a plurality of sensing links therebetween may be established.

Step 2304 includes transmitting a sensing trigger frame to the station. According to an implementation, access point acting as sensing receiver 502-1 may be configured to transmit the sensing trigger frame to the station. In examples, the sensing trigger frame may be configured to identify a sensing measurement setup according to the transmission configuration.

Step 2306 includes receiving one or more sensing transmissions transmitted by the station according to the sensing trigger frame. According to an implementation, access point acting as sensing receiver 502-1 may be configured to receive the one or more sensing transmissions transmitted by the station according to the sensing trigger frame.

Step 2308 includes performing one or more sensing measurements on the one or more sensing transmissions. According to an implementation, access point acting as sensing receiver 502-1 may be configured to perform one or more sensing measurements on the one or more sensing transmissions.

Step 2310 includes determining a CSM according to the one or more sensing measurements. In examples, the CSM may correspond to a sensing link of a plurality of sensing links between a networking device (operating as the access point) and the station and to the transmission configuration. According to an implementation, access point acting as sensing receiver 502-1 may be configured to determine the CSM according to the one or more sensing measurements.

Step 2312 includes selecting the transmission configuration as an operating transmission configuration according to the CSM. According to an implementation, the access point acting as sensing receiver 502-1 may be configured to select the transmission configuration as the operating transmission configuration according to the CSM.

Step 2314 includes communicating the operating transmission configuration to the station. According to an implementation, access point acting as sensing receiver 502-1 may be configured to communicate the operating transmission configuration to the station.

FIG. 24A and FIG. 24B depict yet another flowchart 2400 for selecting a transmission configuration as an operating transmission configuration according to a CSM, according to some embodiments. In an implementation, flowchart 2400 may be carried out by an access point (for example, sensing transmitter 504-1) operating as a sensing initiator.

In a brief overview of an implementation of flowchart 2400, at step 2402, a sensing measurement setup may be established with a station of a plurality of stations in a basic service set (BSS). In examples, the sensing measurement setup may correspond to a transmission configuration comprising a channel and bandwidth (CHB) and transmission parameters. At step 2404, one or more sensing NDPA frames may be transmitted to the station. At step 2406, one or more sensing transmissions configured according to the transmission configuration and corresponding to the one or more sensing NDPA frames may be transmitted to the station. At step 2408, a sensing measurement report may be received from the station. At step 2410, a CSM may be determined according to the sensing measurement report. In examples, the CSM may correspond to a sensing link of a plurality of sensing links between an access point (which is a networking device) and the station and to the transmission configuration. At step 2412, the transmission configuration may be selected as an operating transmission configuration according to the CSM. At step 2414, the operating transmission configuration may be communicated to the station.

Step 2402 includes establishing a sensing measurement setup with a station of a plurality of stations in a BSS. In examples, the sensing measurement setup may correspond to a transmission configuration comprising a CHB and transmission parameters. According to an implementation, access point acting as sensing transmitter 504-1 may be configured to establish the sensing measurement setup with the station of the plurality of stations in the BSS. In an example, the BSS including an access point and a plurality of stations having a plurality of sensing links therebetween may be established.

Step 2404 includes transmitting one or more sensing NDPA frames to the station. According to an implementation, access point acting as sensing transmitter 504-1 may be configured to transmit the one or more sensing NDPA frames to the station.

Step 2406 includes transmitting one or more sensing transmissions configured according to the transmission configuration and corresponding to the one or more sensing NDPA frames to the station. According to an implementation, access point acting as sensing transmitter 504-1 may be configured to transmit the one or more sensing transmissions configured according to the transmission configuration and corresponding to the one or more sensing NDPA frames to the station.

Step 2408 includes receiving a sensing measurement report from the station. According to an implementation, the access point acting as sensing transmitter 504-1 may be configured to receive the sensing measurement report from the station. In examples, the sensing measurement report includes a channel state information (CSI) for the sensing link and a reconstructed CSI for the sensing link.

Step 2410 includes determining a CSM according to the sensing measurement report. In examples, the CSM may correspond to a sensing link of a plurality of sensing links between a networking device (operating as the access point) and the station and to the transmission configuration. According to an implementation, access point acting as sensing transmitter 504-1 may be configured to determine the CSM according to the sensing measurement report.

Step 2412 includes selecting the transmission configuration as an operating transmission configuration according to the CSM. According to an implementation, the access point acting as sensing transmitter 504-1 may be configured to select the transmission configuration as the operating transmission configuration according to the CSM. In examples, selection of the transmission configuration may be performed according to at least one of availability of channel resources, received signal strength indication information, and data channel metrics.

Step 2414 includes communicating the operating transmission configuration to the station. According to an implementation, access point acting as sensing transmitter 504-1 may be configured to communicate the operating transmission configuration to the station.

According to some implementations, the access point acting as sensing transmitter 504-1 may be configured to transmit a sensing NDPA frame to the station. Further, the access point acting as sensing transmitter 504-1 may be configured to transmit a sensing transmission configured according to the transmission configuration to the station. In an implementation, the access point acting as sensing transmitter 504-1 may be configured to receive a sensing measurement report from the station and extract the CSM from the sensing measurement report.

FIG. 25 depicts a flowchart 2500 for establishing a shared channel and bandwidth (CHB) as an operating CHB, according to some embodiments. In an implementation, flowchart 2500 may be carried out by an access point (for example, sensing receiver 502-1 or sensing transmitter 504-1) operating as a sensing initiator.

In a brief overview of an implementation of flowchart 2500, at step 2502, a plurality of sensing measurement setups may be established according to a plurality of transmission configurations. At step 2504, a plurality of channel sensing metric (CSM) matrices may be determined. In examples, each CSM matrix may correspond to one sensing link of a plurality of sensing links and comprising a plurality of CSM scores according to a plurality of different transmission configurations for the one sensing link. At step 2506, transmission configurations may be identified as candidate transmission configurations based on having corresponding CSMs that surpass a quality threshold for each station of a plurality of stations. At step 2508, transmission configurations having a shared channel and bandwidth (CHB) and qualifying as candidate transmissions configuration for each station of the plurality of stations may be identified as potential operating transmission configurations. At step 2510, the shared CHB may be established as an operating CHB.

Step 2502 includes establishing a plurality of sensing measurement setups according to a plurality of transmission configurations. According to an implementation, access point acting as sensing receiver 502-1 may be configured to establish the plurality of sensing measurement setups according to the plurality of transmission configurations.

Step 2504 includes determining a plurality of channel sensing metric (CSM) matrices. Each CSM matrix corresponds to one sensing link of a plurality of sensing links and comprising a plurality of CSM scores according to a plurality of different transmission configurations for the one sensing link. According to an implementation, the access point acting as sensing receiver 502-1 may be configured to determine the plurality of CSM matrices.

Step 2506 includes identifying transmission configurations as candidate transmission configurations based on having corresponding CSMs that surpass a quality threshold for each station of a plurality of stations. According to an implementation, access point acting as sensing receiver 502-1 may be configured to identify transmission configurations as candidate transmission configurations based on having corresponding CSMs that surpass the quality threshold for each station of the plurality of stations.

Step 2508 includes identifying, as potential operating transmission configurations, transmission configurations having a shared channel and bandwidth (CHB) and qualifying as candidate transmissions configuration for each station of the plurality of stations. According to an implementation, access point acting as sensing receiver 502-1 may be configured to identify, as potential operating transmission configurations, transmission configurations having the shared CHB and qualifying as candidate transmissions configuration for each station of the plurality of stations. In an implementation, access point acting as sensing receiver 502-1 may be configured to identify transmission configurations as candidate transmission configurations based on having corresponding CSMs that surpass a quality threshold for each station of the plurality of stations. Further, access point acting as sensing receiver 502-1 may be configured to identify, as potential operating transmission configurations, transmission configurations having a shared CHB and qualifying as candidate transmissions configuration for each station of the plurality of stations.

Step 2510 includes establishing the shared CHB as an operating CHB. According to an implementation, access point acting as sensing receiver 502-1 may be configured to establish the shared CHB as the operating CHB.

FIG. 26 depicts flowchart 2600 for adjusting basic service set (BSS) parameters responsive to determining that the at least one of CSM of one or more CSMs is below a quality threshold, according to some embodiments. In an implementation, flowchart 2600 may be carried out by an access point (for example, sensing receiver 502-1 or sensing transmitter 504-1) operating as a sensing initiator.

In a brief overview of an implementation of flowchart 2600, at step 2602, a BSS may be established according to an operating channel and bandwidth (CHB) based on data transmission metrics. At step 2604, a sensing measurement setup may be established with a plurality of stations in the BSS. In examples, the sensing measurement setup may correspond to a transmission configuration comprising the CHB, and transmission parameters. At step 2606, one or more channel sensing metrics (CSMs) may be obtained. Each CSM may correspond to a sensing link of a plurality of sensing links between a networking device and a station and to the transmission configuration. At step 2608, it may be determined if at least one of the CSM of the one or more CSMs is below a quality threshold. At step 2610, responsive to determining that the at least one of the CSM of the one or more CSMs is below the quality threshold, BSS parameters may be adjusted.

Step 2602 includes establishing a BSS according to an operating CHB based on data transmission metrics. According to an implementation, access point acting as sensing receiver 502-1 may be configured to establish the BSS according to the operating CHB based on data transmission metrics.

Step 2604 includes establishing a sensing measurement setup with a plurality of stations in the BSS. The sensing measurement setup may correspond to a transmission configuration comprising the CHB, and transmission parameters. According to an implementation, access point acting as sensing receiver 502-1 may be configured to establish the sensing measurement setup with the plurality of stations in the BSS.

Step 2606 includes obtaining one or more channel sensing metrics (CSMs). Each CSM may correspond to a sensing link of a plurality of sensing links between a networking device and a station and to the transmission configuration. According to an implementation, access point acting as sensing receiver 502-1 may be configured to obtain one or more CSMs.

Step 2608 includes determining that at least one of the CSM of the one or more CSMs is below a quality threshold. According to an implementation, access point acting as sensing receiver 502-1 may be configured to determine that at least one of the CSM of the one or more CSMs is below the quality threshold.

Step 2610 includes adjusting BSS parameters responsive to determining that the at least one of the CSM of the one or more CSMs is below the quality threshold. According to an implementation, access point acting as sensing receiver 502-1 may be configured to adjust the BSS parameters responsive to determining that the at least one of the CSM of the one or more CSMs is below the quality threshold. In examples, access point acting as sensing receiver 502-1 may adjust the BSS parameters by adjusting a configuration of the BSS. In an example, the configuration may include at least the CHB. In some implementations, access point acting as sensing receiver 502-1 may adjust the BSS parameters by removing one or more sensing links corresponding to the at least one of the CSM below the quality threshold from a set of links used for sensing.

In the method of FIG. 22, FIG. 23A, FIG. 23B, FIG. 24A, FIG. 24B, FIG. 25, and FIG. 26, the access point may be a sensing initiator and the plurality of stations may be sensing responders. In the example described above, the access point is described as acting in the role of sensing receiver 502-1 or the role of sensing transmitter 504-1.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

Further embodiments include the following.

Embodiment 1 includes a method for establishing a basic service set (BSS) including an access point and a plurality of stations having a plurality of sensing links therebetween, performed by a networking device operating as the access point, the method comprising: establishing a sensing measurement setup with a station of the plurality of stations in the BSS, the sensing measurement setup corresponding to a transmission configuration comprising a channel and bandwidth (CHB), and transmission parameters; obtaining a channel sensing metric (CSM), the CSM corresponding to a sensing link of the plurality of sensing links between the networking device and the station and to the transmission configuration; selecting the transmission configuration as an operating transmission configuration according to the CSM; and communicating the operating transmission configuration to the station.

Embodiment 2 includes the method of embodiment 1, wherein obtaining the channel sensing metric includes determining the channel sensing metric based on a comparison between a channel state information (CSI) for the sensing link and a reconstructed CSI for the sensing link.

Embodiment 3 includes the method of embodiment 2, wherein: the CSI includes a plurality of time domain pulses; and the reconstructed CSI includes a selected number of time domain pulses from the plurality of time domain pulses.

Embodiment 4 includes the method of any of embodiments 1-3, wherein the selected number of time domain pulses is determined according to at least one of: a noise threshold method; a filter mask method; and a knee point method.

Embodiment 5 includes the method of any of embodiments 1-4, wherein obtaining the CSM includes: transmitting, by the networking device, a sensing trigger frame to the station; receiving, by the networking device, one or more sensing NDP transmissions transmitted by the station according to the sensing trigger frame; performing one or more sensing measurements on the one or more sensing NDP transmissions; and determining the CSM according to the one or more sensing measurements.

Embodiment 6 includes the method of embodiment 5, wherein the sensing trigger frame is configured to identify a sensing measurement setup according to the transmission configuration.

Embodiment 7 includes the method of any of embodiments 1-6, wherein obtaining the CSM includes: transmitting, by the networking device, one or more sensing NDPA frames to the station; transmitting, by the networking device, one or more sensing NDP transmissions configured according to the transmission configuration to the station and corresponding to the one or more sensing NDPA frames; receiving, by the networking device, one or more sensing measurement reports from the station; and determining the CSM according to the one or more sensing measurement reports.

Embodiment 8 includes the method of embodiment 7, wherein the sensing measurement report includes a channel state information (CSI) for the sensing link.

Embodiment 9 includes the method of any of embodiments 1-8, wherein: establishing the sensing measurement setup includes establishing a plurality of sensing measurement setups according to a plurality of transmission configurations; obtaining the channel sensing metric (CSM) includes obtaining a CSM matrix, the CSM matrix comprising a plurality of CSMs, each corresponding to the sensing link and to one transmission configuration of the plurality of transmission configurations; and selecting the CHB as an operating CHB is performed according to the CSM matrix.

Embodiment 10 includes the method of any of embodiments 1-9, further comprising: determining a plurality of CSM matrices, each CSM matrix corresponding to one sensing link of the plurality of sensing links and comprising a plurality of CSM scores according to a plurality of different transmission configurations for the one sensing link.

Embodiment 11 includes the method of any of embodiments 1-10, wherein selecting the transmission configuration as an operating transmission configuration further includes: identifying transmission configurations as candidate transmission configurations based on having corresponding CSMs that surpass a quality threshold for each station of the plurality of stations; and selecting, as the operating transmission configuration, the transmission configuration qualifying as a candidate transmission configuration for each station of the plurality of stations.

Embodiment 12 includes the method of any of embodiments 1-11, wherein selecting the transmission configuration is further performed according to at least one of availability of channel resources, received signal strength indication information, and data channel metrics.

Embodiment 13 includes the method of any of embodiments 1-12, wherein selecting the transmission configuration as an operating transmission configuration further includes: identifying transmission configurations as candidate transmission configurations based on having corresponding CSMs that surpass a quality threshold for each station of the plurality of stations; identifying, as potential operating transmission configurations, transmission configurations having a shared CHB and qualifying as candidate transmissions configuration for each station of the plurality of stations; and establishing the shared CHB as an operating CHB.

Embodiment 14 is a method for establishing a basic service set (BSS) including an access point and a plurality of stations having a plurality of sensing links therebetween, performed by a networking device operating as the access point, the method comprising: establishing the BSS according to an operating channel and bandwidth (CHB) based on data transmission metrics; establishing a sensing measurement setup with the plurality of stations in the BSS, the sensing measurement setup corresponding to a transmission configuration comprising the CHB, and transmission parameters; obtaining one or more channel sensing metrics (CSMs), each CSM corresponding to a sensing link of the plurality of sensing links between the networking device and the station and to the transmission configuration; determining that at least one of the CSM of the one or more CSMs is below a quality threshold; and adjusting BSS parameters responsive to determining that the at least one of the CSM of the one or more CSMs is below the quality threshold.

Embodiment 15 includes the method of embodiment 14, wherein adjusting BSS parameters includes: adjusting a configuration of the BSS, the configuration including at least the CHB.

Embodiment 16 includes the method of any of embodiments 14-15, wherein adjusting the BSS parameters includes removing one or more sensing links corresponding to the at least one of the CSM below the quality threshold from a set of links used for sensing.

Embodiment 17 is a system for establishing a basic service set (BSS) including an access point and a plurality of stations having a plurality of sensing links therebetween, the system including: a networking device operating as the access point and including at least a transmitting antenna, a receiving antenna, and at least one processor configured to execute instructions for: establishing a sensing measurement setup with a station of the plurality of stations in the BSS, the sensing measurement setup corresponding to a transmission configuration comprising a channel and bandwidth (CHB), and transmission parameters; obtaining a channel sensing metric (CSM), the CSM corresponding to a sensing link of the plurality of sensing links between the networking device and the station and to the transmission configuration; selecting the transmission configuration as an operating transmission configuration according to the CSM; and communicating the operating transmission configuration to the station.

Embodiment 18 includes the system of embodiment 17, wherein the at least one processor is configured to execute instructions for obtaining the channel sensing metric by determining the channel sensing metric based on a comparison between a channel state information (CSI) for the sensing link and a reconstructed CSI for the sensing link.

Embodiment 19 includes the system of embodiments 17 or 18, wherein: the CSI includes a plurality of time domain pulses; and the reconstructed CSI includes a selected number of time domain pulses from the plurality of time domain pulses.

Embodiment 20 includes the system of embodiment 19, wherein the selected number of time domain pulses is determined according to at least one of: a noise threshold method; a filter mask method; and a knee point method.

Embodiment 21 includes the system of embodiments 17-20, wherein the at least one processor is configured to execute instructions for obtaining the CSM by: transmitting, by the networking device, a sensing trigger frame to the station; receiving, by the networking device, one or more sensing NDP transmissions transmitted by the station according to the sensing trigger frame; performing one or more sensing measurements on the one or more sensing NDP transmissions; and determining the CSM according to the one or more sensing measurements.

Embodiment 22 includes the system of embodiment 21, wherein the sensing trigger frame is configured to identify a sensing measurement setup according to the transmission configuration.

Embodiment 23 includes the system of any of embodiments 17-22, wherein the at least one processor is configured to execute instructions for obtaining the CSM by: transmitting, by the networking device, one or more sensing NDPA frames to the station; transmitting, by the networking device, one or more sensing NDP transmissions configured according to the transmission configuration to the station and corresponding to the one or more sensing NDPA frames; receiving, by the networking device, one or more sensing measurement reports from the station; and determining the CSM according to the one or more sensing measurement reports.

Embodiment 24 includes the system of embodiment 23, wherein the sensing measurement report includes a channel state information (CSI) for the sensing link.

Embodiment 25 includes the system of any of embodiments 17-24, wherein the at least one processor is configured to execute instructions for: establishing the sensing measurement setup by establishing a plurality of sensing measurement setups according to a plurality of transmission configurations; obtaining the channel sensing metric (CSM) by obtaining a CSM matrix, the CSM matrix comprising a plurality of CSMs, each corresponding to the sensing link and to one transmission configuration of the plurality of transmission configurations; and selecting the CHB as an operating CHB according to the CSM matrix.

Embodiment 26 includes the system of any of embodiments 17-25, wherein the at least one processor is further configured to execute instructions for: determining a plurality of CSM matrices, each CSM matrix corresponding to one sensing link of the plurality of sensing links and comprising a plurality of CSM scores according to a plurality of different transmission configurations for the one sensing link.

Embodiment 27 includes the system of any of embodiments 17-26, wherein the at least one processor is configured to execute instructions for selecting the transmission configuration as an operating transmission configuration by: identifying transmission configurations as candidate transmission configurations based on having corresponding CSMs that surpass a quality threshold for each station of the plurality of stations; and selecting, as the operating transmission configuration, the transmission configuration qualifying as a candidate transmission configuration for each station of the plurality of stations.

Embodiment 28 includes the system of any of embodiment 27, wherein the at least one processor is configured to execute instructions for selecting the transmission configuration further according to at least one of availability of channel resources, received signal strength indication information, and data channel metrics.

Embodiment 29 includes the system of any of embodiments 17-28, wherein the at least one processor is configured to execute instructions for selecting the transmission configuration as an operating transmission configuration by: identifying transmission configurations as candidate transmission configurations based on having corresponding CSMs that surpass a quality threshold for each station of the plurality of stations; identifying, as potential operating transmission configurations, transmission configurations having a shared CHB and qualifying as candidate transmissions configuration for each station of the plurality of stations; and establishing the shared CHB as an operating CHB.

Embodiment 30 is a system for establishing a basic service set (BSS) including an access point and a plurality of stations having a plurality of sensing links therebetween, the system including: a networking device operating as the access point and including at least a transmitting antenna, a receiving antenna, and at least one processor configured to execute instructions for: establishing the BSS according to an operating channel and bandwidth (CHB) based on data transmission metrics; establishing a sensing measurement setup with the plurality of stations in the BSS, the sensing measurement setup corresponding to a transmission configuration comprising the CHB, and transmission parameters; obtaining one or more channel sensing metrics (CSMs), each CSM corresponding to a sensing link of the plurality of sensing links between the networking device and the station and to the transmission configuration; determining that at least one of the CSM of the one or more CSMs is below a quality threshold; and adjusting BSS parameters responsive to determining that the at least one of the CSM of the one or more CSMs is below the quality threshold.

Embodiment 31 includes the system of any of embodiment 30, wherein the at least one processor is configured to execute instructions for adjusting the BSS parameters by adjusting a configuration of the BSS, the configuration including at least the CHB.

Embodiment 32 includes the system of any of embodiments 30-31, wherein the at least one processor is configured to execute instructions for adjusting the BSS parameters by removing one or more sensing links corresponding to the at least one of the CSM below the quality threshold from a set of links used for sensing.

1. A method for establishing a basic service set (BSS) including an access point having a plurality of sensing links with a plurality of stations, performed by a networking device operating as the access point, the method comprising:
establishing a sensing measurement session with a station of the plurality of stations in the BSS, the sensing measurement session corresponding to a transmission configuration comprising a channel and bandwidth (CHB), and transmission parameters;
obtaining a channel sensing metric (CSM), the CSM corresponding to a sensing link of the plurality of sensing links between the networking device and the station and to the transmission configuration;
selecting the transmission configuration as an operating transmission configuration according to the CSM; and
communicating the operating transmission configuration to the station.

2. The method of claim 1, wherein obtaining the channel sensing metric includes determining the channel sensing metric based on a comparison between a channel state information (CSI) for the sensing link and a reconstructed CSI for the sensing link.

3. (canceled)

4. (canceled)

5. The method of claim 1, wherein obtaining the CSM includes:
transmitting, by the networking device, a sensing trigger frame to the station;
receiving, by the networking device, one or more sensing NDP transmissions transmitted by the station according to the sensing trigger frame;
performing one or more sensing measurements on the one or more sensing NDP transmissions; and
determining the CSM according to the one or more sensing measurements.

6. (canceled)

7. The method of claim 1, wherein obtaining the CSM includes:
transmitting, by the networking device, one or more sensing NDPA frames to the station;
transmitting, by the networking device, one or more sensing NDP transmissions configured according to the transmission configuration to the station and corresponding to the one or more sensing NDPA frames;
receiving, by the networking device, one or more sensing measurement reports from the station; and
determining the CSM according to the one or more sensing measurement reports.

8. (canceled)

9. The method of claim 1, wherein:
establishing the sensing measurement session includes establishing a plurality of sensing measurement sessions according to a plurality of transmission configurations;
obtaining the channel sensing metric (CSM) includes obtaining a CSM matrix, the CSM matrix comprising a plurality of CSMs, each corresponding to the sensing link and to one transmission configuration of the plurality of transmission configurations; and
selecting the CHB as an operating CHB is performed according to the CSM matrix.

10. The method of claim 1, further comprising:
determining a plurality of CSM matrices, each CSM matrix corresponding to one sensing link of the plurality of sensing links and comprising a plurality of CSM scores according to a plurality of different transmission configurations for the one sensing link.

11. The method of claim 1, wherein selecting the transmission configuration as an operating transmission configuration further includes:
identifying transmission configurations as candidate transmission configurations based on having corresponding CSMs that surpass a quality threshold for each station of the plurality of stations; and
selecting, as the operating transmission configuration, the transmission configuration qualifying as a candidate transmission configuration for each station of the plurality of stations.

12. (canceled)

13. The method of claim 1, wherein selecting the transmission configuration as an operating transmission configuration further includes:
identifying transmission configurations as candidate transmission configurations based on having corresponding CSMs that surpass a quality threshold for each station of the plurality of stations;
identifying, as potential operating transmission configurations, transmission configurations having a shared CHB and qualifying as candidate transmissions configuration for each station of the plurality of stations; and
establishing the shared CHB as an operating CHB.

14. A method for establishing a basic service set (BSS) including an access point and a plurality of stations having a plurality of sensing links therebetween, performed by a networking device operating as the access point, the method comprising:
establishing the BSS according to an operating channel and bandwidth (CHB) based on data transmission metrics;
establishing a sensing measurement session with the plurality of stations in the BSS, the sensing measurement session corresponding to a transmission configuration comprising the CHB, and transmission parameters;
obtaining one or more channel sensing metrics (CSMs), each CSM corresponding to a sensing link of the plurality of sensing links between the networking device and the station and to the transmission configuration;
determining that at least one of the CSM of the one or more CSMs is below a quality threshold; and
adjusting BSS parameters responsive to determining that the at least one of the CSM of the one or more CSMs is below the quality threshold.

15. The method of claim 14, wherein adjusting BSS parameters includes:
adjusting a configuration of the BSS, the configuration including at least the CHB.

16. (canceled)

17. A system for establishing a basic service set (BSS) including an access point having a plurality of sensing links with a plurality of stations, the system including:
a networking device operating as the access point and including at least a transmitting antenna, a receiving antenna, and at least one processor configured to execute instructions for:
establishing a sensing measurement session with a station of the plurality of stations in the BSS, the sensing measurement session corresponding to a transmission configuration comprising a channel and bandwidth (CHB), and transmission parameters;
obtaining a channel sensing metric (CSM), the CSM corresponding to a sensing link of the plurality of sensing links between the networking device and the station and to the transmission configuration;
selecting the transmission configuration as an operating transmission configuration according to the CSM; and
communicating the operating transmission configuration to the station.

18. The system of claim 17, wherein the at least one processor is configured to execute instructions for obtaining the channel sensing metric by determining the channel sensing metric based on a comparison between a channel state information (CSI) for the sensing link and a reconstructed CSI for the sensing link.

19. (canceled)

20. (canceled)

21. The system of claim 17, wherein the at least one processor is configured to execute instructions for obtaining the CSM by:
transmitting, by the networking device, a sensing trigger frame to the station;
receiving, by the networking device, one or more sensing NDP transmissions transmitted by the station according to the sensing trigger frame;
performing one or more sensing measurements on the one or more sensing NDP transmissions; and
determining the CSM according to the one or more sensing measurements.

22. (canceled)

23. The system of claim 17, wherein the at least one processor is configured to execute instructions for obtaining the CSM by:
transmitting, by the networking device, one or more sensing NDPA frames to the station;
transmitting, by the networking device, one or more sensing NDP transmissions configured according to the transmission configuration to the station and corresponding to the one or more sensing NDPA frames;
receiving, by the networking device, one or more sensing measurement reports from the station; and
determining the CSM according to the one or more sensing measurement reports.

24. (canceled)

25. The system of claim 17, wherein the at least one processor is configured to execute instructions for:
establishing the sensing measurement session by establishing a plurality of sensing measurement sessions according to a plurality of transmission configurations;
obtaining the channel sensing metric (CSM) by obtaining a CSM matrix, the CSM matrix comprising a plurality of CSMs, each corresponding to the sensing link and to one transmission configuration of the plurality of transmission configurations; and
selecting the CHB as an operating CHB according to the CSM matrix.

26. The system of claim 17, wherein the at least one processor is further configured to execute instructions for:
determining a plurality of CSM matrices, each CSM matrix corresponding to one sensing link of the plurality of sensing links and comprising a plurality of CSM scores according to a plurality of different transmission configurations for the one sensing link.

27. The system of claim 17, wherein the at least one processor is configured to execute instructions for selecting the transmission configuration as an operating transmission configuration by:
identifying transmission configurations as candidate transmission configurations based on having corresponding CSMs that surpass a quality threshold for each station of the plurality of stations; and
selecting, as the operating transmission configuration, the transmission configuration qualifying as a candidate transmission configuration for each station of the plurality of stations.

28. (canceled)

29. The system of claim 17, wherein the at least one processor is configured to execute instructions for selecting the transmission configuration as an operating transmission configuration by:
identifying transmission configurations as candidate transmission configurations based on having corresponding CSMs that surpass a quality threshold for each station of the plurality of stations;
identifying, as potential operating transmission configurations, transmission configurations having a shared CHB and qualifying as candidate transmissions configuration for each station of the plurality of stations; and
establishing the shared CHB as an operating CHB.

30. A system for establishing a basic service set (BSS) including an access point and a plurality of stations having a plurality of sensing links therebetween, the system including:
a networking device operating as the access point and including at least a transmitting antenna, a receiving antenna, and at least one processor configured to execute instructions for:
establishing the BSS according to an operating channel and bandwidth (CHB) based on data transmission metrics;
establishing a sensing measurement session with the plurality of stations in the BSS, the sensing measurement session corresponding to a transmission configuration comprising the CHB, and transmission parameters;
obtaining one or more channel sensing metrics (CSMs), each CSM corresponding to a sensing link of the plurality of sensing links between the networking device and the station and to the transmission configuration;
determining that at least one of the CSM of the one or more CSMs is below a quality threshold; and
adjusting BSS parameters responsive to determining that the at least one of the CSM of the one or more CSMs is below the quality threshold.

31. The system of claim 30, wherein the at least one processor is configured to execute instructions for adjusting the BSS parameters by adjusting a configuration of the BSS, the configuration including at least the CHB.

32. (canceled)
